(19) United States
(12) Patent Application Publication
(10) Pub. No.: US 2021/0274809 A1
(43) Pub. Date: Sep. 9, 2021

(54) BIOACTIVE FEED ADDITIVE FOR LIVESTOCK

(71) Applicant: Iowa State University Research Foundation, Inc., Ames, IA (US)

(72) Inventors: Elizabeth Ann Kraayenbrink, Ames, IA (US); Krysten Craft, Ames, IA (US); Stephan Schmitz-Esser, Ames, IA (US)

(21) Appl. No.: 17/249,600

(22) Filed: Mar. 5, 2021

Related U.S. Application Data
(60) Provisional application No. 62/986,089, filed on Mar. 6, 2020.

(51) Int. Cl. A23K 10/30; A23K 20/163; A23K 20/158; A23K 20/184; A23K 20/174; A23K 20/20; A23K 20/147; A23K 10/18; A23K 50/75

(52) U.S. Cl. CPC A23K 10/30; A23K 20/163; A23K 20/158; A23K 20/184; A23K 50/75; A23K 20/30; A23K 20/147; A23K 10/18; A23K 20/174

(57) ABSTRACT

The present application relates to livestock and/or companion animal feed compositions, methods of making and using the same, and in particular a feed composition comprising an alfalfa bioactive additive, wherein the alfalfa bioactive composition includes one or more of saponins, fatty acids, phytoestrogens, and polysaccharides, and wherein the feed composition is suitable for improving the health, immune function, and intestinal microbiota of animals such as cattle, goats, sheep, swine and fowl.

### CROSS REFERENCE TO RELATED APPLICATIONS

This application claims priority under 35 U.S.C. § 119 to provisional patent application U.S. Ser. No. 62/986,089 filed Mar. 6, 2020. The provisional patent application is herein incorporated by reference in its entirety, including without limitation, the specification, claims, and abstract, as well as any figures, tables, appendices, or drawings thereof.

### FIELD OF THE INVENTION

The present disclosure relates to a livestock feed composition, methods of making and using the same, and in particular a feed composition which is suitable for improving the health of companion animals and livestock such as cattle, goats, sheep, swine, equines, and fowl, and more particularly to a feed composition comprising a phytogenic bioactive additive which improves the immune function, intestinal microbiota, weight, and feed conversion of livestock.

### BACKGROUND OF THE INVENTION

Meeting nutritional and health requirements for livestock is extremely important in maintaining acceptable performance of neonatal, growing, finishing, maintenance, and breeding animals. From a nutritional standpoint, an optimal diet includes adequate intakes of amino acids, carbohydrates, fatty acids, minerals, and vitamins. Conventionally, maize, soybeans, barley, hay, molasses, beet pulp, wheat bran, silage, and/or fiber are used as fundamental components of feed for the purpose of improving the health and body weight of livestock. Various feed additives or supplements may be additionally used to correct deficiencies or provide additional outcomes in basal diets.

Diet, including feed additives, also contributes to livestock health, both in terms of overall health as measured, for example, by growth, weight, pelage, etc., and also in terms of immune health, as measured, for example, by incidence of disease, and disease resistance. Dietary supplementation with certain nutrients can regulate gene expression and key metabolic pathways to improve fertility, immune function, stress resistance, neonatal survival, growth, feed efficiency, long-term health, and meat quality. Feed additives can also improve the flavor and digestibility of feed.

Bioactive additives, and particularly phytogenic bioactives, are highly desirable for a number of reasons. Plant extracts and phytochemicals offer a natural source of bioactive feed additives that are rooted in the use of herbal therapies in traditional medicines. Additionally, bioactive, plant-sourced feed additives for use in animal diets appeal to consumer demand for ‘naturally-raised’ animal products.

Consumption of legumes (family Fabaceae) by both humans and animals is increasing in popularity due to a number of compounds found within these plants that are known to have health-promoting properties. Plants within this family include alfalfa, clover, peas, peanuts, and soybeans, all with varying degrees of prevalence in human and animal diets.

Alfalfa is a perennial flowering plant largely utilized for animal feed with a history of use as a medicinal plant in humans. Alfalfa provides a wide variety of minerals and vitamins including calcium, magnesium, potassium, sulfur, iron, cobalt, manganese, zinc, Vitamin A, Vitamin E, Vitamin D, Vitamin K, as well as riboflavin and niacin. In addition to vitamins and minerals, alfalfa is a high quality forage, providing high levels of protein and relatively low quantities of fiber. The protein content of alfalfa varies depending on the stage (early or late) but is generally between about 10% to 25% crude protein—about 70% of which is digestible protein—and from 20% to 28% crude fiber. In contrast, the average grass hay averages 8.4% crude protein and 31.4% fiber.

Although alfalfa is a high quality forage compared to grass hay, it still contains enough indigestible, insoluble fiber to limit its use in non-ruminant livestock diets. The amount of insoluble fiber in alfalfa, although less than grass hay, still poses a significant challenge for non-ruminant livestock, which lack the fermentative capacity to extract adequate energy from high-fiber diets. Additionally, alfalfa hay can cause pasture bloat in ruminants.

A further issue of consideration in the use of alfalfa is the maturity and time of cutting of the alfalfa, as both maturity and stage of cutting alter protein primary structures, which correlates with protein metabolism in livestock, particularly ruminant animals. Due to the perennial nature of the plant, alfalfa can be cut for hay at several points during the growing season where a number of environmental factors and harvest conditions can alter its nutrient composition. As alfalfa matures from early bud to late bloom, crude protein decreases (with no changes to gross energy), and both acid detergent fiber (ADF) and carbohydrate content increase as well.

As part of the decrease in crude protein, the non-protein fraction of crude protein decreases with advancing stage of maturity in alfalfa, while unavailable protein increases. Within the true protein fraction of crude protein, the amount of rapidly-degradable protein increases with maturity while levels of intermediate and slowly-degraded protein decreases. While maturity has no effect on carbohydrate fractions, time of cutting (afternoon vs. early morning) increases the amount of rapidly degradable carbohydrates (starch) in alfalfa.

As a result, there is a need to develop feeding strategies to maximize alfalfa-associated benefits without the limitation of fiber for both ruminants and non-ruminants.

There is further a need to develop feed compositions which increase livestock body weight and improve feed efficiency.

There is a still further need to develop feed compositions which provide livestock improved immune resistance in the event of disease, and which foster healthy intestinal microbiota.

Other needs, objectives and goals are described implicitly and explicitly herein, and will be apparent to one skilled in the art.

### BRIEF SUMMARY OF THE INVENTION

In an embodiment, the present application provides for an alfalfa bioactive composition comprising a source of alfalfa which comprises one or more saponins, one or more fatty acids, one or more phytoestrogens, one or more polysaccharides, or a combination thereof. In an aspect, the alfalfa bioactive composition is provided as part of an animal feed composition, comprising an alfalfa bioactive composition, having a source of alfalfa which comprises one or more saponins, one or more fatty acids, one or more phytoestrogens, one or more polysaccharides, or a combination thereof and further a carbohydrate source. In an aspect, the carbohydrate source comprises maize, sorghum, rye alfalfa, green oilseed, legumes, grasses, cabbage, pumpkins, turnips, beets, carrots, swedes, vegetable roots, non-leguminous hay, clover, wheat bran, rice bran, barley bran, maize bran, rye bran, oat bran, millet bran, sorghum bran, fonio, triticale, pulses, or a combination thereof. In an aspect, the alfalfa bioactive composition is present in an amount of between about 0.0001 wt. % to about 15 wt. % of the composition, and the carbohydrate source is present in an amount of from about 1 wt. % to about 99 wt. % of the composition.

In an additional embodiment, the animal feed composition further comprising a source of fiber. In an aspect, the source of fiber comprises neutral detergent fiber, acid detergent fiber, lignin, cellulose, or a combination thereof.

In an additional embodiment, the animal feed composition may further comprise one or more vitamins and minerals, wherein the vitamins and minerals are calcium, phosphorous, magnesium potassium, chloride, sodium, copper, zinc, sulfur, iron, manganese, nitrate, or a combination thereof.

In an embodiment, the animal feed composition may further comprise a supplementary protein source, wherein the supplementary protein source is soy meal, sunflower meal, canola meal, distiller's dried grains with solubles (DDGS), pea protein, bean protein, lupins, lemna, algae, sweet potato, common vetch seeds, hempseed cake, castor oil meal, pigeon pea, rapeseed, cassava foliage, duckweed, fish meal, blood meal, poultry by-product (ground poultry offal), meat meal, keratin, insect meal, or a combination thereof.

In an aspect, the alfalfa bioactive composition is suspended in a solvent comprising water, chloroform, or a combination thereof.

The application further provides methods of improving the growth parameters of livestock and/or companion animals comprising first providing to an animal an alfalfa bioactive composition in an amount effective to increase the body weight and/or feed efficiency of the animal, wherein the alfalfa bioactive composition comprises a source of alfalfa comprising one or more saponins, one or more fatty acids, one or more phytoestrogens, one or more polysaccharides, or a combination thereof and then exposing the animal to the alfalfa bioactive composition, whereby the body weight and/or feed efficiency of the animal is improved compared to animals not provided with the alfalfa bioactive composition. In some embodiments, the methods maintain or improve the feed intake of the livestock animal even in the event of a pathogen challenge or other managerial, environmental, biological, or life-cycle related challenge.

In an aspect, the exposure to the alfalfa bioactive composition occurs by providing the alfalfa bioactive composition as part of an animal feed composition and/or a dietary supplement in the form of a solid (e.g., tablet, pellet) or a liquid. In a further aspect, the animal is exposed to the alfalfa bioactive composition for a period of between 1 day and 56 or more days.

In a further aspect, methods of improving immune resistance in animals, particularly livestock are providing, the methods comprising first providing to an animal an alfalfa bioactive composition in an amount effective to reduce serum cytokines and/or improve adaptive and/or innate immune response, wherein the alfalfa bioactive composition comprises one or more saponins, or more fatty acids, one or more phytoestrogens, one or more polysaccharides, or a combination thereof, and thereafter the animal to the alfalfa bioactive composition, wherein the concentration of serum cytokines is reduced and/or innate and/or adaptive immune cell concentration is increased.

In an aspect, the decrease in serum cytokines includes a reduction in the number of IFN-γ⁺ and/or TNF-α⁺ cells. In a further aspect, the reduction in the number of IFN-γ⁺ and/or TNF-α⁺ cells improves infection recovery rate. In a further aspect, the increase in adaptive immune cells includes an increase in one or more B-cell and/or T-cell populations. In an aspect, the increase in innate immune cells includes an increase in one or more neutrophil and/or macrophage populations.

In an embodiment, methods of improving the intestinal microbiota of animals are provided, wherein the methods comprise first providing to an animal an alfalfa bioactive composition in an amount effective to reduce a pathogen population and improve one or more beneficial microbial populations, wherein the alfalfa bioactive composition comprises one or more saponins, one or more fatty acids, one or more phytoestrogens, one or more polysaccharides, or a combination thereof; and thereafter exposing the livestock animal to the alfalfa bioactive composition, wherein the quantity of the pathogen population is reduced and/or the quantity of the one or more beneficial microbial populations (e.g., probiotics, prebiotics and the like) are increased.

In an aspect, the pathogen population includes Citrobacter rodentium and/or an operational taxonomic unit thereof. In an aspect, the one or more beneficial microbial populations includes Akkermansia, Turicibacter, Muribaculaceae, Dubosiella, Lactobacillus, Bacteroides, Lachnospiraceae, Alistipes, Parasutterella, Bifidobacterium, Anaeroplasma, or a combination or an operational taxonomic unit thereof.

### BRIEF DESCRIPTION OF THE DRAWINGS

FIGS. 1A-1H show a crude protein (CP) and crude fat (CF) analysis of preliminary aqueous alfalfa extracts. Data in these figures represent the average±SEM while the lack of a bar indicates that insufficient yield of solid aqueous extract precluded analysis. Bars with different letter superscripts are significantly different P≤0.05. In particular, FIG. 1A depicts the CP of individual extraction conditions; FIG. 1B shows the impact of extraction ratio on CP in aqueous extracts (P=1.0); FIG. 1C shows the effect of extraction temperature on CP in aqueous extracts (RT vs. 60° C., P=0.5; RT vs. 100° C., P=0.0002; 60° C. vs. 100° C., P<0.0001); FIG. 1D shows the impact of extraction duration on the percent CP in aqueous extracts (2 h vs. 12 h, P=0.0003; 2 h vs. 24 h, P<0.0001; 12 h vs. 24 h, P<0.0001); FIG. 1E shows the CF based on the various extraction conditions; FIG. 1F depicts the impact of extraction ratio on percent CF in aqueous alfalfa extracts (P=0.93); FIG. 1G shows the impact of extraction temperature on the percent CF in aqueous alfalfa extracts (RT vs. 60° C., P=0.03; RT vs. 100° C., P=0.6; 60° C. vs. 100° C., P=0.03); and FIG. 1H shows the effect of extract duration on the percent of CF (2 h vs. 12 h, P=0.1; 2 h vs. 24 h, P=0.4; 12 h vs. 24 h, P=0.4).

FIGS. 2A-2F show the average crude protein (CP) and crude fat (CF) of a 1:5 ratio of aqueous alfalfa extracts at room temperature (RT) or 60° C. for 24 h. Data in these figures represent the average CP or CF±SEM. In particular, FIG. 2A shows the CP of all extracts; FIG. 2B shows the effect of temperature on CP (P=0.4); FIG. 2C depicts the effect of alfalfa cutting (P=0.7) on CP in aqueous alfalfa extracts; FIG. 2D shows the percent CF of all extracts; FIG. 2E shows the effect of temperature on CF (P=0.1); FIG. 2F depicts the impact of alfalfa cutting (P=0.08) on percent CF in aqueous alfalfa extracts.

FIGS. 3A-3H depict the nutrient analysis of chloroform alfalfa extracts. Data in these figures represent the average CP or CF±SEM. Bars with different letter superscripts are significantly different P≤0.05. In particular, FIG. 3A shows the average crude protein (CP) of the first and fifth cutting chloroform extracts done at a 1:4 or 1:5 alfalfa to chloroform ratio, at R % or 40° C.; FIG. 3B shows the impact of extraction ratio (P=0.1) on the percent CP in chloroform alfalfa extract; FIG. 3C shows the impact of temperature (P=0.2) on the percent CP in chloroform alfalfa extract; FIG. 3D depicts the cutting impact (CP) (P=0.0002) on the chloroform extracts; FIG. 3F shows the impact of extraction ratio on CF (P=0.08) in chloroform alfalfa extract; FIG. 3G shows the impact of temperature (P=0.1) on chloroform alfalfa extract; FIG. 3H shows the difference in chloroform extracts from alfalfa at different cuttings (P<0.0001); FIG. 3E shows the average crude fat (CF) of the first and fifth cutting chloroform extracts done at a 1:4 or 1:5 alfalfa to chloroform ratio, at R % or 40° C.

FIG. 4 shows the fatty acid profile of first and fifth cutting alfalfa as analyzed by gas chromatography (GC).

FIG. 5 depicts the fatty acid profile of preliminary aqueous alfalfa extracts as analyzed by gas chromatography (GC).

FIGS. 6A-6C show the fatty acid profile of aqueous extracts. In particular, FIG. 6A depicts the fatty acid profile of the extracts grouped by the alfalfa to water ratio; FIG. 6B shows the fatty acid profile of the extracts grouped by extraction temperature; and FIG. 6C depicts the fatty acid profile of the extracts grouped by time analyzed by gas chromatography (GC).

FIG. 7 shows the fatty acid profile of chloroform alfalfa extracts as analyzed by gas chromatography (GC).

FIGS. 8A-8C depict the fatty acid profile of chloroform extracts. In particular, FIG. 8A shows the fatty acid profile of the extracts grouped by the alfalfa to chloroform ratio; FIG. 8B shows the fatty acid profile of the extracts grouped by extraction temperature; and FIG. 8A shows the fatty acid profile of the extracts grouped by cutting as analyzed by gas chromatography.

FIG. 9 shows the effects of dietary treatments containing different forms of first and fifth cutting alfalfa on mouse BW pre- and post-inoculation with Citrobacter rodentium. Data represent mean BW±SEM. Key timepoints for blood and tissue sampling are marked by black arrows.

FIGS. 10A-10C show the average daily feed intake of mice fed different forms of first and fifth cut alfalfa. Data are represented as the mean ADFI±SEM. Bars with different letter superscripts are significant at P≤0.05. In particular, FIG. 10A shows the effects of alfalfa supplementation based on form; FIG. 10B shows the effects of alfalfa supplementation based on cutting; and FIG. 10C shows the interaction of form x cutting.

FIG. 11 depicts a comparison of the mean BW of mice fed first and fifth cutting alfalfa regardless of form compared to the control.

FIGS. 12A-12C show a comparison of the mean BW of mice fed different cuttings and forms of alfalfa. Data represent the mean±SEM, *=P≤0.05. Key timepoints for blood and tissue sampling are marked by black arrows. In particular, FIG. 12A shows the overall body weight trends for first and fifth cutting alfalfa regardless of alfalfa supplementation form; FIG. 12B compares body weight trends for mice fed hay and the aqueous extract; FIG. 12C compares body weight trends for mice fed hay and the chloroform extract of alfalfa, regardless of cutting.

FIGS. 13A-13F show the effects of various dietary treatments on mouse BW compared to controls both pre- and post-inoculation with Citrobacter rodentium. Data represent the mean BW±SEM. Key timepoints for blood and tissue sampling are marked by black arrows. In particular, FIG. 13A shows a body weight comparison between the control and first cut hay; FIG. 13B shows a body weight comparison between the control and fifth cut hay; FIG. 13C shows a body weight comparison between the control and first cut aqueous extract; FIG. 13D shows a body weight comparison between the control and the fifth cut aqueous extract; FIG. 13E shows a body weight comparison between the control and the first cut chloroform extract; FIG. 13F shows a body weight comparison between the control and the fifth cut chloroform extract.

FIGS. 14A-14C show the effect of alfalfa supplementation on colonic crypt depth in mice before (d14) and after (d18, 22, 28, 35) inoculation with Citrobacter rodentium. Data are represented as the mean crypt depth of 35 measurements taken along the colon of 2 mice/treatment±SEM. In particular, FIG. 14A depicts the effects of alfalfa supplementation based on form; FIG. 14B shows the effects of alfalfa supplementation based on cutting; and 14C shows the interaction of form x cutting.

FIGS. 15A-15D show the results of a serum cytokine analysis. In particular, FIG. 15A shows the serum cytokine analysis of IL-1β, by the BioLegend LegendPlex assay; FIG. 15B shows the serum cytokine analysis of IL-6 by the BioLegend LegendPlex assay; FIG. 15C shows the serum cytokine analysis of IL-1β, via ELISA analysis; and FIG. 15D shows the serum cytokine analysis of IL-6 via ELISA analysis.

FIGS. 16A-16C depict the percentage of IFN-γ-producing cells in the spleens of mice fed hay, aqueous, and chloroform extracts of first and fifth cutting alfalfa. Data are represented as the mean percentage of IFN-γ⁺ cells within the live cell gate±SEM. Bars with different superscripts are significantly different at P≤0.05. The dashed line separates the end of the feeding-enrichment period and the start of the infection period. In particular, FIG. 16A shows the effects of alfalfa supplementation based on form; FIG. 16B shows the effects of alfalfa supplementation based on cutting; and FIG. 16C shows the interaction of form x cutting.

FIGS. 17A-17C depict the percentage of T-helper 1 (T_{H}1; IFN-γ⁺ CD4⁺) cells in the spleens of mice fed hay, aqueous, and chloroform extracts of first and fifth cutting alfalfa. Data are represented as the mean percentage of CD4⁺ cells within the IFN-γ⁺ cell gate±SEM. Bars with different superscripts are significantly different at P≤0.05. The dashed line separates the end of the feeding-enrichment period and the start of the infection period. In particular, FIG. 17A shows the effects of alfalfa supplementation based on form; FIG. 17B shows the effects of alfalfa supplementation based on cutting; and FIG. 17C shows the interaction of form x cutting

FIGS. 18A-18C show the percentage of TNF-α-producing cells in the spleens of mice fed hay, aqueous, and chloroform extracts of first and fifth cutting alfalfa. Data are represented as the mean percentage of TNF-α cells within the live cell gate±SEM. Bars with different superscripts are significantly different at P≤0.05. The dashed line separates the end of the feeding-enrichment period and the start of the infection period. In particular, FIG. 18A shows the effects of alfalfa supplementation based on form; FIG. 18B shows the effects of alfalfa supplementation based on cutting; and FIG. 18C shows the interaction of form x cutting.

FIGS. 19A-19C depict the percentage of TNF-α-producing CD3⁺CD8⁺ T-cytotoxic (TC) cells in the spleens of mice fed hay, aqueous, and chloroform extracts of first and fifth cutting alfalfa. Data are represented as the mean percentage of TNF-α⁺ cells within the TC cell gate±SEM. Bars with different superscripts are significantly different at P≤0.05. The dashed line separates the end of the feeding-enrichment period and the start of the infection period. In particular, FIG. 19A shows the effects of alfalfa supplementation based on form; FIG. 19B shows the effects of alfalfa supplementation based on cutting; and FIG. 19C shows the interaction of form x cutting.

FIGS. 20A-20C show the percentage of macrophages (CD11b⁺Ly6G⁻F4/80⁺) in the spleens of mice fed hay, aqueous, and chloroform extracts of first and fifth cutting alfalfa. Effects of alfalfa supplementation are separated into FIG. 20A showing form, FIG. 20B showing cutting, and FIG. 20C showing the interaction of form x cutting. Data are represented as the mean percentage of cells within the CD11b⁺ cell gate±SEM. Bars with different superscripts are significantly different at P≤0.05. The dashed line separates the end of the feeding-enrichment period and the start of the infection period.

FIGS. 21A-21C show the percentage of B-cells (B220⁺) in the spleens of mice fed hay, aqueous, and chloroform extracts of first and fifth cutting alfalfa. Effects of alfalfa supplementation are separated into FIG. 21A showing form, FIG. 21B showing cutting, and FIG. 21C comparing the interaction of form x cutting. Data are represented as the mean percentage of cells within the live cell gate±SEM. Bars with different superscripts are significantly different at P≤0.05. The dashed line separates the end of the feeding-enrichment period and the start of the infection period.

FIGS. 22A-22C show the percentage of T-cells (CD3⁺) in the spleens of mice fed hay, aqueous, and chloroform extracts of first and fifth cutting alfalfa. Effects of alfalfa supplementation are separated into FIG. 22A showing form, FIG. 22B showing cutting, and FIG. 22C comparing the interaction of form x cutting. Data are represented as the mean percentage of cells within the live cell gate±SEM. Bars with different superscripts are significantly different at P≤0.05. The dashed line separates the end of the feeding-enrichment period and the start of the infection period.

FIGS. 23A-23C show the percentage of T helper cells (T_{H}; CD3⁺CD4⁺) in the spleens of mice fed hay, aqueous, and chloroform extracts of first and fifth cutting alfalfa. Effects of alfalfa supplementation are separated into FIG. 23A showing form, FIG. 23B showing cutting, and FIG. 23C comparing the interaction of form x cutting. Data are represented as the mean percentage of cells within the CD3⁺ cell gate±SEM. Bars with different superscripts are significantly different at P≤0.05. The dashed line separates the end of the feeding-enrichment period and the start of the infection period.

FIGS. 24A-24C depict the percentage of T cytotoxic cells (T_{C}; CD3⁺CD8⁺) in the spleens of mice fed hay, aqueous, and chloroform extracts of first and fifth cutting alfalfa. Effects of alfalfa supplementation are separated into FIG. 24A showing form, FIG. 24B showing cutting, and FIG. 24C showing the interaction of form x cutting. Data are represented as the mean percentage of cells within the CD3⁺ cell gate±SEM. Bars with different superscripts are significantly different at P≤0.05. The dashed line separates the end of the feeding-enrichment period and the start of the infection period.

FIG. 25 depicts the median relative abundance (%) of the 30 most abundant OTUs present in the colon of mice fed the control and diets supplemented with first and fifth cutting ground alfalfa hay. Maximum values were set to 19.0% to improve resolution. OTUs marked with * indicate those with a relative abundance >19.0%.

FIG. 26 shows the median relative abundance (%) of the 30 most abundant OTUs present in the colons of mice fed the control and diets supplemented with aqueous extracts from first and fifth cutting alfalfa. Maximum values were set to 19.0% to improve resolution. OTUs marked with * indicate those with a relative abundance >19.0%.

FIG. 27 depicts the median relative abundance (%) of the 30 most abundant OTUs present in the colons of mice fed the control and diets supplemented with chloroform extracts of first and fifth cutting alfalfa. Maximum values were set to 19.0% to improve resolution. OTUs marked with * indicate those with a relative abundance >19.0%.

FIG. 28 shows the average relative abundance of Citrobacter rodentium (OTU 14) in the colons of mice fed diets without alfalfa (control) and those supplemented with chloroform extracts of first or fifth cutting alfalfa. Data represent the mean relative abundance±SEM. * indicates significance at P≤0.05.

FIGS. 29A-29C depict the percentage of IFN-γ⁺CD8⁺ cells in the spleens of mice fed hay, aqueous, and chloroform extracts of first and fifth cutting alfalfa. Effects of alfalfa supplementation are separated into FIG. 29A showing form, FIG. 29B showing cutting, and FIG. 29C comparing the interaction of form x cutting. Data are represented as the mean percentage of CD8⁺ cells within the IFN-γ⁺ cell gate±SEM. Bars with different superscripts are significantly different at P≤0.05.

FIGS. 30A-30C show the percentage of TNF-α-producing macrophages (CD11b⁺Ly6G⁻F4/80⁺) cells in the spleens of mice fed hay, aqueous, and chloroform extracts of first and fifth cutting alfalfa. Effects of alfalfa supplementation are separated into FIG. 30A showing form, FIG. 30B showing cutting, and FIG. 30A comparing the interaction of form x cutting. Data are represented as the mean percentage of TNF-α⁺ cells within the macrophage gate±SEM. Bars with different superscripts are significantly different at P≤0.05. The dashed line separates the end of the feeding-enrichment period and the start of the infection period.

FIGS. 31A-31C depict the percentage of overall CD11b⁺ cells in the spleens of mice fed hay, aqueous, and chloroform extracts of first and fifth cutting alfalfa. Effects of alfalfa supplementation are separated into FIG. 31A showing form, FIG. 31B showing cutting, and FIG. 31C comparing the interaction of form x cutting. Data are represented as the mean percentage of cells within the live cell gate±SEM. Bars with different superscripts are significantly different at P≤0.05. The dashed line separates the end of the feeding-enrichment period and the start of the infection period.

FIGS. 32A-32C show the percentage of neutrophils (CD11b⁺Ly6G⁺) in the spleens of mice fed hay, aqueous, and chloroform extracts of first and fifth cutting alfalfa. Effects of alfalfa supplementation are separated into FIG. 32A showing form, FIG. 32B showing cutting, and FIG. 32C comparing the interaction of form x cutting. Data are represented as the mean percentage of cells within the CD11b⁺ cell gate±SEM. Bars with different superscripts are significantly different at P≤0.05. The dashed line separates the end of the feeding-enrichment period and the start of the infection period.

FIGS. 33A-33C show the percentage of memory B-cells (B220+CD11b⁺) in the spleens of mice fed hay, aqueous, and chloroform extracts of first and fifth cutting alfalfa. Effects of alfalfa supplementation are separated into FIG. 33A showing form, FIG. 33B showing cutting, and 33C comparing the interaction of form x cutting. Data are represented as the mean percentage of cells within the B220⁺B-cell gate±SEM. Bars with different superscripts are significantly different at P≤0.05. The dashed line separates the end of the feeding-enrichment period and the start of the infection period.

FIGS. 34A-34B show the populations of immune cells in the peripheral blood mononuclear cells (PBMC) isolated from the blood of 14 d-old Ross 708 broilers fed diets±0.25% chloroform extract of 5^{th} cutting alfalfa. FIG. 34A shows cell populations within live cell gates analyzed by flow cytometry while FIG. 34B represents CD3⁺ T cell subpopulations within the CD3⁺ gate. Data represent the mean of each cell population from 4 birds/diet±SEM. Bars with different letter superscripts are significantly different P≤0.05.

FIGS. 35A-35C show the populations of monocyte/macrophage⁺, Bu-1⁺ B cells, and CD3⁺ T cells in the peripheral blood mononuclear cells (PBMC) of healthy and Eimeria-inoculated Ross 708 broilers fed diets±0.25% chloroform extract of 5^{th} cutting alfalfa. Data represent the mean of each cell population from 4 birds/treatment±SEM. Bars with different letter superscripts are significantly different P≤0.05.

FIGS. 36A-36C show T cell subpopulations of CD3⁺CD4⁺ helper T cells, CD3+CD8α⁺ T cells, and CD3⁺ TCRγδ⁺ cells in the peripheral blood mononuclear cells (PBMC) of healthy and Eimeria-inoculated Ross 708 broilers fed diets±0.25% chloroform extract of 5^{th} cutting alfalfa. Data represent the mean of each cell population from 4 birds/treatment±SEM. Bars with different letter superscripts are significantly different P≤0.05.

### DETAILED DESCRIPTION OF THE INVENTION

The embodiments of this invention are not limited to the particular feed compositions, including the methods of making and methods of using the same. It is further to be understood that all terminology used herein is for the purpose of describing particular embodiments only and is not intended to be limiting in any manner or scope. For example, as used in this specification and the appended claims, the singular forms “a,” “an” and “the” can include plural referents unless the content clearly indicates otherwise. It should also be noted that the term “or” is generally employed in its sense including “and/or” unless the content clearly dictates otherwise. Further, all units, prefixes, and symbols may be denoted in its SI accepted form.

Numeric ranges recited within the specification are inclusive of the numbers defining the range and include each integer within the defined range. Throughout this disclosure, various aspects of this invention are presented in a range format. It should be understood that the description in range format is merely for convenience and brevity and should not be construed as an inflexible limitation on the scope of the invention. Accordingly, the description of a range should be considered to have specifically disclosed all the possible sub-ranges, fractions, and individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual numbers within that range, for example, 1, 2, 3, 4, 5, and 6, and decimals and fractions, for example, 1.2, 3.8, 1½, and 4¾. This applies regardless of the breadth of the range.

So that the present application may be more readily understood, certain terms are first defined. Unless defined otherwise, all technical and scientific terms used herein have the same meaning as commonly understood by one of ordinary skill in the art to which embodiments of the present application pertain. Many methods and materials similar, modified, or equivalent to those described herein can be used in the practice of the embodiments of the present application without undue experimentation, the preferred materials and methods are described herein. In describing and claiming the embodiments of the present application, the following terminology will be used in accordance with the definitions set out below.

The term “and/or” means any one of the items, any combination of the items, or all of the items with which this term is associated.

The term “weight percent,” “wt. %,” “percent by weight,” “% by weight,” and variations thereof, as used herein, refer to the concentration of a substance as the weight of that substance divided by the total weight of the composition and multiplied by 100. It is understood that, as used here, “percent,” “%,” and the like are intended to be synonymous with “weight percent,” “wt. %,” etc.

The term “about,” as used herein, refers to variation in the numerical quantity that can occur, for example, through typical measuring techniques and equipment, with respect to any quantifiable variable, including, but not limited to, concentration, mass, volume, time, temperature, pH, reflectance, etc. Further, given solid and liquid handling procedures used in the real world, there is certain inadvertent error and variation that is likely through differences in the manufacture, source, or purity of the ingredients used to make the compositions or carry out the methods and the like. The term “about” also encompasses amounts that differ due to different equilibrium conditions for a composition resulting from a particular initial mixture. The term “about” also encompasses these variations. Whether or not modified by the term “about,” the claims include equivalents to the quantities.

The terms “source of alfalfa” and “alfalfa-derived” as used herein includes all or part of an alfalfa plant (i.e., Medicago sativa) including raw material (e.g., roots, stems, leaves, flowers, seeds, fruit, or any germplasm) or extracts, solutions, liquids, powders, solids, capsules, or dried materials thereof. The terms “alfalfa supplementation,” “alfalfa supplemented” or “alfalfa supplement” refer to the delivering of a source of alfalfa and/or an alfalfa-derived component to a livestock animal, whether incorporated into a feed composition, incorporated into a supplement (e.g. a dietary/nutritional supplement with other sources of nutrients, vitamins, or minerals), or direct delivery to the animal.

The methods and compositions described herein may comprise, consist essentially of, or consist of the components and ingredients enumerated in exemplary embodiments as well as other ingredients described herein. As used herein, “consisting essentially of” means that the methods and compositions may include additional steps, components or ingredients, but only if the additional steps, components or ingredients do not materially alter the basic and novel characteristics of the claimed methods and compositions.

Various other terms are defined herein below.

Components of Alfalfa-Derived Bioactive Additive

The present application employs one or more alfalfa-derived bioactive additives. Alfalfa is a perennial plant, meaning it can be cut for hay at several points during the growing season. Alfalfa may be cut between one and about six times during the growing season. Based on the maturity and time of cutting, a number of environmental factors and harvest conditions can alter the nutrient composition of alfalfa.

As alfalfa matures from early bud to late bloom, crude protein (CP) decreases, with minimal changes to gross energy (GE), and increases in acid detergent fiber (ADF) and carbohydrate content. Both stage of maturity and hour of cutting alter protein primary structures, which correlate with protein metabolism in livestock, particularly ruminant animals. Within the true protein fraction of CP, the amount of rapidly-degradable protein increases with maturity while levels of intermediate and slowly-degraded protein decreases. While maturity has no effect on carbohydrate fractions, hour of cutting (afternoon vs. early morning) increases the amount of rapidly degradable carbohydrates alfalfa.

Accordingly, the stage of maturity and hour of cutting may be selected in order to achieve the desired relative nutrient quantities and concentration. In a preferred embodiment, the alfalfa used as part of an animal feed supplement is a late cutting alfalfa. In an aspect, the late cutting alfalfa is the fourth through the sixth cutting of alfalfa. In a preferred embodiment, the alfalfa used for an animal feed supplement is from the fifth cutting.

A number of phytochemicals and other compounds in alfalfa have beneficial nutraceutical effects in livestock. In particular, saponins, fatty acids, phytoestrogens, and polysaccharides contribute to both overall health, immune health, and/or improved intestinal microbiota in livestock.

Saponins

Saponins belong to the class of steroid and terpenoid glycosides which are generally anti-nutritional triterpene glycosides. In alfalfa, saponins are often measured as the aglycone precursors known as sapogenins, of which medicagenic acid, zanhic acid, and soyasaponin are found in high concentrations in alfalfa. Generally, total saponins in alfalfa increase from Spring to Summer and decrease from Summer to Autumn, although the saponin content can be significantly influenced by a complex interplay of environmental factors.

Saponins play a role in both adaptive and innate immunity. According to the present disclosure, despite being generally anti-nutritional, saponins can be used to support immune function in livestock. Without being bound by theory, it is though that saponins downregulate the nuclear factor (NF)-κB pathway, resulting in downstream reduction in expression of toll-like receptor (TLR)-4 and inducible nitric oxide synthase (iNOS) and decreased production of pro-inflammatory mediators such as nitric oxide (NO), interleukin (IL)-6, and IL-1β, both in vitro and in vivo. Oral administration of saponins can enhance antibody responses, specifically serum immunoglobulin (Ig)G responses, the number of IgA⁺ cells in the intestines, and can increase proliferation of T and B-cells.

In addition to immune function, embodiments of the present application may use saponins to improve intestinal microbiota in livestock. Although dietary saponins are generally considered anti-nutritional and are not readily consumed in large quantities due to their bitter taste, the present application has found that administration of saponins as part of an alfalfa-derived feed supplement can beneficially improve intestinal microbiota. In particular, saponins administered orally can reduce the relative abundance of dominant phyla in the microbiome and increase the relative abundance of beneficial community members such as Bacteroides, Lactobacillus, and Bifidobacterium.

Without being bound by theory, it is thought that members of the colonic microbiota hydrolyze saponins to remove the sugar moiety and release bioactive sapogenins. Thus, overall saponins as part of an alfalfa supplement may provide a prebiotic effect that beneficially alters the microbial community in both healthy and diseased animals.

In an embodiment, the alfalfa extract of the present application may include between about 0 wt. % to about 95 wt. % saponins, including from between about 0-1, 1-2, 2-3, 3-4, 4-5, 5-6, 6-7, 7-8, 8-9, 9-10, 10-11, 11-12, 12-13, 13-14, 14-15, 15-16, 16-17, 17-18, 18-19, 19-20, 20-21, 21-22, 22-23, 23-24, 24-25, 25-26, 26-27, 27-28, 28-29, 29-30, 30-31, 31-32, 32-33, 33-34, 34-35, 35-36, 36-37, 37-38, 38-39, 39-40. 40-41, 41-42, 42-43, 43-44, 44-45, 45-46, 46-47, 47-48, 48-49, 49-50, 50-51, 51-52, 52-53, 53-54, 54-55, 55-56, 56-57, 57-58, 58-59, 59-60, 60-61, 61-62, 62-63, 63-64, 64-65, 65-66, 66-67. 67-68, 68-69, 69-70, 70-71, 71-72, 72-73, 73-74, 74-75, 75-76, 76-77, 77-78, 78-79, 79-80, 80-81, 81-82, 82-83, 83-84, 84-85, 85-86, 86-87, 87-88, 88-89, 89-90, 90-91, 91-92, 92-93, 93-94, 94-95, 95-96, 96-97, 97-98, or 98-99 wt. %

Fatty Acids

Fatty acids include carboxylic acids with saturated or unsaturated, branched or unbranched aliphatic chains. When combined with glycerol, fatty acids form lipids, especially phospholipids, and triglycerides. The three essential omega-3 (also known as n-3) fatty acids include alpha-linoleic acid (ALA), eicosapentaenoic acid (EPA), and docosahexaenoic acid (DHA). ALA in particular is found primarily in plant-based oils. Lineoleic acid (LA) is a primary essential omega-6 (n-6) fatty acid. Linoleic acid (LA) and alpha linolenic acid (ALA) belong to the omega-6 and omega-3 series of polyunsaturated fatty acids (PUFA), respectively.

Upon consumption, omega-6 PUFAs are converted to arachidonic acid by a series of desaturation and elongation reactions. Further metabolism of arachidonic acid results in the formation of pro-inflammatory mediators including prostaglandins and leukotrienes. As a result, omega-6 fatty acids are considered to be pro-inflammatory. In contrast, dietary omega-3 fatty acids are metabolized to eicosapentanoic acid (EPA) and docosahexanoic acid (DHA), which are considered to be the biologically active omega-3 PUFAs. These two fatty acids displace arachidonic acid in lipid membranes, resulting in the decreased availability of substrate for the metabolic conversion of arachidonic acid into pro-inflammatory mediators. This results in the classification of omega-3 fatty acids as anti-inflammatory.

For livestock, supplementing diets with sources of omega-3 PUFAs can lead to decreased lymphocyte proliferation and a decreased presence of pro-inflammatory markers. Additionally, livestock diets with low omega-6 to omega-3 ratios can lead to improved cytokine responses which correlated to improved immunity. In particular, fatty acids present in a chloroform extract of alfalfa according to the present disclosure may be used to inhibit inflammation in livestock.

In an embodiment, the alfalfa extract of the present application may include between about 0 wt. % to about 95 wt. % fatty acids, including from between about 0-1, 1-2, 2-3, 3-4, 4-5, 5-6, 6-7, 7-8, 8-9, 9-10, 10-11, 11-12, 12-13, 13-14, 14-15, 15-16, 16-17, 17-18, 18-19, 19-20, 20-21, 21-22, 22-23, 23-24, 24-25, 25-26, 26-27, 27-28, 28-29, 29-30, 30-31, 31-32, 32-33, 33-34, 34-35, 35-36, 36-37, 37-38, 38-39, 39-40. 40-41, 41-42, 42-43, 43-44, 44-45, 45-46, 46-47, 47-48, 48-49, 49-50, 50-51, 51-52, 52-53, 53-54, 54-55, 55-56, 56-57, 57-58, 58-59, 59-60, 60-61, 61-62, 62-63, 63-64, 64-65, 65-66, 66-67. 67-68, 68-69, 69-70, 70-71, 71-72, 72-73, 73-74, 74-75, 75-76, 76-77, 77-78, 78-79, 79-80, 80-81, 81-82, 82-83, 83-84, 84-85, 85-86, 86-87, 87-88, 88-89, 89-90, 90-91, 91-92, 92-93, 93-94, 94-95, 95-96, 96-97, 97-98, or 98-99 wt. %

Phytoestrogens

Phytoestrogens are polyphenolic compounds found in plants that have similar structures to estrogen and exhibit agonism with estrogen receptor. Classification of phytoestrogens is based on structural properties and biosynthesis, with the main classes being flavonoids, lignans, and stilbenoids. Flavonoids are enriched in legumes and subgroups within this class include isoflavones, flavonols, and coumestans. The quantities of each of these compounds can vary among legumes, with alfalfa and its extract being found to have high amounts of quercetin, daidzein, apigenin, coumestrol, and luteolin. Concentrations of phytoestrogens are greatest during the early stages of plant development, with apigenin and coumestrol found in higher concentrations than the other phytoestrogens quercetin and luteolin, except during the flowering stage where all phytoestrogens are found in similar amount. Within the plant, concentrations of phytoestrogens are highest in the flowers with apigenin and quercetin being found in greater amounts than luteolin and coumestrol. In early-flowering alfalfa harvested at three points during the growing season, flavonoid concentration often decreases between the first and second/third cuttings.

According to the present application, phytoestrogens can be used to impact the immune system through a variety of mechanisms. Without wishing to be bound by theory, it is thought that the flavanol quercetin impacts immunity by inhibiting the production of pro-inflammatory cytokines in lipopolysaccharide (LPS)-induced RAW264.7 murine macrophages and upregulating the expression of a TLR-4 suppressor protein. This ultimately can result in suppression of the inflammatory response to LPS, as TLR-4 is responsible for immune response to LPS. Quercetin can also be used to reduce percentages of CD4⁺, IFN-γ⁺CD4⁺, and TNF-α′CD4⁺ T-cells in animals.

Isoflavone phytoestrogens such as daidzein and genistein may improve immune function, including reductions in body weight loss during illness, improved colon histopathological scores, suppression of pro-inflammatory production in cultured monocytes stimulated with LPS, and inhibition of macrophage activation. These results show that phytoestrogens inhibit inflammatory responses that may ameliorate colitis and other inflammatory conditions.

Flavonoid phytoestrogens, particularly apigenin, can reduce the numbers of neutrophils and monocytes during experimental peritonitis. One of the major non-flavonoid phytoestrogens isolated from alfalfa, coumestrol, can have therapeutic potential for slowing disease progression and altering splenic T-cell subsets.

Overall, phytoestrogens can have anti-inflammatory properties that may play a role in ameliorating colitis and other inflammatory conditions. Previously, others seeking to use phytoestrogens to improve livestock immune function have focused largely on uncharacterized blends of phytoestrogens from soybeans. There was no assurance that the responses observed in soybean phytoestrogens may not be predictors of responses to the same class of phytochemicals in alfalfa, as the potency of responses varies between legumes. The present application has beneficially found that phytoestrogens from alfalfa can be used to improve livestock immune health.

In addition to immune health, phytoestrogens are used according to the present application to improve intestinal microbiota of livestock. In particular, phytoestrogens may be used to improve intestinal microbiome to combat overweight and obesity. Quercetin supplementation can increase Bacteroidetes while reducing the abundance of Proteobacteria and Actinobacteria to healthy levels in animal microbiota.

In an embodiment, the alfalfa extract of the present application may include between about 0 wt. % to about 95 wt. % phytoestrogens, including from between about 0-1, 1-2, 2-3, 3-4, 4-5, 5-6, 6-7, 7-8, 8-9, 9-10, 10-11, 11-12, 12-13, 13-14, 14-15, 15-16, 16-17, 17-18, 18-19, 19-20, 20-21, 21-22, 22-23, 23-24, 24-25, 25-26, 26-27, 27-28, 28-29, 29-30, 30-31, 31-32, 32-33, 33-34, 34-35, 35-36, 36-37, 37-38, 38-39, 39-40. 40-41, 41-42, 42-43, 43-44, 44-45, 45-46, 46-47, 47-48, 48-49, 49-50, 50-51, 51-52, 52-53, 53-54, 54-55, 55-56, 56-57, 57-58, 58-59, 59-60, 60-61, 61-62, 62-63, 63-64, 64-65, 65-66, 66-67. 67-68, 68-69, 69-70, 70-71, 71-72, 72-73, 73-74, 74-75, 75-76, 76-77, 77-78, 78-79, 79-80, 80-81, 81-82, 82-83, 83-84, 84-85, 85-86, 86-87, 87-88, 88-89, 89-90, 90-91, 91-92, 92-93, 93-94, 94-95, 95-96, 96-97, 97-98, or 98-99 wt. %

Polysaccharides

Polysaccharides are long chains of carbohydrate molecules, specifically polymeric carbohydrates composed on monosaccharide units bound together by glycosidic linkages. The particular immune benefit observed by treatment with polysaccharides can vary depending upon the source of the polysaccharide. Hemicellulosic and pectic polysaccharides from alfalfa are linked to decreased expression of IL-1β, IL-6, and cyclooxygenase-2.

With respect to microbiome, plant-based sources of polysaccharides can ameliorate diseases in animals by shifting the major phyla in the microbiome to a more health balance of bacteria. Polysaccharides in fiber, rather than extracted polysaccharides from specific plant sources can have an impact on the intestinal microbiota due to its well-established function as a substrate for bacterial fermentation. According to the present application, alfalfa-based fiber-rich meal in the diet can be used to increase species richness and diversity in intestinal microbiome and decrease the abundance of pathogenic bacteria.

In an embodiment, the alfalfa extract of the present application may include between about 0 wt. % to about 95 wt. % polysaccharides, including from between about 0-1, 1-2, 2-3, 3-4, 4-5, 5-6, 6-7, 7-8, 8-9, 9-10, 10-11, 11-12, 12-13, 13-14, 14-15, 15-16, 16-17, 17-18, 18-19, 19-20, 20-21, 21-22, 22-23, 23-24, 24-25, 25-26, 26-27, 27-28, 28-29, 29-30, 30-31, 31-32, 32-33, 33-34, 34-35, 35-36, 36-37, 37-38, 38-39, 39-40. 40-41, 41-42, 42-43, 43-44, 44-45, 45-46, 46-47, 47-48, 48-49, 49-50, 50-51, 51-52, 52-53, 53-54, 54-55, 55-56, 56-57, 57-58, 58-59, 59-60, 60-61, 61-62, 62-63, 63-64, 64-65, 65-66, 66-67. 67-68, 68-69, 69-70, 70-71, 71-72, 72-73, 73-74, 74-75, 75-76, 76-77, 77-78, 78-79, 79-80, 80-81, 81-82, 82-83, 83-84, 84-85, 85-86, 86-87, 87-88, 88-89, 89-90, 90-91, 91-92, 92-93, 93-94, 94-95, 95-96, 96-97, 97-98, or 98-99 wt. %.

In an embodiment, the alfalfa extract may be comprised as described in Table 1.

TABLE 1
Alfalfa Composition

| Component | Early Cutting | Late Cutting |
|---|---|---|
| Moisture | 10-15 | 10-15 |
| Dry Matter | 80-90 | 80-90 |
| Crude Protein | 15-20 | 25-30 |
| Fat | 1-3 | 1-3 |
| Ash | 8-12 | 7-12 |
| Neutral Detergent Fiber | 35-45 | 25-30 |
| Acid Detergent Fiber | 25-35 | 18-27 |
| Lignin | 4-8 | 3-7 |
| Calcium | 1-3 | 1-3 |
| Phosphorous | 0.1-0.5 | 0.1-0.5 |
| Magnesium | 0.1-0.5 | 0.1-0.5 |
| Potassium | 1-3 | 1-3 |
| Chloride | 0.1-1 | 0.1-1 |
| Sodium | 0.01-0.5 | 0.01-0.5 |
| Copper (ppm) | 5-10 | 5-10 |
| Zinc (ppm) | 20-40 | 20-40 |
| Sulfur | 0.01-1 | 0.01-1 |
| Iron (ppm) | 150-250 | 100-200 |
| Manganese (ppm) | 30-70 | 50-100 |
| Nitrate-N (ppm) | 125-175 | 25-75 |
| Non-Fiber Carbohydrates | 25-35 | 35-45 |

Methods of Preparing an Alfalfa-Derived Bioactive Additive

In an embodiment, the application is directed to methods of preparing an alfalfa-derived bioactive additive for a livestock feed composition. The additive may be prepared by any suitable method, but in an embodiment the first step in preparing the additive comprises obtaining initial extracts from alfalfa plant material. Extracts are generally prepared by separating or otherwise fragmenting whole plant material and using a solvent at a suitable plant to solvent ratio and temperature to extract the preferred plant component.

Fragmentation of the whole plant material may occur by any suitable method, whether manually or automatically (i.e., using a machine or device), including maceration, ultrasound-assisted solvent extraction, and Soxhlet extraction, among others. For the purposes of obtaining bulk extracts for use as a feed additive in animal diets, methods that do not require special equipment and can be completed at a large scale without the risk of damaging compounds are most appropriate. In a preferred embodiment, maceration is used to obtain the initial alfalfa plant extract. In a further preferred embodiment, maceration is used to obtain alfalfa plant extract in bulk.

Extraction by maceration in the context of preparing plant extracts is completed by combining plant material and solvent in the same container and allowing extraction to occur through constant contact. This is a simple method that can be scaled up for increased production but utilizes large amounts of solvent and may not be as exhaustive as other methods.

Additionally, or alternatively, water decoction may be used to prepare an herbal decoction using multiple components of the alfalfa plant. Decoction comprises extraction by maceration and subsequent boiling of selected plant material. The mash created as a result of the boiling is then strained.

Extraction may occur using any suitable solvent including, including polar, nonpolar, and/or semipolar solvents. Suitable solvents include, without limitation, water, alcohols such as methanol, ethanol, and 2-propanol; aliphatic hydrocarbons such as propane, butane, hexane and petrol; hydrocarbons with a carbonyl group such as acetone and methyl acetate; halogen derivatives such as dichloromethane, dichloroethane, chloroform, and freons; and mixtures thereof. In a preferred embodiment, the solvent is a lipophilic solvent such as petrol or chloroform.

In an embodiment, the alfalfa additive is present in a solution at a ratio of alfalfa to solvent of about 1:2 to about 1:10, including a ratio of 1:3, 1:4, 1:5, 1:6, 1:7, 1:8, or 1:9. In preferred embodiments, the solvent is water and/or chloroform.

In an embodiment the alfalfa is extracted under any suitable temperature including room temperature, and a temperature of between about 20° C. to about 120° C. including, for example 40° C. and 60° C.

The extraction process for preparing the bioactive additive may occur over any suitable time period, for example between 2 hours and about 80 hours, for example, 2 hours, 4 hours, 8 hours, 10 hours, 20 hours, 24 hours, 48 hours, 72 hours, or 96 hours.

Incorporation of Alfalfa-Derived Bioactive Additive into a Feed Composition

The feed compositions of the present application preferably include an alfalfa-derived bioactive additive incorporated into a base animal feed composition (i.e., the remainder of the animal feed composition exclusive of the alfalfa-derived bioactive additive). The base composition may comprise, for example, a carbohydrate source including fodder and/or forage crops and may further include additional ingredients such as a supplementary protein source, additional fats, and other desired minerals, vitamins, and/or nutrients.

Carbohydrate Source

Forage crops are crops on which animals graze independently or crops that have purposes other than animal feed. Primary examples of suitable forage crops include grasses and legumes such as bentgrass, oat-grass, hurricane grass, Surinam grass, koronivia grass, bromegrass, buffelgrass, Rhodes grass, bermudagrass, orchard grass, antelope grass, Bungoma grass, tall fescue, meadow fescue, red fescue, black spear grass, West Indian marsh grass, jaragua grass, southern cutgrass, Italian ryegrass, perennial ryegrass, Guinea grass, molasses grass, carabao grass, dallisgrass, reed canary grass, timothy grass, bluegrass, wheatgrass, pinto peanut, roundleaf sensitive pea, butterfly-pea, bird's-foot trefoil, purple bush-bean, burgundy bean, alfalfa, barrel medic, sweetclover, soybean, common sainfoin, Townsville stylo, shrubby stylo, clovers such as alsike clover, crimson clover, red clover, white clover, vetches, mulga, silk trees, Belmont sins, lebbeck, earpod tree, leadtree, maize, sorghum, oats, or a combination thereof.

Fodder crops are crops that are cultivated primarily for animal feed. Primary examples of suitable forage crops include maize, sorghum, rye such as Italian ryegrass, English perennial ryegrass, alfalfa, green oilseeds, legumes such as birdsfoot, trefoil, lespedeza, kudzu, sesbania, sainfoin, esparcette, and sulfa, grasses such as bent, redtop, florin grass, bluegrass, Columbus grass, fescue, Napier, elephant grass, orchard grass, Rhodes grass, Sudan grass, and Timothy grass, cabbage, pumpkins, turnips, beets, carrots, swedes, vegetable roots, non-leguminous hay, hay from leguminous crops such as alsike clover, crimson clover, red clover, white clover, and alfalfa; brans of wheat, rice, barley, maize, rye, oat, millet, sorghum, buckwheat, fonio, triticale, and pulses; soybean, groundnut, copra, palm kernel, sunflower seed, rapeseed, olive, safflower, sesame, mustard, poppy, kapok, cottonseed, linseed, and hempseed cakes (i.e. residue from oil extraction), potato offals, beet pulp, bagasse, pulp (e.g. the waste of fruit used for feed), marc of grape, beet tops, cane tops, straw and husks, leaves, top and vines, food wastes, meat meal, fish meal, blood meal, compound feed, pet food, gluten feed and meal, byproducts of other industry processes such as the ethanol industry (distiller's dried grains with solubles), or a combination thereof.

The carbohydrate, whether forage or fodder, may be provided in any suitable form, including, for example, raw (fresh), dried, whole, cut, chopped, milled, pressed, pelletized, granularized, ground, or a combination thereof.

The carbohydrate may comprise between about 1 wt. % to about 99 wt. % of the animal feed composition as a whole, including between about 0-1, 1-2, 2-3, 3-4, 4-5, 5-6, 6-7, 7-8, 8-9, 9-10, 10-11, 11-12, 12-13, 13-14, 14-15, 15-16, 16-17, 17-18, 18-19, 19-20, 20-21, 21-22, 22-23, 23-24, 24-25, 25-26, 26-27, 27-28, 28-29, 29-30, 30-31, 31-32, 32-33, 33-34, 34-35, 35-36, 36-37, 37-38, 38-39, 39-40. 40-41, 41-42, 42-43, 43-44, 44-45, 45-46, 46-47, 47-48, 48-49, 49-50, 50-51, 51-52, 52-53, 53-54, 54-55, 55-56, 56-57, 57-58, 58-59, 59-60, 60-61, 61-62, 62-63, 63-64, 64-65, 65-66, 66-67. 67-68, 68-69, 69-70, 70-71, 71-72, 72-73, 73-74, 74-75, 75-76, 76-77, 77-78, 78-79, 79-80, 80-81, 81-82, 82-83, 83-84, 84-85, 85-86, 86-87, 87-88, 88-89, 89-90, 90-91, 91-92, 92-93, 93-94, 94-95, 95-96, 96-97, 97-98, or 98-99 wt. %. Preferably, the carbohydrate source is present between about 20 wt. % to about 80 wt. %, more preferably between about 75 wt. % to about 90 wt. % of the animal feed composition.

Supplementary Protein Source

The animal feed composition may further include one or more supplemental sources of protein. Supplementary protein sources may include plant-based protein sources and/or animal/insect-based protein sources. Suitable plant-based protein sources include, without limitation, soy meal, sunflower meal, canola meal, distiller's dried grains with solubles (DDGS), pea protein, bean protein, lupins, lemna, algae, sweet potato, especially sweet potato foliage, common vetch seeds, hempseed cake, castor oil meal, pigeon pea, rapeseed, cassava foliage, duckweed, or a combination thereof. Suitable animal- and insect-based sources include, without limitation, fish meal, blood meal, poultry by-product (ground poultry offal), meat meal, keratin, insect meal such as maggot meal, silkworm pupae, snail meal, and grasshopper meal, or a combination thereof.

The supplementary protein source may comprise between about 1 wt. % to about 99 wt. % of all protein sources, including between about 0-1, 1-2, 2-3, 3-4, 4-5, 5-6, 6-7, 7-8, 8-9, 9-10, 10-11, 11-12, 12-13, 13-14, 14-15, 15-16, 16-17, 17-18, 18-19, 19-20, 20-21, 21-22, 22-23, 23-24, 24-25, 25-26, 26-27, 27-28, 28-29, 29-30, 30-31, 31-32, 32-33, 33-34, 34-35, 35-36, 36-37, 37-38, 38-39, 39-40. 40-41, 41-42, 42-43, 43-44, 44-45, 45-46, 46-47, 47-48, 48-49, 49-50, 50-51, 51-52, 52-53, 53-54, 54-55, 55-56, 56-57, 57-58, 58-59, 59-60, 60-61, 61-62, 62-63, 63-64, 64-65, 65-66, 66-67. 67-68, 68-69, 69-70, 70-71, 71-72, 72-73, 73-74, 74-75, 75-76, 76-77, 77-78, 78-79, 79-80, 80-81, 81-82, 82-83, 83-84, 84-85, 85-86, 86-87, 87-88, 88-89, 89-90, 90-91, 91-92, 92-93, 93-94, 94-95, 95-96, 96-97, 97-98, or 98-99 wt. %. Preferably, the carbohydrate source is present between about 5 wt. % to about 35 wt. %, more preferably between about 8 wt. % to about 25 wt. % of the animal feed composition.

Lipids and Fats

Suitable lipid sources for the composition of the present disclosure may be any known or used in the art, including but not limited to, animal-based and/or plant-based sources. Suitable animal-based fat sources include, without limitation, milk fat, butter, butter fat, egg yolk lipid; marine sources, such as fish oils, marine oils, single cell oils, or a combination thereof. Suitable vegetable and plant oil sources include, without limitation, corn oil, canola oil, sunflower oil, soybean oil, palm olein oil, coconut oil, high oleic sunflower oil, evening primrose oil, rapeseed oil, olive oil, flaxseed (linseed) oil, cottonseed oil, high oleic safflower oil, palm stearin, palm kernel oil, wheat germ oil; medium chain triglyceride oils and emulsions and esters of fatty acids, or a combination thereof. Examples include, but are not limited to, fatty acids (e.g., stearic, palmitic, oleic, linoleic, and lauric acid), complex lipids (e.g., phospholipids), and monoglycerides and diglycerides.

Sources of edible fats may include, but are not limited to, coconut oil, corn oil, cottonseed oil, fish oil, olive oil, palm oil, sesame oil, soybean oil, canola oil, sunflower seed oil, tallow, greases, beef fat, restaurant fats, and mixtures thereof.

The lipids/fats may comprise between about 1 wt. % to about 99 wt. % of the animal feed composition as a whole, including between about 0-1, 1-2, 2-3, 3-4, 4-5, 5-6, 6-7, 7-8, 8-9, 9-10, 10-11, 11-12, 12-13, 13-14, 14-15, 15-16, 16-17, 17-18, 18-19, 19-20, 20-21, 21-22, 22-23, 23-24, 24-25, 25-26, 26-27, 27-28, 28-29, 29-30, 30-31, 31-32, 32-33, 33-34, 34-35, 35-36, 36-37, 37-38, 38-39, 39-40. 40-41, 41-42, 42-43, 43-44, 44-45, 45-46, 46-47, 47-48, 48-49, 49-50, 50-51, 51-52, 52-53, 53-54, 54-55, 55-56, 56-57, 57-58, 58-59, 59-60, 60-61, 61-62, 62-63, 63-64, 64-65, 65-66, 66-67. 67-68, 68-69, 69-70, 70-71, 71-72, 72-73, 73-74, 74-75, 75-76, 76-77, 77-78, 78-79, 79-80, 80-81, 81-82, 82-83, 83-84, 84-85, 85-86, 86-87, 87-88, 88-89, 89-90, 90-91, 91-92, 92-93, 93-94, 94-95, 95-96, 96-97, 97-98, or 98-99 wt. %. Preferably, the lipids are present between about 20 wt. % to about 80 wt. %, more preferably between about 75 wt. % to about 90 wt. % of the animal feed composition.

Vitamins, Minerals and Other Nutrients

Lipids are excellent carriers for some feed supplements including vitamins. Examples of such vitamins include, but are not limited to, vitamins A, E, K, and the B group vitamins. Optionally, dietary nitrogen may be included in the lipids. Optional dietary nitrogen sources include, but are not limited to, ammonia, ammonium polyphosphate, animal protein products, oilseed meals, synthetic amino acids, and urea. Optionally, various vitamins may be added to the mixture. Optionally, various trace minerals and elements may be added to the mixture.

Examples of such trace minerals and elements include, but are not limited to, cobalt sulfate, copper sulfate, ferrous sulfate, ferrous oxide, iodines, manganese sulfate, potassium iodate, selenium and its compounds, sulphur, zinc oxide, and zinc sulfate, etc.

The vitamins, minerals, and other nutrients or trace elements may be present in the animal feed composition in an amount of between about 0 wt. % to about 50 wt. %, including between about 0-1, 1-2, 2-3, 3-4, 4-5, 5-6, 6-7, 7-8, 8-9, 9-10, 10-11, 11-12, 12-13, 13-14, 14-15, 15-16, 16-17, 17-18, 18-19, 19-20, 20-21, 21-22, 22-23, 23-24, 24-25, 25-26, 26-27, 27-28, 28-29, 29-30, 30-31, 31-32, 32-33, 33-34, 34-35, 35-36, 36-37, 37-38, 38-39, 39-40. 40-41, 41-42, 42-43, 43-44, 44-45, 45-46, 46-47, 47-48, 48-49, and 49-50 wt. % of the animal feed composition.

Other Optional Ingredients

Optionally, various drugs, medicaments, insecticides, enzymes, antimicrobials, probiotics, prebiotics, and the like may be added to the mixture. The other optional ingredients may be present in the animal feed composition in an amount of between about 0 wt. % to about 50 wt. %, including between about 0-1, 1-2, 2-3, 3-4, 4-5, 5-6, 6-7, 7-8, 8-9, 9-10, 10-11, 11-12, 12-13, 13-14, 14-15, 15-16, 16-17, 17-18, 18-19, 19-20, 20-21, 21-22, 22-23, 23-24, 24-25, 25-26, 26-27, 27-28, 28-29, 29-30, 30-31, 31-32, 32-33, 33-34, 34-35, 35-36, 36-37, 37-38, 38-39, 39-40. 40-41, 41-42, 42-43, 43-44, 44-45, 45-46, 46-47, 47-48, 48-49, and 49-50 wt. % of the animal feed composition.

Formation of an Animal Feed Composition with Bioactive Additive

Any suitable method for treating the base animal feed composition with an alfalfa-based bioactive additive may be used. For example, the additive may be mixed with animal feed. The animal feed may be in the form of a solid or a liquid, and the alfalfa-based bioactive may be provided as a solid or a liquid. Upon combination, the animal feed containing the additive may be provided in the form of a liquid, e.g., as a concentrate or solution, or as a solid, e.g., in the form of a block, mash, crumbles, pellets, grains, tablets, or other solid composition.

As part of forming an animal feed composition containing the bioactive additive of the present disclosure, the carbohydrate source may be combined with the bioactive additive and other additional components described herein by any means suitable, where the carbohydrate and/or other components are provided as a homogenous mixture, non-homogenous mixture, slurry, mash, liquid concentrate, liquid spray, raw, dried, whole, cut chopped, milled pressed, pelletized, granularized, or ground component, or a combination thereof.

For example, in an embodiment, the bioactive additive, protein source, additional lipids, and/or vitamins and minerals may be provided as a liquid spray which is sprayed onto the carbohydrate source. According to another embodiment, the bioactive additive is provided in the form of pellets, and a base animal feed composition comprising a carbohydrate source, protein source, and/or vitamins and minerals form a homogenous mixture which is also pelletized, and the pellets of the bioactive additive and the base animal feed composition are combined to form a mixture.

The bioactive additive may also be added directly to straw or hay, wherein application of the additive is by use of a spray system installed on each baler used. Spray nozzles are installed at the optimum location to uniformly distribute the additive to the hay on entry to the baler. The nozzle type, number and location are determined on the basis of the specific bailer design. The additive is fed to the nozzles by means of piping and hose from a pump driven by a variable speed motor. The motor speed is adjusted to deliver the specified quantity of the additive to the hay. An additive supply tank may be attached to the baler or the tractor pulling the baler is piped to the feed pump suction.

For loose hay that is stacked, the additive may be sprayed on top of each layer of hay added (about 18-inch-thick layer). The spray system may be a handheld spray nozzle or series of nozzles mounted on a suspended rack that can be posited above the haystack as layers of hay are added. A supply tank, piping, hose, pump with variable-speed drive are provided at the stacking site to feed lipid to the spraying nozzle(s).

Baled or loose hay can be treated with the additive just prior to feeding. The additive can be applied to bailed or loose hay by standard spray apparatus. To avoid waste, each bale or lot of loose hay should be placed in a large pan during the spraying operation. Additive draining of the hay collects in the pan for reuse.

The additive can be injected into round bales by inserting a sparge pipe into the center axis. Using a high pressure pump, the additive is distributed in the hay uniformly through the sparge pipe nozzles. The inserted end of the sparge pipe is closed with a conical cap to facilitate penetration.

For round hay bales, the additive can be applied, by rotating the bale in a pan containing the specified quantity of the additive, preferably in liquid form. After the specified quantity of the additive has been absorbed by the rotating bale, the bale is lifted up above the pan and placed on a drainage rack. Additive draining from the bale flows back to the pan for use in the next application.

Square (rectangular) bales can be treated with the additive by emersion in a vat of the additive for sufficient time to absorb the specified quantity. The treated bale is lifted out of the vat and placed on a rack to enable free additive to drain back into the vat for further use.

Livestock Animals

Any animal, including companion animals along with ruminant or non-ruminant livestock can be fed the animal feed according to the invention, this includes animals such as cattle, horses, goats, swine, poultry, game birds, and sheep. This may also include companion animals such as dogs and cats, along with smaller animals such as rabbits and guinea pigs. The animal feed may be fed at any time during the animal's life and in any amount sufficient for the particular animal.

Methods of Using Alfalfa-Derived Bioactive Additive

Phytochemical research has the potential to improve non-ruminant livestock health through the identification of nutraceutical compounds. This thesis focused on alfalfa (Medicago sativa) as a potential source of nutraceutical compounds for non-ruminant livestock. Alfalfa is part of the legume (Fabaceae) family and associated with health benefits in both humans and animals. When implemented in monogastric diets, the high concentration of insoluble fiber typically limits alfalfa inclusion; however, alfalfa extracts can circumvent this issue. The understanding of alfalfa's benefits are limited by inconsistencies between supplementation forms used in published literature and a lack of information on how known changes to nutritional and phytochemical profiles due to plant maturity, season, time of harvest, and cutting translate to animal health.

Livestock research into alfalfa's health-promoting qualities primarily focuses on performance parameters in healthy animals and does not typically provide detailed examination into physiological changes underlying these responses. In nutraceutical research, two systems of interest in characterizing responses to feed additives are the host immune system and intestinal microbiota. These two systems interact with each other and dietary components to modulate inflammatory responses and promote overall health; however, descriptively assessing changes to the host immune system and microbiota in livestock is limited by the scarcity of available reagents for these species. As a result, the present application used mice to assess immunological and microbiological responses to alfalfa supplementation. To determine how changes observed at baseline health translated to modified immune responses, animals were challenged with rodent-specific Citrobacter rodentium. This bacterial pathogen is effective at colonizing the murine colon, has a known timeline of infection, and well-documented effects on both the immune system and intestinal microbiota. The work presented here examined changes to the host immune system and intestinal microbiota underlying BW, FI, and colon histomorphology responses in healthy and pathogen-challenged mice due to dietary supplementation with different forms (ground hay, water-, or lipid-soluble extract) of first or fifth cutting alfalfa.

In addition to discrepancies in alfalfa research based on supplementation form, cutting, and measured biological outcomes, a number of different extraction methods are described throughout phytochemical research. These methods vary based on ratios of alfalfa: solvent, the use of special equipment (e.g., Soxhlet apparatus), duration of extraction, and utilization of heat to accelerate the process. An objective of the present application is to utilize a simple extraction method (maceration) with a number of different alfalfa: solvent ratios, temperatures, and durations to optimize the nutrient profiles of aqueous and chloroform alfalfa extracts. In the case of aqueous extracts, extractions done at a 1:5 ratio of alfalfa:water for 24 h maximized crude protein while temperature did not have an effect. As extraction temperature did not impact crude protein content in the final product, aqueous extracts were performed at room temperature to avoid degradation of thermosensitive compounds. Based on previous work, a 72 h extraction was selected for chloroform extracts prior to trials to correspond with exhaustive methods utilizing a Soxhlet apparatus. For these extracts, a 1:4 alfalfa:chloroform ratio at 40° C. maximized the crude fat content of the resulting product.

In addition to optimizing extraction methods, fatty acid profiles of the alfalfa hays and extracts were analyzed to gain preliminary insights into differences between the forms and cuttings. One notable difference between the two hay cuttings was the presence of omega-6 linoleic acid in first cutting (13.4%) and omega-3 linolenic acid in fifth cutting alfalfa (26.4%). Fatty acid profiles of aqueous extracts predominantly consisted of saturated palmitic and stearic acids, but the overall percentage of crude fat in these extracts was expectedly low at 1-2%. In contrast, chloroform extracts contained mostly palmitic and linoleic acid with those obtained from fifth cutting alfalfa having numerically greater percentages of linolenic acid compared to first cutting (0.8% vs. 7.7%). Overall, the present application beneficially contributes to the selection of methods to prepare aqueous and chloroform extracts as feed additives in an animal study while providing preliminary insights into the differences between forms and cuttings of alfalfa.

Once extraction methods were selected, alfalfa extract was supplemented in rodent diets for a 35 d mouse trial. This trial utilized 6-week-old female C57BL/6J mice because females would begin at an optimal size for C. rodentium infection (18-20 g) while the C57BL/6J strain has a well-characterized intestinal microbiota and develops a self-resolving colitis in response to the administered pathogen. The 35 d trial was divided into a 14 d feeding enrichment period followed by challenge with C. rodentium and a 21 d recovery period to assess responses to alfalfa supplementation in healthy and pathogen-challenged mice from the same sample population. During this trial, weight, feed intake, and colon crypt depth were measured in addition to assessing the immune response and changes to the colon microbiota in response to alfalfa supplementation before and after infection.

After the 14 d feeding enrichment period, systemic analysis of serum cytokines by two different methods (ELISA and flow cytometry) resulted in no observable differences between treatment groups. Analysis within immune tissues such as the spleen, however, revealed differences due to dietary treatment. Splenic intracellular cytokine staining showed that feeding aqueous and chloroform extracts created a more inflammatory environment by increasing populations of IFN-γ⁺ cells by 9.1 and 6.7% over the control, respectively. In addition to altering cytokine profiles within the spleen, flow cytometric analysis showed that all forms of alfalfa supplementation increased splenic T-cell populations, with chloroform extracts having 5.2% more T-cells than the control. Only extracts had a similar effect on B-cells with both aqueous and chloroform extracts increasing these cells by 13.8% compared to the control. These responses are similar to reports of increased lymphocyte proliferation observed in poultry models using in vitro blastogenesis assays.

Analysis of the colon digesta by 16S rRNA gene sequencing also showed changes to the intestinal microbiota by alfalfa-supplementation in healthy mice. Overall, greater changes to the microbiota were observed in mice fed diets supplemented with hay, which was expected due to the known effects of fiber on the microbiota. After the feeding enrichment period, increases in the relative abundance of OTUs associated with Muribaculaceae, a genus that is highly represented in the murine colon microbiota, were specific to fifth cutting alfalfa and attributed to lipid-soluble compounds within the plant.

Despite these changes to the immune system and intestinal microbiota, healthy mice did not display differences in BW or crypt depth in response to alfalfa supplementation, suggesting that changes to splenic immune cell profiles and the colonic microbiota were not substantial enough to negatively impact BW or colon crypt depth. Additional parameters, such as leukocyte infiltration, would have provided greater insights into baseline changes to colon histomorphology in response to alfalfa supplementation. Functional insights into physiological changes as they translated to general health in response to alfalfa supplementation were gained through C. rodentium infection.

Immediately following inoculation, mice fed fifth cutting chloroform extract recovered to their pre-inoculation BW 2 d earlier than mice fed the control. Underlying this response was the early recruitment of IFN-γ⁺ innate immune cells from the spleen to peripheral tissues observed in mice fed chloroform extracts at 4 dpi. Innate immune responses were combined with fifth cutting alfalfa maintaining elevated splenic lymphocytes at 4 dpi when control diets caused splenic lymphocyte proliferation and first cutting alfalfa resulted in early recruitment to peripheral tissues.

In addition to changes to the immune response in the early stages of infection, fifth cutting chloroform extract reduced the relative abundance of C. rodentium in the colon at 4 dpi compared to the control (1.0% vs. 0.06%). In vitro disc diffusion assays showed that alfalfa extracts did not directly inhibit C. rodentium growth, suggesting that pathogen reduction by fifth cutting chloroform extract occurred through indirect action on the microbiota or immune system; however, it is important to note that the in vitro conditions used by the disc diffusion assay were not fully representative of in vivo conditions encountered by C. rodentium in the mouse colon. While the exact mechanism of action of this effect remains unknown, both the immunological and microbiological results obtained in the first 4 dpi show that fifth cutting chloroform alfalfa extracts increased the timing of IFN-γ⁺ innate immune responses and reduced C. rodentium abundance to protect mouse BW immediately following inoculation.

When C. rodentium infection was resolving at later timepoints, mice fed control and aqueous extracts showed changes in splenic B-cell populations trending towards recovery, while those fed chloroform extracts maintained levels of this cell type below pre-inoculation percentages. Similar observations were noted for macrophage populations in the later timepoints of C. rodentium infection. While splenic B-cells and macrophages did not show recovery to pre-inoculation levels at later timepoints in mice fed chloroform extracts, these diets also increased the relative abundance of Turicibacter (14 dpi) and Akkermansia (21 dpi). In chickens, increased relative abundance of Turicibacter is associated with low RFI. while Akkermansia is regarded as anti-inflammatory and inversely correlated with inflammatory bowel disease.

At this time, mice fed chloroform extracts consumed the lowest amount of feed but had greater BW than other alfalfa-supplemented treatments, suggesting that the increased abundance of Turicibacter may contribute to low RFI in other species following health challenge; however, parameters such as RFI are not measured in mice due to differing husbandry objectives. In the last days of the infection, only mice fed chloroform extracts had average BW numerically greater than the control, which may be attributed to prolonged B-cell and macrophage responses and/or increased relative abundance of beneficial genera. Notably, mice fed fifth cutting chloroform extracts had increased relative abundance of Turicibacter and Akkermansia compared to first cutting extract, despite both increasing the abundance of both genera compared to control.

Current research into specific health benefits and compounds within the lipid-soluble compartment of alfalfa is limited, with one study examining the effects of chloroform alfalfa extract, to date. In vitro reductions in pro-inflammatory cytokine production by chloroform alfalfa extract during an LPS challenge and suggested that palmitic, linoleic, linolenic, and a number of phenolic acids may be causing the observed effects. While the presence of palmitic, linoleic, and linolenic acids corresponds to the observed fatty acid profiles of chloroform extracts, these extracts contributed to a more pro-inflammatory environment in the spleen of healthy animals. Phytoestrogens found in alfalfa share structural similarity to lipid-soluble steroid hormones, suggesting that they may be present in lipid-soluble chloroform extracts; however, their presence was identified in aqueous extract and isoflavones are regarded as being water-soluble.

Concurrent assessment of the immune system and intestinal microbiota before and after health challenge provided insights into physiological changes underlying general health parameters like BW and FI; however, the assays used to analyze these systems solely provide identification of cell types and bacterial genera present and do not provide specific functional insights. Additionally, measuring spleen immune cell profiles did not show site-specific responses C. rodentium infection, making it difficult to sufficiently ascertain the scope of the response and compare it to published literature. Despite these limitations, the results obtained by this work demonstrate that lipid-soluble compounds enriched in late-cutting alfalfa beneficially modulate the host immune system and intestinal microbiota in a way that protects and improves BW during an immune challenge. By using a well-characterized mouse model to gain these insights, future livestock applications can focus more specifically on the immunomodulatory and microbiota-altering effects of lipid-soluble compounds in late-cutting alfalfa in production animals.

### EXAMPLES

The following non-limiting examples are provided to further illustrate the present invention.

Relevant Abbreviations:

d=Day

BW=Body Weight

FI=Feed Intake

CP=Crude Protein

GE=Gross Energy

ADF=Acid Detergent Fiber

PUFA=Polyunsaturated Fatty Acid

EPA=Eicosapentanoic Acid

DHA=Docosahexanoic Acid

NF=Nuclear Factor

TLR=Toll-Like Receptor

iNOS=Inducible Nitric Oxide Synthase

NO=Nitric Oxide

IL=Interleukin

Ig=Immunoglobulin

TNF=Tumor Necrosis Factor

LPS=Lipopolysaccharide

IFN=Interferon

PBS=Phosphate-Buffered Saline

APC=Antigen-Presenting Cell

DC=Dendritic Cell

Tx=T-helper

T_{reg}=Regulatory T-cell

SPF=Specific Pathogen Free

SFB=Segmented Filamentous Bacteria

Foxp3=Forkhead box P3

SCFA=Short-Chain Fatty Acid

RT=Room Temperature

CF=Crude Fat

GC=Gas Chromatography

FAME=Fatty Acid Methanol Extract

ADFI=Average Daily Feed Intake

dpi=Day Post-Inoculation

CFU=Colony Forming Unit

LB=Lysogeny Broth

Tc=Cytotoxic T-cell

BCS=Bovine Calf Serum

OTU=Operational Taxonomic Unit

ANOSIM=Analysis of Similarities

LDA=Linear Discriminant Analysis

LEfSe=Linear Discriminant Analysis Effect Size

ZOI=Zone of Inhibition

RFI=Residual Feed Intake

### Example 1. Bioactive Alfalfa Additive Preparation

First and fifth cutting alfalfa hays harvested from the same field were obtained and nutritional analysis for each cutting was conducted. Large round and small square bales of alfalfa hay were ground by a commercial hay grinder. Netting and strings on individual bales and round bales were not able to be completely removed prior to grinding. Prior to extraction, alfalfa hays were ground further through a 1 mm screen to increase surface area available for extraction. The nutritional composition of the alfalfa is shown in Table 2 below.

TABLE 2
Composition of Alfalfa

| Component | Quantity |
|---|---|
| Moisture | 10-14 |
| Dry Matter | 84-87 |
| Crude Protein | 18-25 |
| Fat | 1-2 |
| Ash | 8-11 |
| Neutral Detergent Fiber | 28-40 |
| Acid Detergent Fiber | 20-32 |
| Lignin | 4-7 |
| Calcium | 1-2 |
| Phosphorous | 0.1-0.3 |
| Magnesium | 0.1-0.3 |
| Potassium | 2-3 |
| Chloride | 0.1-1 |
| Sulfur | 0.1-0.5 |
| Sodium | 0.01-0.1 |
| Zinc (ppm) | 25-30 |
| Copper (ppm) | 8-10 |
| Iron (ppm) | 140-220 |
| Manganese (ppm) | 45-70 |
| Nitrate-N (ppm) | 50-150 |
| Non-Fiber Carbohydrates | 30-40 |

Aqueous alfalfa extracts were then prepared in 1:3, 1:4, and 1:5 ratios of alfalfa to water. Each ratio was subjected to extraction at three different temperature conditions: room temperature (RT), supplemental heat (60° C.), or boiling. All extracts were completed in acid-washed glass beakers with continuous stirring for the duration of extraction. Beaker contents were passed through cheesecloth to collect extract. Extracts performed at RT and 60° C. were completed in 24 h with extract collection and a solvent change occurring at 12 h. Boiled extracts were completed in 2 h in accordance with previously published methods. Collected extracts were frozen at −20° C. prior to freeze-drying to obtain a solid aqueous alfalfa extract. Solid extracts were analyzed for CP and crude fat (CF).

After preparation of aqueous alfalfa extracts, chloroform extracts were also prepared for comparison. Chloroform extracts were performed in 1:4 and 1:5 alfalfa to chloroform ratios. Both ratios were performed at RT or with supplemental heat (40° C.). All extracts were performed in covered glass beakers in a fume hood with continuous stirring. Temperature was carefully monitored to prevent boiling and subsequent loss of solvent. Extractions were completed in 72 h and a solvent change every 24 h. Chloroform extract was collected by filtering through cheesecloth and leaving uncovered in a fume hood to allow solvent evaporation and produce solid chloroform alfalfa extract. Solid extract was analyzed for CP and CF.

Fatty acid profiles of all prepared extracts and alfalfa hays were measured by gas chromatography (GC). Prior to preparation of fatty acid methanol extracts (FAME), crude lipid extracts were prepared by soaking 1.5-2.0 g of aqueous extract and 5 g of ground hay in chloroform for 24 h. Chloroform extracts did not require this additional extraction step. Following solvent removal, approximately 5 mg of resulting lipid residue and chloroform alfalfa extract was placed in a glass vial for FAME preparation.

Conversion to FAME involved an acid catalyst (3% sulfuric acid in methanol) to prevent the formation of soap. A total of 3 mL of this solution was added to each glass vial before being sealed and placed in an oven at 80° C. for 8 h with occasional shaking. Extraction of FAME was finished by the addition of a 1:1 solution of hexane and water, centrifugation at 3,500 rpm for 10 minutes, and collection of the top layer of solution into a second glass vial. The collected solution was washed again with water to remove acidic impurities and the resulting top layer was collected into a 2 mL glass GC vial. Samples were analyzed using a Hewlett Packard HP 5890 Series II gas chromatograph (Agilent Technologies, Santa Clara, Calif.) with the injector and detector set at 250° C., the oven set at 160° C. for 1 minute, and the temperature set to increase by 5° C. per minute until reaching 210° C.

Differences between extraction conditions were then assessed using a student's two-tailed t-test, assuming unequal variance in JMP Pro 14 (SAS Institute, Cary, N.C.). Significance was determined at P≤0.05.

Based on an analysis of the available nutrients in alfalfa, first and fifth cutting alfalfa hays showed differences in nutrient profiles due to cutting. Notably, fifth cutting alfalfa hay contained a greater percentage of CP (24.2%) than first cutting hay (19.1%). Fiber profiles between the two varied with fifth cutting hay having 11.2, 10.1, and 1.9% less NDF, ADF, and lignin, respectively, and 9.3% more non-fiber carbohydrates compared to first cutting. In terms of mineral content, fifth cutting hay had more potassium, chloride, sulfur, and manganese, but less iron and nitrate than first cutting hay. The relative abundance of nutrients in first and fifth cutting alfalfa is shown in Table 3 below.

TABLE 3
Analysis of first and fifth cutting alfalfa hays

| | First | Fifth |
|---|---|---|
| Component | Cutting | Cutting |
| Moisture | 13.84 | 13.78 |
| Dry Matter | 86.17 | 86.22 |
| CP | 19.05 | 24.18 |
| Fat | 1.57 | 1.66 |
| Ash | 10.99 | 8.96 |
| NDF | 39.79 | 28.58 |
| ADF | 31.38 | 21.25 |
| Lignin | 6.81 | 4.92 |
| Calcium | 1.96 | 1.99 |
| Phosphorous | 0.23 | 0.27 |
| Magnesium | 0.21 | 0.20 |
| Potassium | 2.34 | 2.63 |
| Chloride | 0.37 | 0.87 |
| Sulfur | 0.15 | 0.32 |
| Sodium | 0.04 | 0.05 |
| Zinc (ppm) | 29.00 | 29.00 |
| Copper (ppm) | 8.00 | 10.00 |
| Iron (ppm) | 212.50 | 144.00 |
| Manganese (ppm) | 49.50 | 70.00 |
| Nitrate-N (ppm) | 150.00 | 52.00 |

Calculated

| | | |
|---|---|---|
| NFC | 30.56 | 39.87 |

¹Analyses conducted by AnaLab laboratories, Fulton, IL (Agri-King, Inc.)
²With the exception of moisture, all values are percentages on a dry matter basis unless otherwise noted
³Abbreviations: CP = crude protein; NDF = neutral detergent fiber; ADF = acid detergent fiber; NFC = non-fiber carbohydrates

Aqueous Extract Method Improvement

Preliminary extracts were done with fifth cutting hay to determine which of the several extraction conditions should be examined in greater detail. At the outset of preparing preliminary extracts, the 1:3 alfalfa to water ratio was excluded from further examination due to the added water being completely absorbed by the dry hay.

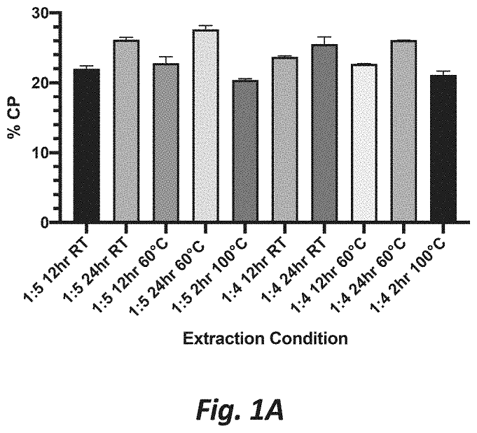

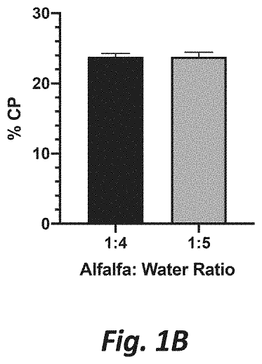

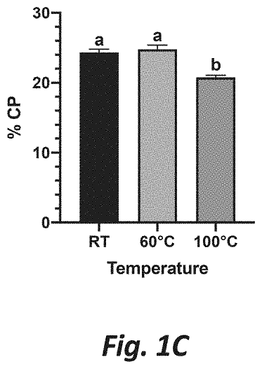

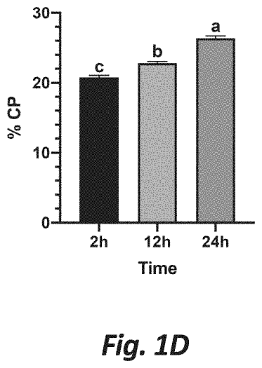

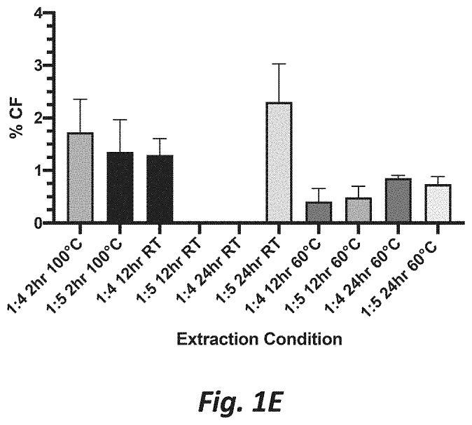

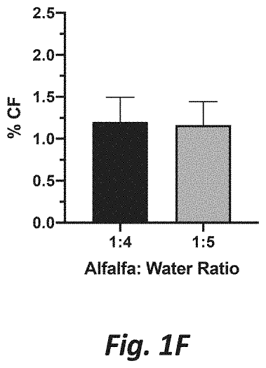

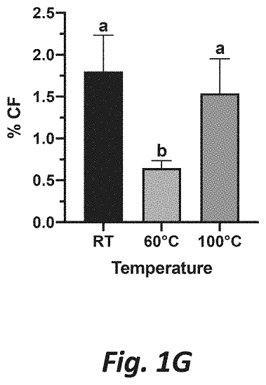

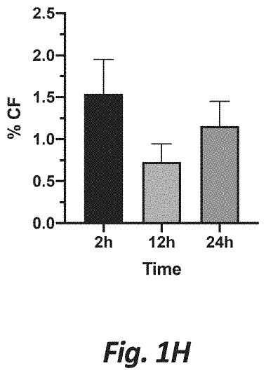

Performing the preliminary extracts at RT and 60° C. resulted in 3.6 and 4.0% more CP in the final product, respectively, than extracts performed at 100° C. (P=0.0002; P<0.0001). A time-dependent response on the percent CP in aqueous alfalfa extract was observed with extracts performed for 24 h having 5.6 and 3.6% more CP than extracts performed at 2 and 12 h, respectively (P<0.0001). Aqueous extracts performed for 12 h contained 2.0% more CP than those performed for 2 h (P=0.0003). The ratio of alfalfa to water did not impact the amount of CP present in aqueous alfalfa extracts. Room temperature and boiled extracts contained 1.2 and 1.0% more CF, respectively, than extracts performed at 60° C. (P=0.03). Extraction ratio and time did not affect the percent CF in preliminary aqueous extracts. These results are shown in FIGS. 1A-1H.

Crude fat was not a major factor in selecting methods for preparing aqueous alfalfa extracts. In the preliminary extracts, low extract yields reduced the amount of sample available for CF analysis. Due to the hydrophobic quality of lipids, the low percentage of CF in aqueous extracts was expected and can be attributed to the extraction of a small amount of polar lipids (i.e., phospholipids) by water. A combination of low CF in the aqueous extracts and small amounts available for analysis resulted in high errors for CF analysis, as shown in FIGS. 1A-1H.

Based on these results, methods involving boiling for 2 h and extracts completed for 12 h were excluded from further trials due to the low amounts of extracted CP. While the ratio of alfalfa:water did not impact the percentage of CP in aqueous alfalfa extract, the 1:5 ratio was selected because the volume of water used reduced the amount of alfalfa floating to the top of the beaker and drying out. This translated to a greater volume of liquid extract being obtained prior to freeze drying. Additional extraction trials were then completed with a 1:5 ratio at RT or 60° C. for both the first and fifth cutting alfalfa hays.

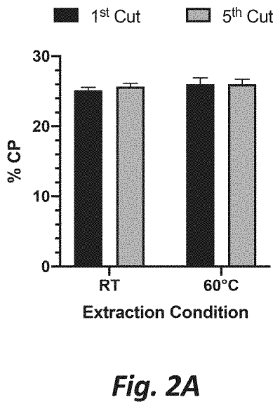

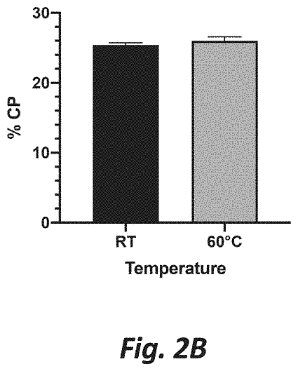

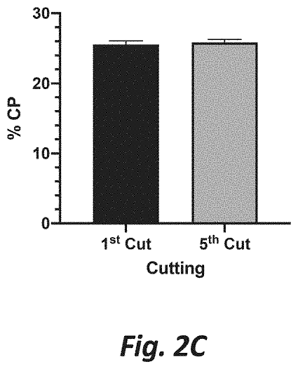

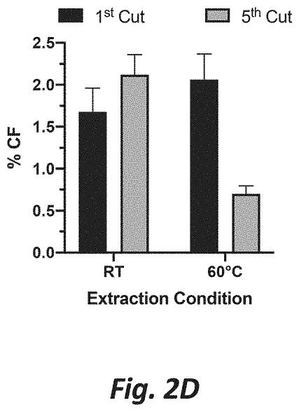

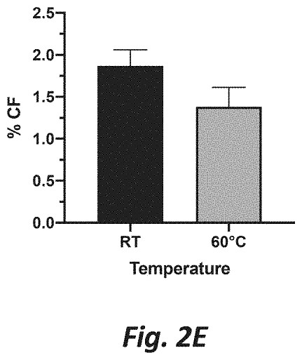

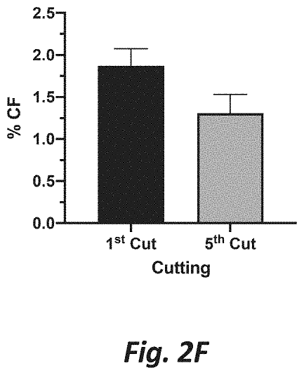

In the final preparation of aqueous extracts, temperature and cutting did not affect percentages of CP and CF in the final product. These results are shown in FIGS. 2A-2F. Since temperature did not impact the amount of CP extracted from alfalfa, the decision for a final extraction method was made based on criteria not related to extract composition. Extractions done at a 1:5 alfalfa:water ratio for 24 h at RT were selected based on optimal CP in the final product and protection of heat-labile compounds.

Chloroform Extract Method Improvement

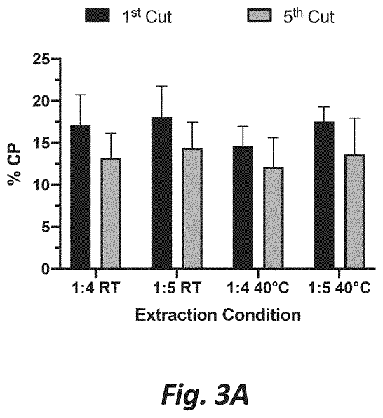

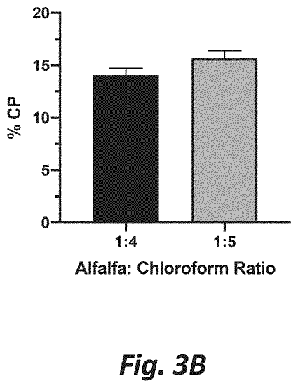

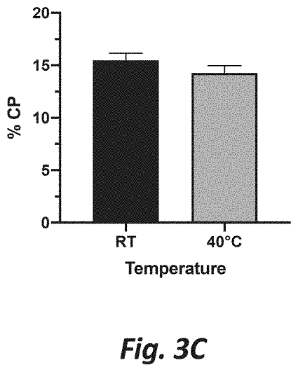

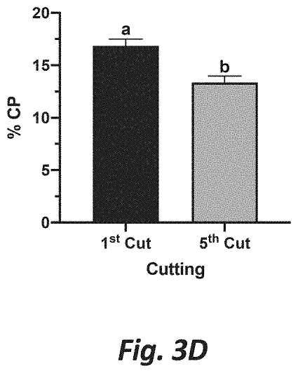

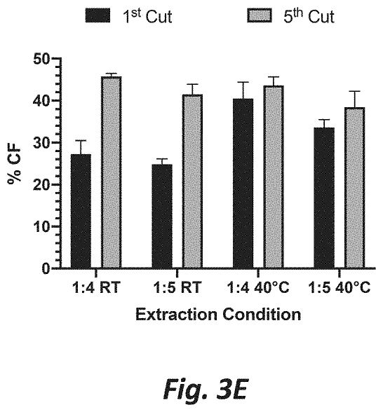

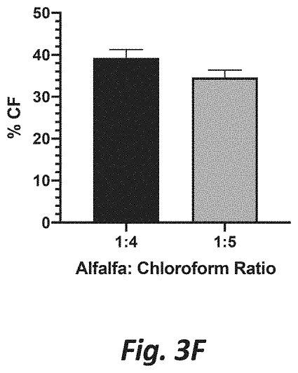

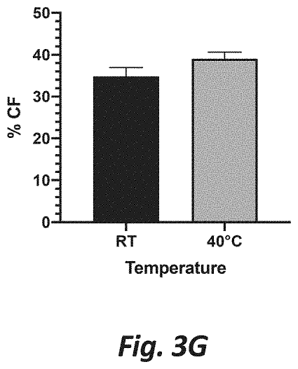

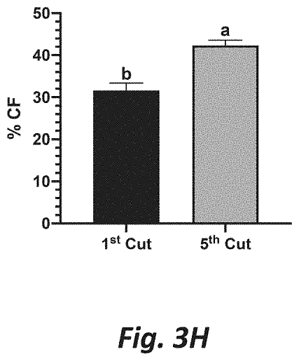

Preliminary extracts to eliminate methods were not performed for the preparation of chloroform alfalfa extracts due to the small number of variables being tested as well as to reduce exposure to harmful solvents. The extraction conditions of temperature and ratio did not have an effect on the composition of chloroform extracts. These results are shown in FIGS. 3A-3H.

Due to the nature of the compounds expected to be present in chloroform alfalfa extracts, CF was one of the major factors for method selection. While not statistically significant, a 1:4 alfalfa: chloroform ratio resulted 4.7% more CF in the final product than 1:4 ratio extracts. Providing supplemental heat (40° C.) resulted in 4.2% more CF in chloroform extracts than RT extracts. To maximize the percentage of CF in the final product, the method chosen for future applications was the 1:4 ratio with 40° C. of supplemental heat.

Chloroform extracts of first cutting hay had 3.5% more CP than fifth cutting extracts (P=0.0002). Chloroform extracts of fifth cutting alfalfa hay contained 10.8% more CF than extracts of first cutting hay (P<0.0001; see FIGS. 3A-3H). This is noteworthy since fifth cutting hay has a higher CP content than first cutting and both hays had similar percent CF. While important to note for future applications, the compositional differences observed between chloroform extracts from first and fifth cutting alfalfa hay were not used to select a method for chloroform extraction.

Fatty Acid Profiles of Hay and Alfalfa Extracts

Fatty acid analysis of the two hays showed differences in fatty acid profiles despite having similar percentages of CF (Table 2.1). Fifth cutting alfalfa hay had 22.3% more palmitic acid (16:0) and 17.5% more arachidic acid (20:0) than first cutting hay.

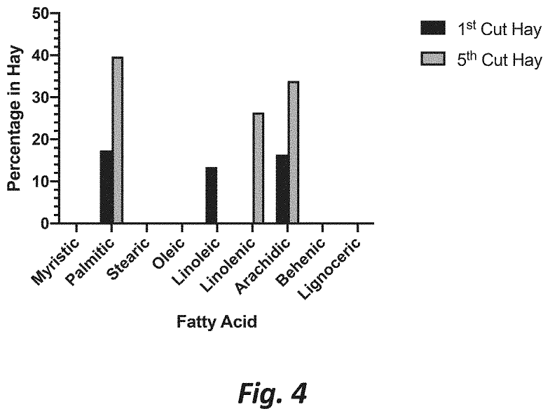

Linoleic acid, an n-6 PUFA, was present in first cutting hay whereas linolenic acid, an n-3 PUFA, was present in fifth cutting hay. The fatty acid profile of the alfalfa analyzed by gas chromatography is shown in FIG. 4. The differences between these two FA are of interest as n-6 PUFAs are generally regarded as pro-inflammatory, whereas n-3 PUFAs are considered anti-inflammatory.

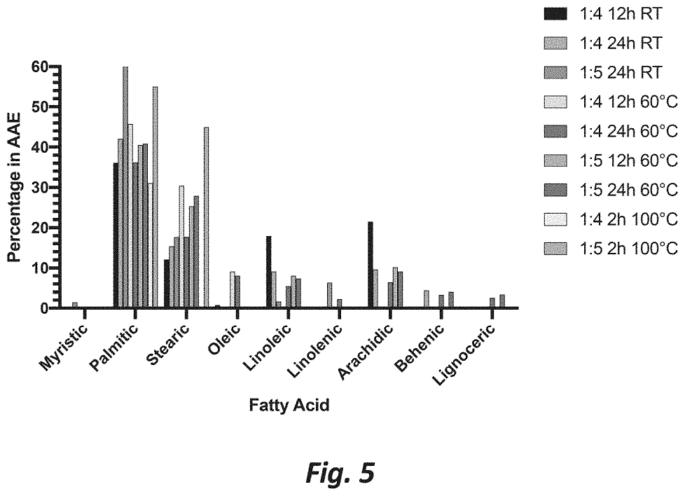

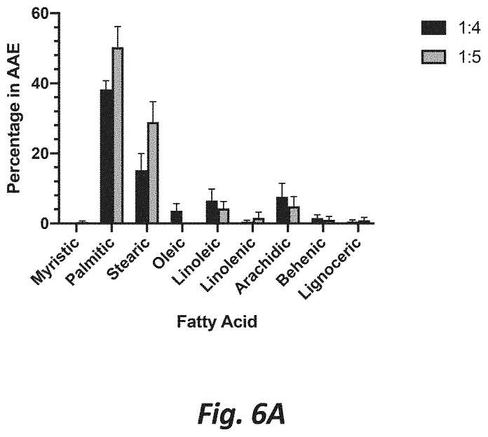

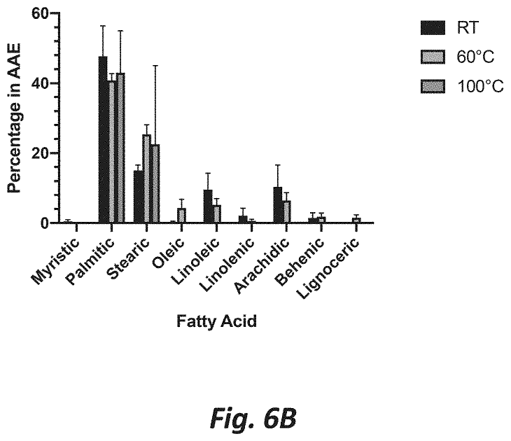

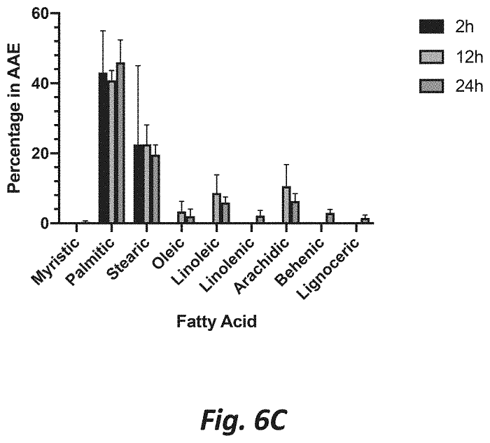

A majority of the preliminary aqueous extracts' FA profile was comprised of palmitic and stearic (18:0) acids. The fatty acid profile of the aqueous extracts is shown in FIG. 5. When grouped by extraction conditions, 1:5 alfalfa to water extract ratio had numerically more palmitic and stearic acid and lower percentages of linoleic acid compared to extractions done at the 1:4 ratio. Room temperature extracts had numerically greater percentages of palmitic, linoleic and arachidic acid than other temperature conditions, but less stearic acid. Allowing extractions to continue for 24 h resulted in more extracted palmitic acid and less extracted stearic, linoleic, and arachidic acid. The fatty acid profiles for the aqueous extracts in terms of water ratio, extraction temperature, and time analyzed are shown in FIGS. 6A-6C. While these FA profiles provide insight into the composition of the obtained extracts, it is important to note that the overall percent CF in aqueous extract is very low (<2%) and these FA may not be present in biologically relevant amounts when aqueous alfalfa extract is supplemented in animal diets.

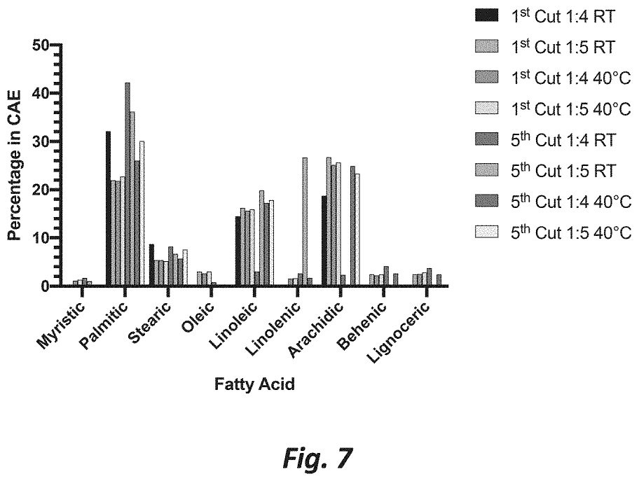

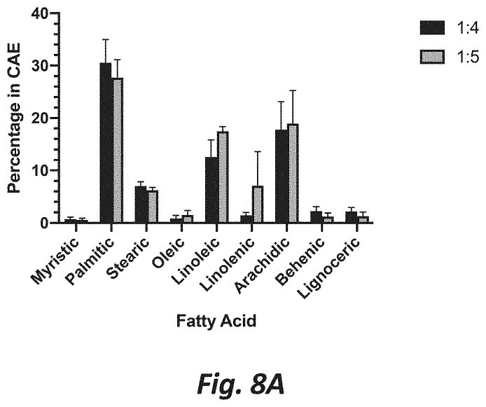

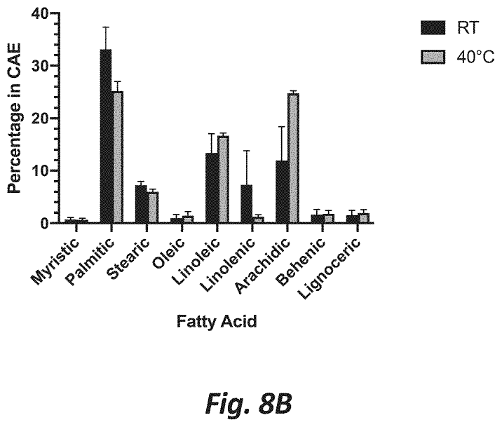

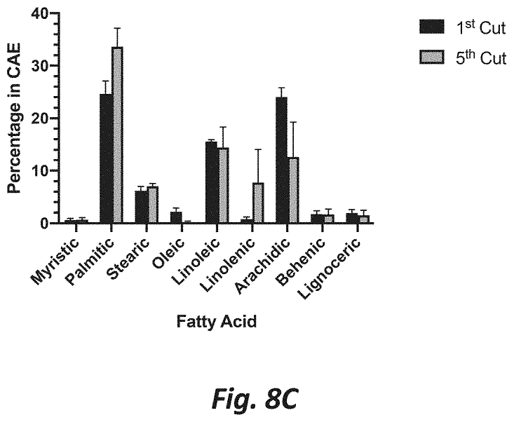

In chloroform extracts, the predominant FA are palmitic, linoleic, and arachidic acid. There is a notably higher percentage of linolenic acid present in the extract of fifth cutting alfalfa done at a 1:5 alfalfa: chloroform ratio at RT (26.7%) compared to all other extracts. This is shown in FIG. 7. Extracts performed at the two alfalfa: chloroform ratios had similar percentages of arachidic acid, but 1:4 ratios had a numerically higher percentage of palmitic acid and a lower percentage of linoleic and linolenic acid. In general, heated extracts contained greater percentages of all FA measured with the exception of palmitic and linolenic acid. Chloroform extracts of fifth cutting hay had a higher percentage of linolenic acid with a similar percentage of linoleic acid compared to chloroform extracts from first cutting hay, as is shown in FIGS. 8A-8C. Interestingly, the GC output for some chloroform extracts showed peaks that correlated with petroleum contamination. Only glass and metal equipment were used during the preparation of chloroform extracts and the presence of petroleum contamination was attributed to the presence of plastic baling twine fragments that remained after the hay was ground.

Fatty acids that were not present in the alfalfa hay were detected in both aqueous and chloroform extracts. For the analysis of FA, alfalfa hays were soaked in chloroform for 24 h to obtain a crude lipid extract prior to FAME preparation. Conversely, chloroform extracts were prepared by soaking alfalfa hay in chloroform for a total of 72 h, which may have allowed for a more exhaustive extraction of FA from the plant material. Similarly, aqueous extracts were prepared by soaking alfalfa hay in water for 24 h prior to the additional 24 h extraction in chloroform to obtain lipid for GC analysis and may have also provided a more extensive extraction of FA.

Overall, the present application provides improved methods for preparing alfalfa extracts for use as a feed supplement. The extraction conditions used are representative of what can be obtained using maceration. Conditions were selected based on the ability to use simple laboratory equipment and potential translation to large-scale production.

### Example 2. Bioactive Alfalfa Additive Used to Improve Animal Health and Protect Against Disease

In a second evaluation, a total of 163 female C57BL/6J mice (Jackson Laboratories, Bar Harbor, Me.) at 6 weeks of age were housed in 45 Innovive cages (2-4 mice/cage; Innovive Inc., San Diego, Calif.). Animals within each cage were identified by ear punch. Mice were given a 7 d period of time to allow the intestinal microbiota to stabilize following transport and diet change to the Teklad Global 18% Protein Rodent Diet (Envigo Teklad, Madison, Wis.). Following the adaptation period (d0), 9 mice were euthanized for baseline blood and tissue sampling. The remaining mice—a total of 154 females—were assigned to 1 of 7 dietary treatments (22 mice/treatment) consisting of the Teklad Global 18% Protein Rodent Diet without alfalfa (control) or supplemented with 9% hay, 0.25% aqueous extract, or 0.25% chloroform extract of first or fifth cutting alfalfa. These diets are shown in Table 4 below. Mice had ad libitum access to food and water. All diets were formulated and prepared in a pelleted form by Envigo Teklad (Madison, Wis.) to be isocaloric and isonitrogenous.

TABLE 4
Nutrient composition of experimental diets fed to female C57BL/6J
mice for the 14 d enrichment period and 21 d infection period

| | Reference | Protein | Carbohydrate | Fat | | % kcal from | % kcal from | % kcal from |
|---|---|---|---|---|---|---|---|---|
| Diet | Number¹ | (%) | (%) | (%) | Kcal/g | Protein | Carbohydrate | Fat |
| Control | TD.00588 | 18.2 | 48.0 | 5.8 | 3.2 | 22.9 | 60.5 | 16.6 |
| ^{1st} Cutting Hay | TD.170994 | 18.2 | 46.4 | 5.5 | 3.1 | 23.7 | 60.3 | 16.0 |
| 5^{th} Cutting Hay | TD.170995 | 18.7 | 47.3 | 5.5 | 3.1 | 23.9 | 60.4 | 15.7 |
| 1^{st} Cutting | TD.170997 | 18.1 | 47.9 | 5.8 | 3.2 | 22.9 | 60.5 | 16.6 |
| Aqueous Extract | | | | | | | | |
| 5^{th} Cutting | TD.170997 | 18.1 | 47.9 | 5.8 | 3.2 | 22.9 | 60.5 | 16.6 |
| Aqueous Extract | | | | | | | | |
| 1^{st} Cutting | TD.170098 | 18.1 | 47.9 | 5.8 | 3.2 | 22.9 | 60.5 | 16.6 |
| Chloroform | | | | | | | | |
| Extract | | | | | | | | |
| 5^{th} Cutting | TD.170999 | 18.1 | 47.9 | 5.8 | 3.2 | 22.9 | 60.5 | 16.6 |
| Chloroform | | | | | | | | |
| Extract | | | | | | | | |

¹All diets were formulated and prepared in a pelleted form by Envigo Teklad (Madison, WI)

After a 14 d feed adaptation period, 6 mice/treatment were euthanized for tissue sampling and the remaining mice were inoculated with 2×10¹⁰ colony forming units (CFU) of Citrobacter rodentium by oral gavage. Inoculum was prepared according to methods published by Crepin V F, Collins J W, Habibzay M, Frankel G. Citrobacter rodentium mouse model of bacterial infection, NAT. PROTOC. 11:1851 (2016), which is herein incorporated by reference in its entirety. Briefly, Citrobacter rodentium strain DBS100 (ATCC 51459; Manassas, Va.) was cultured in 15 ml lysogeny broth (LB) overnight at 37° C. in a shaking incubator set to 200 rpm. Cultures were centrifuged and the bacterial pellet was resuspended in 1.5 ml PBS and 200 μl was administered to each mouse. Each 15 ml starting culture provided sufficient inoculum to infect 6 mice and the number of cultures was scaled accordingly to produce enough for 112 animals. Remaining inoculum was serially diluted and plated on LB agar to enumerate the administered CFUs.

Following inoculation, a total of 4 mice/treatment were euthanized for tissue sampling on 4, 8, 14, and 21 dpi in accordance with timelines used by Crepin et al. The trial concluded at 21 dpi when the last subset of mice was euthanized.

Body Weight and Feed Intake Monitoring Mouse BW was measured on arrival, d0, d14, and daily following inoculation with C. rodentium. Feed intake on a cage basis was determined by subtracting leftover feed from the feeder and cage bottom from the amount of added feed. The total amount of FI from d0-d14, 0-4 dpi, 4-8 dpi, 8-14 dpi, and 14-21 dpi was calculated and presented as the ADFI per mouse.

Histomorphology

Large intestines from 4 mice on d0 and 2 mice/treatment on d14, 4, 8, 14, and 21 dpi were fixed in 10% neutral buffered formalin for 24 hr at room temperature before being transferred to 70% ethanol. Fixed tissues were embedded in paraffin and mounted on a microscope slide before being hematoxylin and eosin stained. Slide images were obtained using a DP80 Olympus Camera mounted on an Olympus BX 54/43 microscope. Crypt depth measurements were taken from the base of the crypt to the lumen of the large intestine using the Olympus Cell Sens Dimension 1.16 software (Olympus Corporation, Shinjuku, Tokyo, Japan). A total of 35 measurements were taken along the length of the large intestine to calculate the average crypt depth of each mouse.

Statistics

Data were analyzed using the following statistical model:

y₍ᵢ₎ⱼₖₗ=μ+Conᵢ+Cut₍ᵢ₎ⱼ+F₍ᵢ₎ₖ+(Cut×F)₍ᵢ₎ⱼₖ+d0BW₍ᵢ₎ⱼₖₗ+e₍ᵢ₎ⱼₖₗ

Where y is the dependent variable (BW, ADFI, or crypt depth), μ is the overall mean, Conᵢ is the effect of the control at the i^{th} level (i=2), Cut₍ᵢ₎ⱼ is the fixed effect of the j^{th} level of alfalfa cutting nested within the control (first or fifth; j=2), F₍ᵢ₎ₖ is the fixed effect of the k^{th} level of form nested within the control (hay, aqueous extract, or chloroform extract; k=3), (Cut×F)₍ᵢ₎ⱼₖ is the fixed effect of the interaction between cutting at the j^{th} level and form at the k^{th} level nested within the control, d0BW₍ᵢ₎ⱼₖₗ is the covariate of d0 BW associated with each observation, and e₍ᵢ₎ⱼₖₗ is the random error. This model was used due to the 2×3+1 factorial treatment design with the control, 2 forms of alfalfa, and 3 supplementation forms. Data were analyzed using the MIXED procedure of SAS 9.4 (SAS Institute, Cary, N.C.) with results considered significant at P≤0.05.

BW and ADFI

The evaluation in the instant case comprised a 35 d animal trial divided into a 14 d feeding enrichment period to assess baseline responses to alfalfa supplementation followed by a 21 d challenge period to determine responses during infection with a rodent-specific pathogen. No differences were found in BW during the enrichment period or ADFI during the enrichment or challenge periods (FIGS. 1 and 2), with the exception of significant reductions in ADFI for mice fed aqueous extract vs hay from 0-4 dpi and 4-8 dpi (FIG. 3.2A). In the first 4 dpi, mice fed diets with hay ate 0.5 g±0.1 g (18.1%) more than mice fed diets with aqueous extract, regardless of cutting (P=0.005; FIG. 3.2A). From 4-8 dpi, mice fed hay ate 0.5±0.2 g (17.2%) more than mice fed aqueous extracts (P=0.04). Mouse BW and ADFI were expected to drop in the early timepoints following inoculation (0-4 dpi and 4-8 dpi) with recovery occurring as C. rodentium was cleared during later timepoints (8-14 dpi and 14-21 dpi).

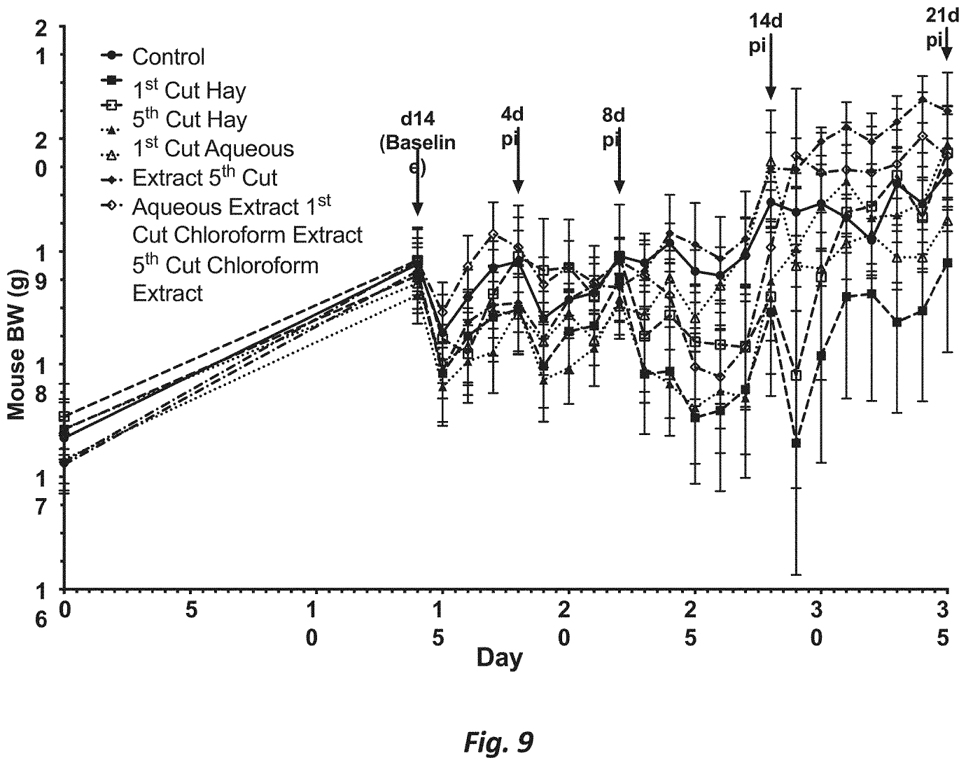

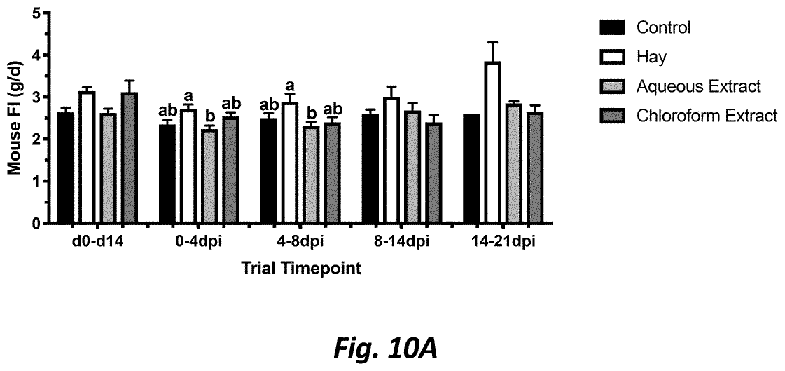

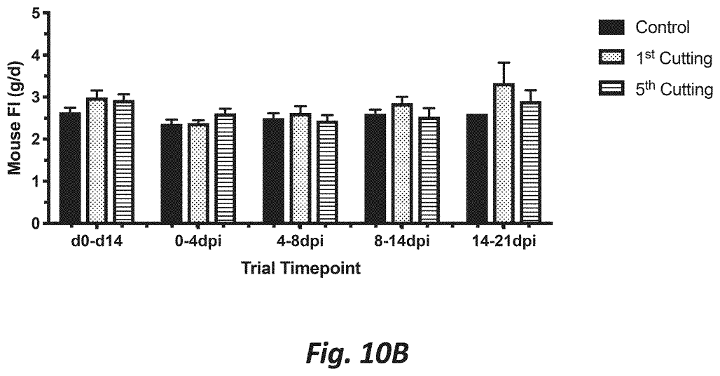

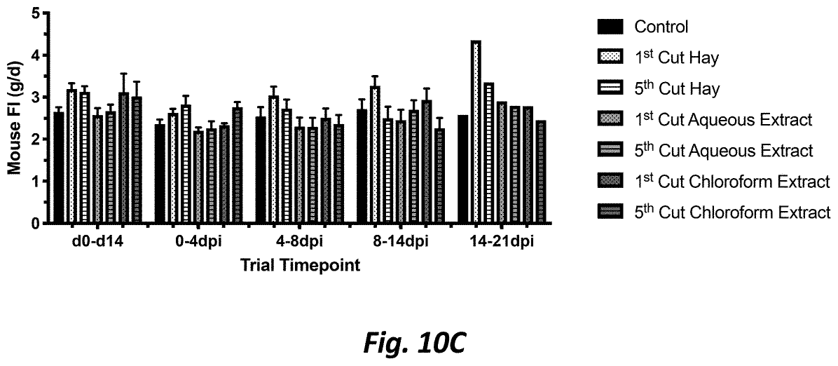

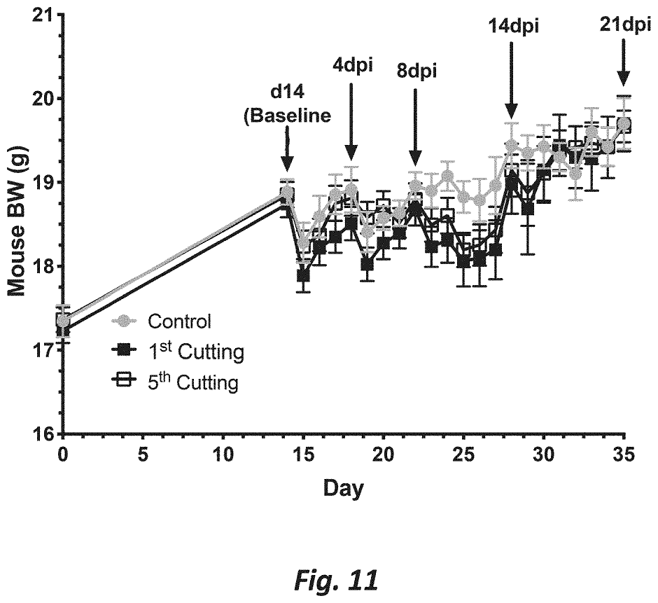

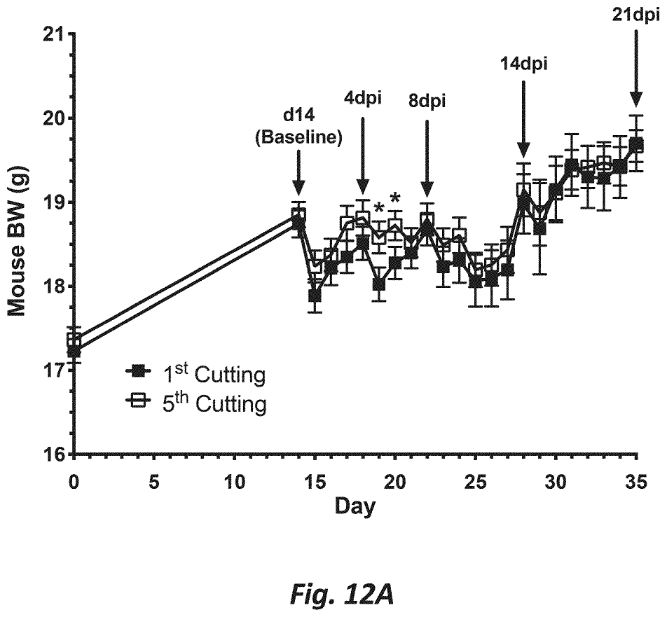

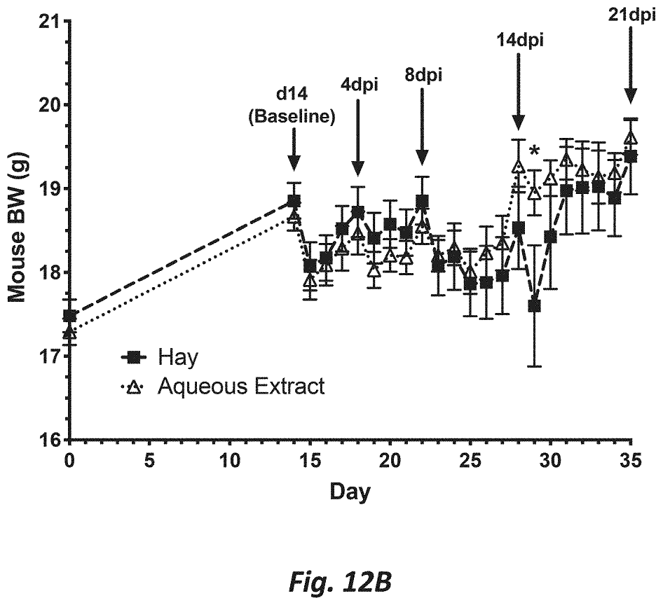

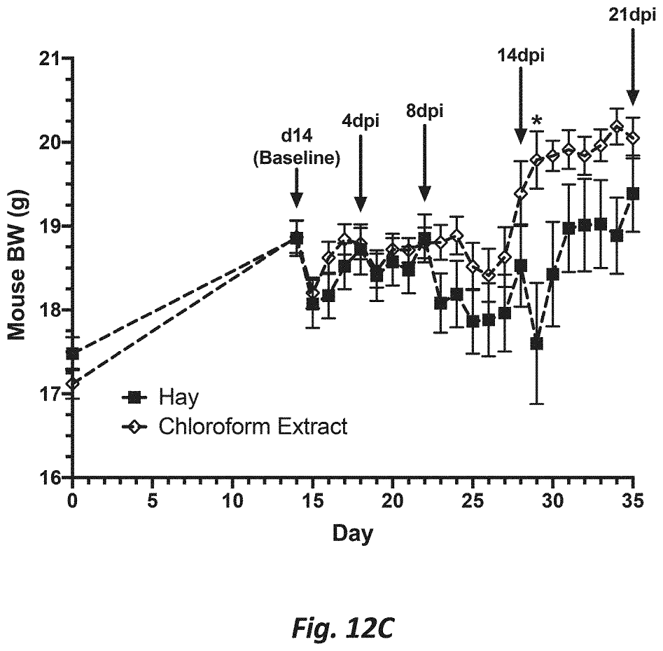

Post-inoculation, none of the alfalfa-supplemented treatments resulted in ADFI that was significantly different from the control diet, as shown in FIG. 9; however, varying significant responses and trends were found in BW, as shown in FIGS. 10A-10C, FIG. 11, and FIGS. 12A-12C. From 8-14 dpi and 14-21 dpi, the general trend was that mice fed diets with hay had numerically greater ADFI than other treatments with the greatest ADFI observed in mice fed first cutting alfalfa hay (see FIGS. 10A and 10C). Feeding fifth cutting alfalfa positively impacted BW between 4-8 dpi, regardless of supplementation form (see FIG. 11), while main effects of both aqueous and chloroform extracts positively impacted BW between 14-21 dpi (see FIGS. 12A and 12C). BW was increased in fifth cutting-supplemented mice by 0.5g±0.2 g (2.6%) and 0.4g±0.2 g (2.0%) compared to mice fed first cutting alfalfa at 5 and 6 dpi, regardless of form (P=0.002 and 0.01) (see FIG. 12A). At 15 dpi, mice fed aqueous and chloroform extracts weighed 1.4g±0.7 g (7.1%) and 1.9g±0.7 g (9.5%) more than mice fed hay, respectively, regardless of cutting (P=0.03) (see FIG. 12B). These results suggest that late-cutting alfalfa protects BW immediately after inoculation but form of supplementation has a greater impact during later timepoints.

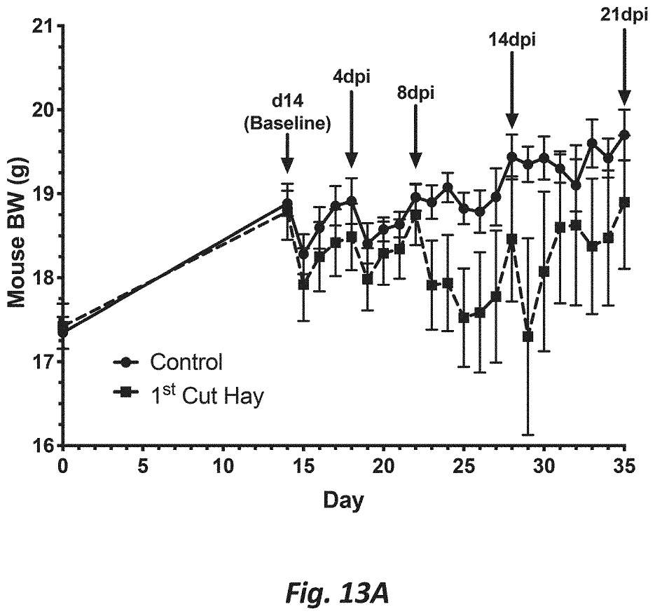

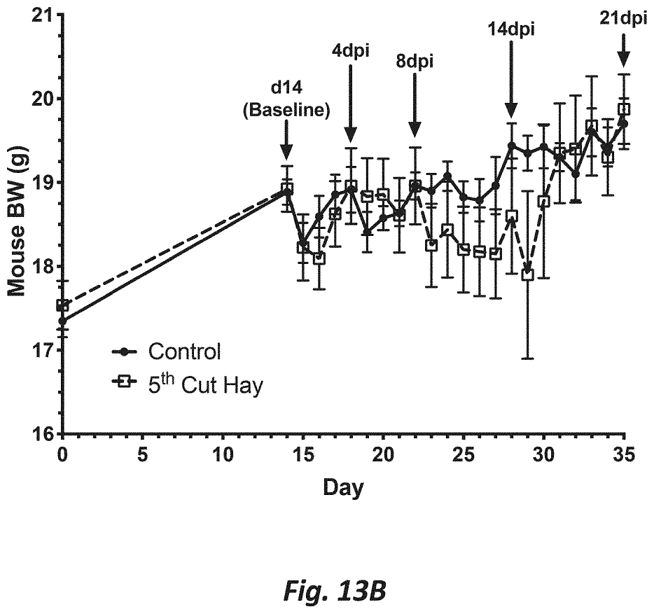

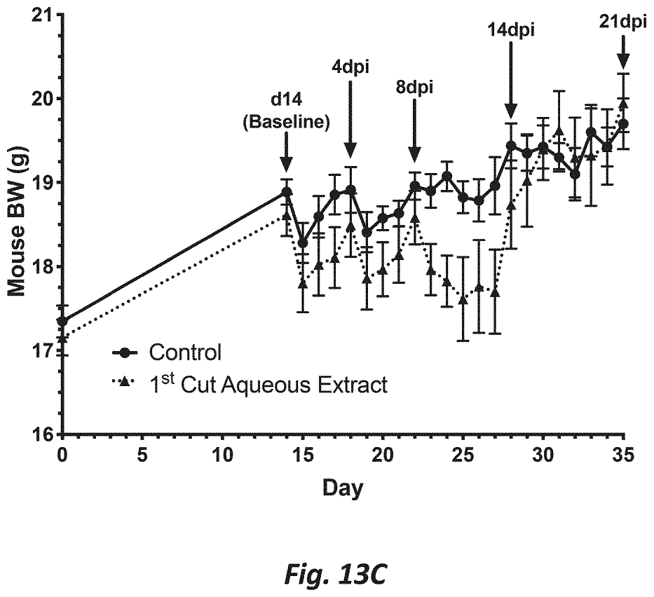

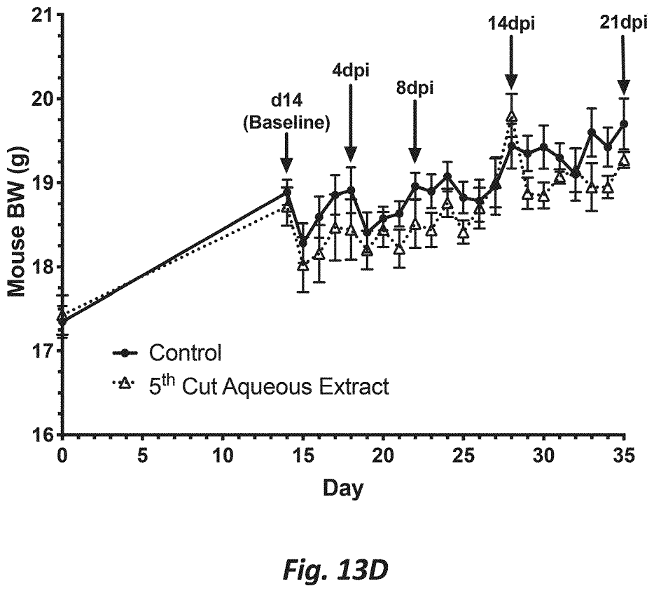

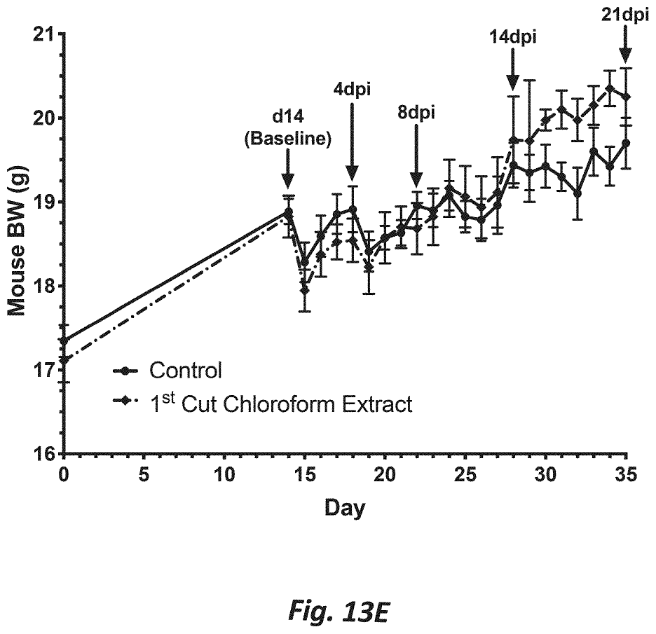

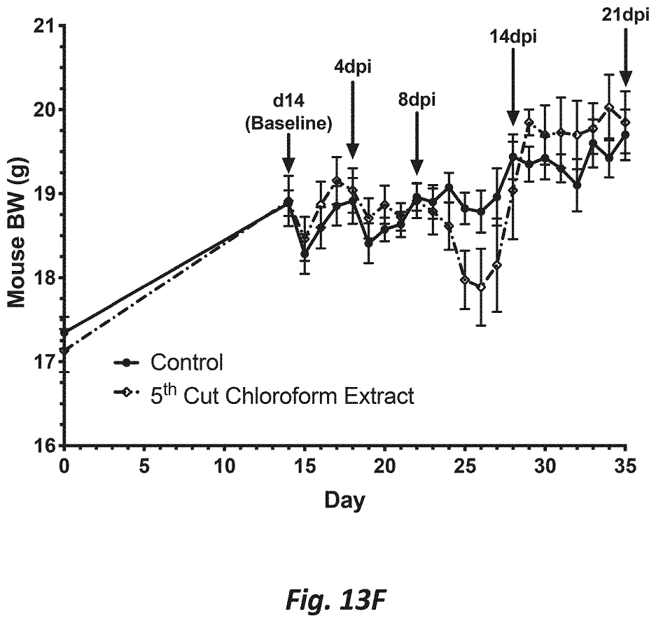

Mice fed control diets recovered to pre-inoculation BW (18.9 g) at 4 dpi but experienced additional losses in BW before fully recovering to pre-inoculation BW at 13 dpi followed by an increase to a final BW of 19.7 g (4.1% increase over pre-inoculation), as shown in FIGS. 13A-13F. Mice fed fifth cutting chloroform extract displayed an expedited recovery to pre-inoculation BW at 2 dpi, followed by a BW that stayed higher than the control until 9 dpi (see FIG. 13F). From 10 to 13 dpi, the BW of mice fed fifth cutting chloroform extracts dropped to 1 g (5.3%) below the pre-inoculation BW before making a final recovery at 14 dpi and increasing to a final BW 0.2 g (1.0%) above the control. While mice fed chloroform extracts of first cutting alfalfa did not recover to their pre-inoculation BW until 9 dpi, they did not experience any BW loss following recovery and increased to a final BW that was 0.6 g (2.7%) greater than control. Notably, only mice fed the chloroform extracts had final BW that were greater than the control (see FIGS. 13E and 13F). Examining these results over the course of inoculation indicates that chloroform extracts have protective effects on BW immediately after inoculation and increases BW over control in late stages post-inoculation, but fifth cutting alfalfa exhibits a protective role from 4-8 dpi compared to first cutting.

During the enrichment period, there were no differences in ADFI and BW; however, post-inoculation response varied based on diet. Without wishing to be bound by theory, increasing dietary fiber content may alter dietary energy availability and this could result in compensation by the mouse to increase intake in an attempt to fulfill energy requirements. Alfalfa hay contains a high percentage of insoluble fiber which is estimated by NDF (34.3 and 24.6% as-fed in first and fifth cutting, respectively). These differences despite both diets being isocaloric was attributed to greater fecal energy loss in mice fed high-insoluble fiber diets, which is suggestive of decreased energy digestibility. At a baseline health state, this inclusion rate did not show negative impacts on mouse BW or ADFI but did not provide sufficient energy to maintain BW during a health challenge.

Improvements in BW during C. rodentium infection observed in mice fed fifth cutting as well as chloroform extracts suggest that enriched phytochemicals may have a protective effect on mouse BW during health challenge.

Colon Histomorphology

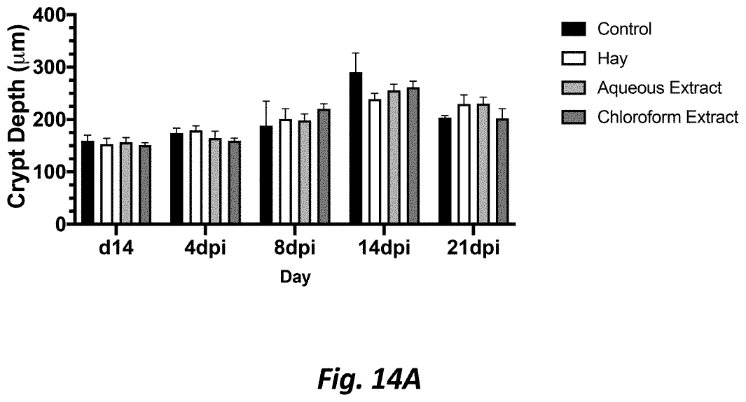

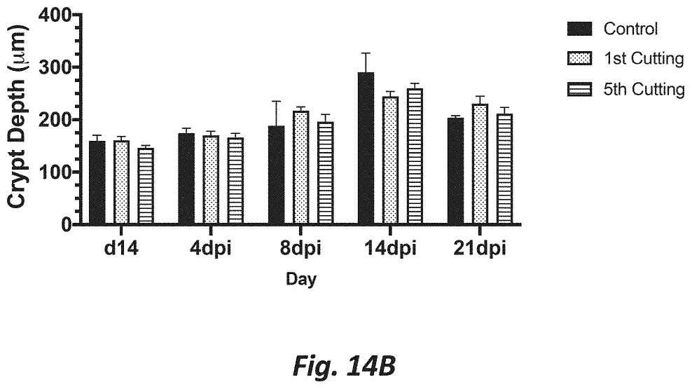

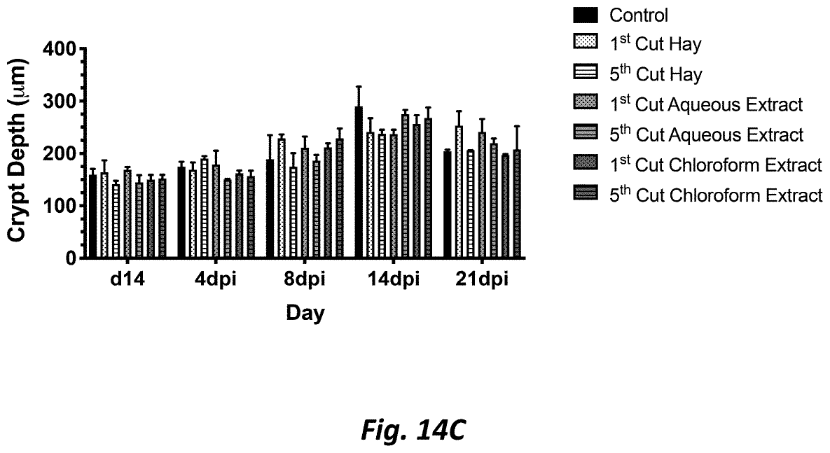

Citrobacter rodentium infection is characterized by crypt hyperplasia that can be measured as increased colonic crypt depth. No differences in crypt depth due to diet were found during the enrichment or challenge periods, as shown in FIGS. 14A-14C); however, non-significant trends due to diet were noted. Despite this, mice fed the control diets experienced the largest peak in crypt depth compared to peak crypt depth reached by all other treatments post-inoculation, indicating that alfalfa supplementation had a protective effect on colon morphology.

At 4 dpi, mice fed chloroform extracts from both first and fifth cutting alfalfa had the shortest crypt depths, which further indicates a trend of potential protective impact of chloroform extracts immediately following inoculation (see FIG. 14A). Mice fed chloroform extracts had the longest crypt depths at 8 dpi, but those fed fifth cutting alfalfa had shorter crypt depths than first cutting (see FIGS. 14A and 14B). This observation is similar to the protective effects of fifth cutting alfalfa on BW seen at the same timepoint post-inoculation, regardless of supplementation form. Notably, mice fed hay and aqueous extracts from first cutting alfalfa did not display a reduction in crypt depth from 14-21 dpi, while all other treatments showed reductions in crypt depth between these timepoints (see FIG. 14C).

The overall findings from this evaluation indicate that supplementation form and cutting of alfalfa supplementation have an impact on general measures of animal health. It is important to note that mice fed hay diets consistently ate more but weighed less during later post-inoculation timepoints while mice fed chloroform extracts ate similar amounts to the control at later timepoints and had improved BW vs. control. These results indicate that compounds enriched in the later cuttings as well as chloroform extract of alfalfa may improve recovery during health challenge.

### Example 3. Bioactive Alfalfa Additive Used to Impact Murine Immune Response Before and After Infection

A further evaluation was conducted to assess the extent to which bioactive additives derived from alfalfa may be used to impact immune response in the presence of an infection. Briefly, hay was ground through a 2 mm screen in a Wiley mill (Arthur H. Thomas Company, Philadelphia, Pa.) and incorporated in the diet at a 9% inclusion level (TD.170994, TD.170995). Aqueous extracts were prepared in a 1:5 ratio of alfalfa:deionized water at room temperature (22° C.) for 24 h. Solid aqueous alfalfa extract was obtained by lyophilizing the collected filtrate. Chloroform extracts were prepared in a 1:4 ratio of alfalfa: chloroform with supplemental heat (40° C.) for 72 h. Chloroform alfalfa extracts were evaporated to dryness to obtain a solid product for inclusion in rodent diets. Both aqueous (TD.170996; TD.170997) and chloroform extracts (TD.170998; TD.170999) from first and fifth cutting alfalfa were incorporated in their respective diets at 0.25%. All dietary treatments used in this study were formulated to be isocaloric and isonitrogenous and prepared in a pelleted form by Envigo Teklad (Madison, Wis.).

One hundred and sixty-three female 6 week old C57BL/6J mice from Jackson Laboratories (Bar Harbor, Me.) were housed in 45 Innovive cages (Innovive Inc., San Diego, Calif.) with 2-4 mice per cage. Mice within a cage were identified by ear punch and given ad libitum access to water and feed. Upon arrival, mice were given a 7 d environmental acclimation period to allow stabilization following transport and diet change. During this time, mice were fed the pelleted Teklad global 18% protein rodent diet (TD.00588), which was used as the basal diet for all treatments. Following the 7 d acclimation period (d0), 9 mice were anesthetized with isoflurane gas and blood was collected by brachial artery puncture before euthanasia by cervical dislocation. The spleen, large intestine, and cecum were collected for baseline immunological analysis. Remaining mice were randomly assigned to 1 of the 7 previously-described dietary treatments (22 mice/treatment).

After 14 days of feed enrichment, 6 mice/treatment were anesthetized for blood collection and euthanized for tissue sampling as previously described. The remaining mice (16/treatment) were administered 2×10¹⁰ CFUs of Citrobacter rodentium by oral gavage. Citrobacter rodentium inoculum was prepared according to the methods described by Crepin V F, Collins J W, Habibzay M, Frankel G. Citrobacter rodentium mouse model of bacterial infection, NAT. PROTOC. 11:1851-76 (2011), which is herein incorporated by reference in its entirety.

Briefly, 15 ml of LB broth were inoculated with Citrobacter rodentium strain DBS100 (ATCC 51459; Manassas, Va.) and grown overnight in a 37° C. incubator with shaking at 200 rpm. The cultures were then centrifuged and re-suspended in 1.5 ml of sterile PBS. Each 1.5 ml culture was sufficient to infect 6 mice and the protocol was scaled to make enough inoculum for the remaining 112 mice. Following the administration of 200 μl of inoculum to each mouse, the remaining culture was serially diluted and plated to enumerate the number of CFUs administered. Following inoculation, 4 Mice/treatment were euthanized for blood and tissue sampling at 4, 8, 14, and 21 dpi. The experiment concluded when the last group of mice was euthanized at 21 dpi.

Serum Cytokine Analysis

Blood was collected into amber serum separator tubes (BD, Franklin Lakes, N.J.) and allowed to clot at room temperature for an hour before being centrifuged at 2,000 rpm for 10 minutes. Collected serum was stored in two aliquots at −80° C. until analysis. Cytokine analysis was performed using the LEGENDplex™ Mouse Inflammation Panel for IL-1α, IL-1β, IL-6, IL-10, IL-12p70, IL-17A, IL-23, IL-27, MCP-1, IFN-β, IFN-γ, TNF-α, and GM-CSF (Cat. No. 740446, BioLegend, San Diego, Calif.) according to the manufacturer's instructions. Flow cytometric analysis of cytokine-conjugated beads was performed using a BDFACSCanto® Cytometer™ (BD Biosciences, San Jose, Calif.). BioLegend ELISA MAX™ kits for IL-6 (Cat. No. 431304) and IL-1β (Cat. No. 432604) were done using the remaining serum to confirm the results obtained by the LEGENDplex™ Mouse Inflammation Panel (BioLegend, San Diego, Calif.). Serum samples for ELISA analysis were diluted 1:1 and allowed to incubate on coated and blocked plates for 12 hours. All other steps were performed according to the manufacturer's instructions.

Flow Cytometry

Mouse spleens were gently homogenized in PBS and passed through a sterile 70□m strainer. Red blood cells were lysed using ACK lysing buffer (Gibco, Fisher Scientific, Hampton, N.H.) and cells were washed twice in PBS. Obtained cells were enumerated using a hemocytometer and frozen in heat-inactivated bovine calf serum (BCS) supplemented with 7.5% DMSO at −80° C. until analysis.

For multi-color flow cytometric analysis of extracellular markers and intracellular cytokines, cells were thawed, counted, and cultured overnight in RPMI (Fisher Scientific) with 10% BCS and 1× penicillin/streptomycin at 37° C., 5% CO₂, and 90% humidity. Cells were plated at a density of 10×106 cells/well in 24-well culture plates. After culturing overnight, cells were counted, and cytokine production was stimulated using the BioLegend Cell Activation Kit with Brefeldin A prepared according to manufacturer's instructions (Cat. No. 423304) for 4 hours at the previously described culture conditions. Following stimulation, cells were collected and aliquoted into flow cytometry tubes and blocked for 10 minutes at 4° C. using mouse FC block (Cat. No. 553142, BD, San Jose, Calif.) diluted according to manufacturer's instructions. Cells were washed in PBS and stained for extracellular markers diluted in cell staining buffer (Cat. No. 420201, BioLegend). Extracellular markers were: B220 Alexa Fluor® 488 (clone RA3-6B2; rat IgG2a, κ), F4/80 PerCP-Cy5.5 (clone BM8; rat IgG2a, κ), CD11b PE/Cy7 (clone M1/70; rat IgG2b, CD4 Alexa Fluor® 700 (clone GK1.5; rat IgG2b, κ), CD3 Pacific Blue (clone 17A2; rat IgG2b, Ly-6G Brilliant Violet™ 510 (clone RB6-8C5; rat IgG2b, κ), and CD8α Brilliant Violet® 785 (clone 53-6.7; rat IgGla, κ; BioLegend).

Fluorescence minus one staining protocols were used with appropriate isotype controls to account for non-specific binding. Following incubation at 4° C. for 30 minutes in the dark, cells were washed in PBS, fixed, and permeabilized using the eBioscience™ Foxp3/transcription factor staining buffer kit (Cat. No. 00-5523-00; Thermo-Fisher Scientific Corporation, Carlsbad, Calif.) according to the manufacturer's instructions. Cells were stained for intracellular cytokines diluted in permeabilization buffer for 30 minutes at room temperature in the dark. Antibodies for intracellular cytokines were IFN-γ APC (clone XMG1.2; rat IgG1, κ), TNF-α PE (clone MP6-XT22; rat IgG1, κ), IL-17A Brilliant Violet™ 650 (clone TC11-18H10.1; rat IgG1, κ), and IL-22 Alexa Fluor® 647 (clone Poly5164; goat polyclonal IgG; BioLegend). After staining, cells were washed twice in permeabilization buffer and resuspended in cell staining buffer. Cells were kept at 4° C. in the dark until immune cell populations could be analyzed using a BD FACSCanto™ cytometer (BD Biosciences).

Statistical Analysis

Data were analyzed using the following statistical model:

y₍ᵢ₎ⱼₖₗ=μ+Conᵢ+Cut₍ᵢ₎ⱼ+Cut₍ᵢ₎j+F₍ᵢ₎ₖ+(Cut×F)₍ᵢ₎ⱼₖ+e(i)jkl

In this model, y is the dependent variable (cell population), μ is the overall mean, Conᵢ is the control effect at the i^{th} level (i=2), Cut₍ᵢ₎ⱼ is the fixed effect of alfalfa cutting at the j^{th} level (first or fifth; j=2) nested within the control, F₍ᵢ₎ₖ is the fixed effect of supplementation form nested within control at the kth level (hay, aqueous extract, or chloroform extract; k=3), (Cut×F)₍ᵢ₎ⱼₖ is the interaction effect between cutting at the j^{th} level and form at the k^{th} level nested within the control, and e₍ᵢ₎ⱼₖₗ is the random error. This model was implemented to address the 2×3+1 factorial treatment design and analysis was performed using PROC MIXED of SAS 9.4 (SAS Institute, Cary, N.C.). The Satterthwaite method for degrees of freedom and the repeated statement by treatment group were used to analyze data under the assumption of unequal variance between treatments. Significance was denoted at P≤0.05.

Serum Cytokines

The LEGENDplex™ Mouse Inflammation Panel was used to measure serum cytokines on d14 (baseline), 4 dpi, 14 dpi, and 21 dpi to correspond with timepoints used for flow cytometric analysis. During analysis, measured cytokines were below the minimum detectable concentration for most timepoints. When serum cytokines were detected, the obtained values represented a minority of the animals (1-2) within a treatment timepoint; however, serum concentrations of IL-1β were detectable in all mice/treatment on 4 dpi (FIG. 1A).

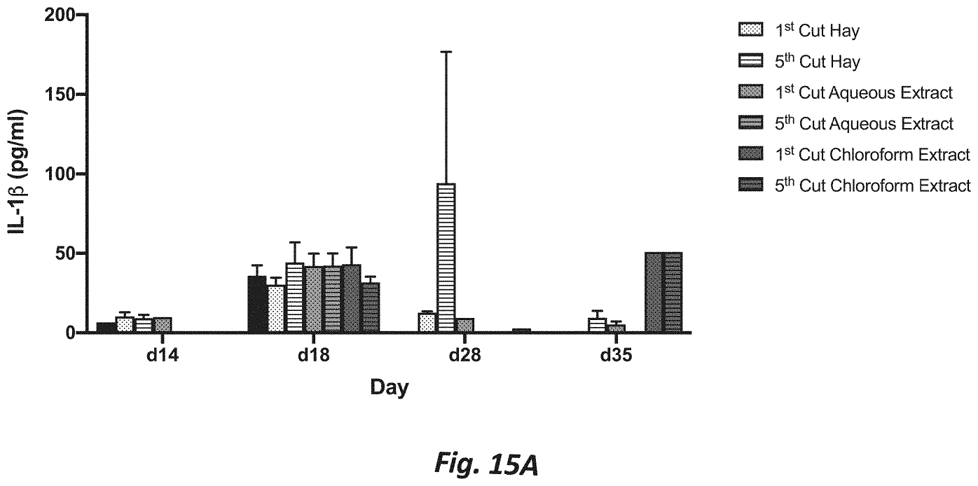

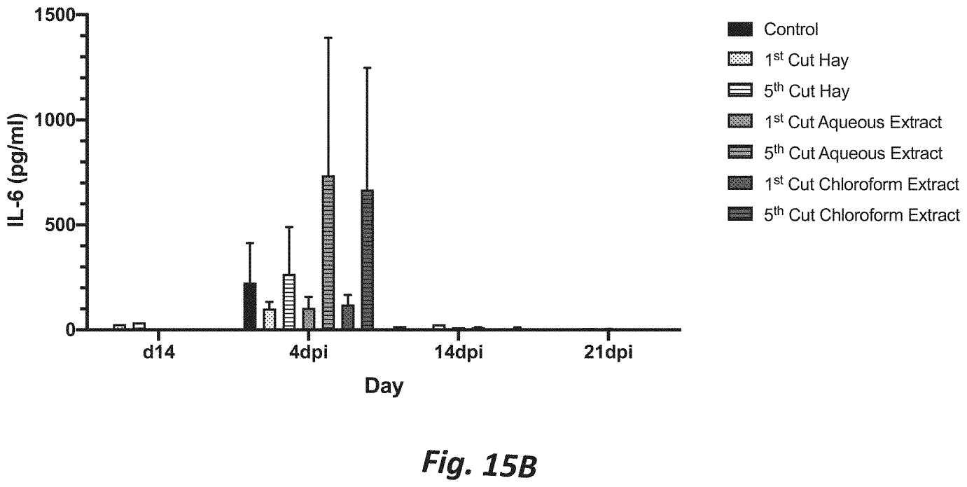

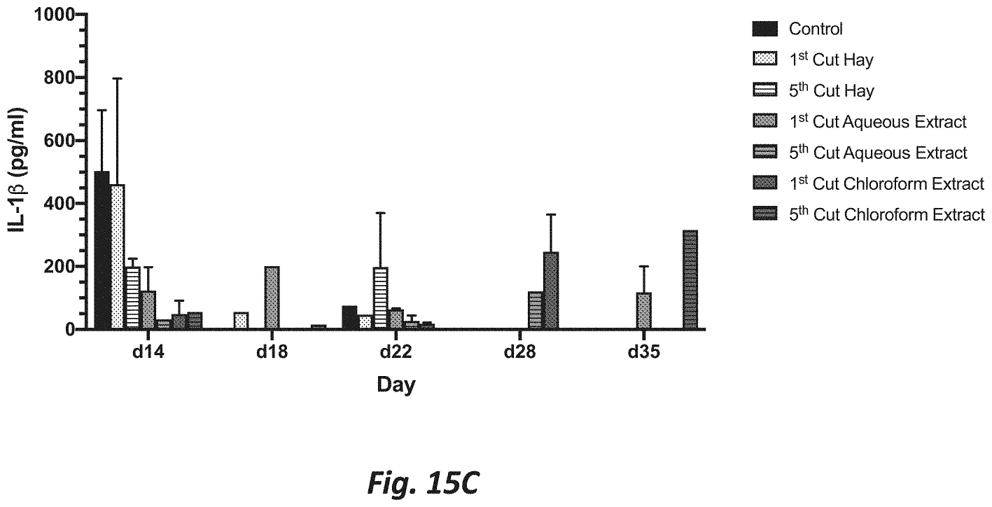

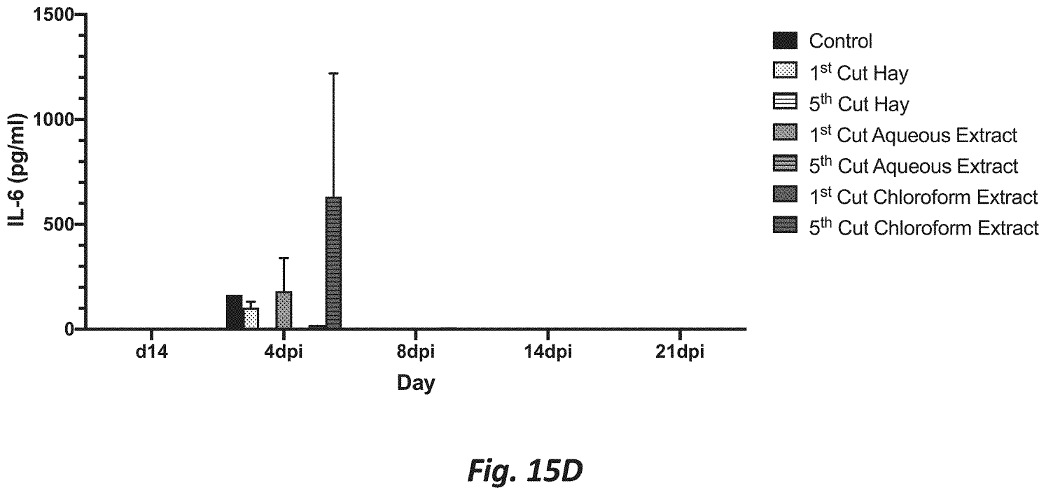

To further investigate these observations, the remaining serum samples were analyzed using ELISA kits for IL-1β and IL-6. As much of the serum for each timepoint was used for the LEGENDplex™ assay, additional samples from 8 dpi were analyzed to include a timepoint representing 4 mice/treatment. Results of the ELISA re-analysis showed similar observations to LEGENDplex™ with much of the samples having cytokine concentrations below the minimum detectable limit, as shown in FIGS. 15A-15D. As a result, statistical analysis could not be performed on serum cytokine concentrations as most timepoints had observed quantities for only 1-2 animals/treatment.

Cytokine-Producing Cells

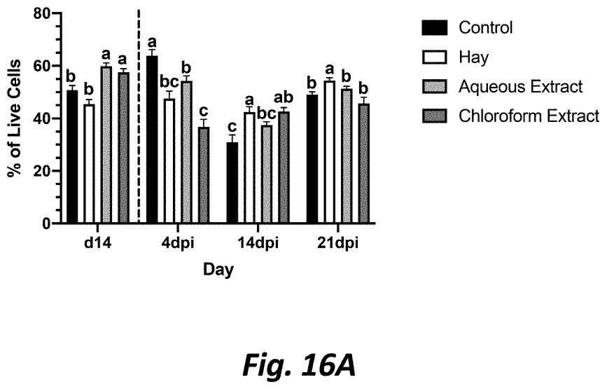

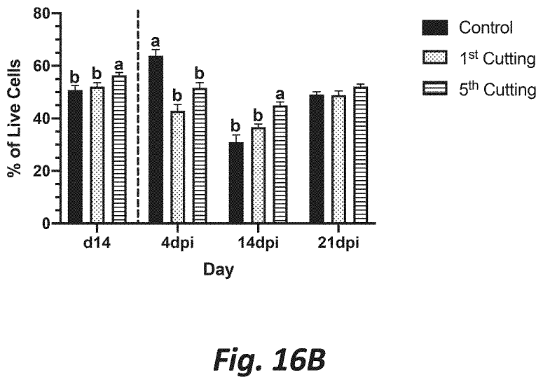

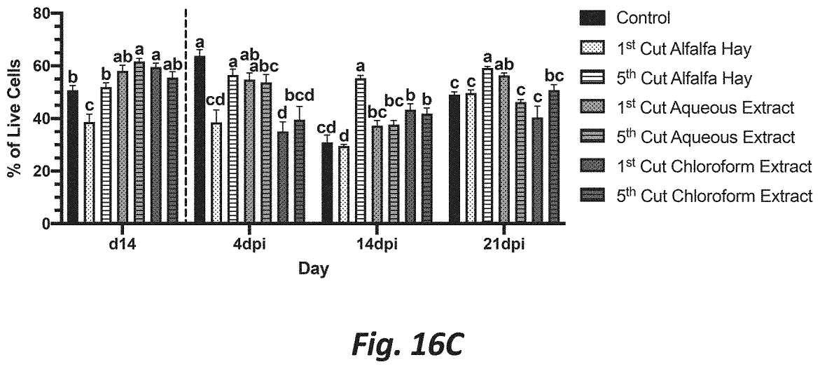

While serum cytokines were not detected in consistent and sufficient concentrations by ELISA and LegendPlex assays, intracellular cytokine staining allowed for analysis of tissue-specific cytokine responses. Interferon-γ is a pro-inflammatory cytokine produced by a number of cell types including CD4⁺ and CD8⁺ T-cells and antigen-presenting cells. At a baseline health state, supplementing alfalfa in the diets as an aqueous or chloroform extract increased the percentage of IFN-γ-producing cells over the control by 9.1 and 6.7%, respectively (P<0.0001) (see FIGS. 16A-16C). Over the course of infection with C. rodentium, hay-supplemented diets showed minor changes to these cell populations and the relatively high percentage of IFN-γ⁺ cells maintained in fifth cutting hay diets across timepoints was underlying observed differences between treatments at 4 and 14 dpi (FIG. 16C). Mice fed chloroform extracts displayed a 20.7% reduction in IFN-γ+ cells from 0-4 dpi to levels 27.0% below the control (P<0.0001), while feeding aqueous extracts resulted in an observed reduction in these cells at the same time as the control (4-14 dpi). In the last days of the infection, control and aqueous diets increased percentages of IFN-γ⁺ cells to pre-inoculation levels, while chloroform extracts maintained this cell population at levels 11.9% below pre-inoculation (FIG. 16A).

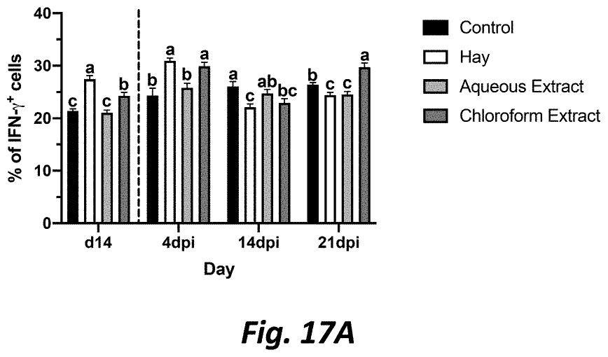

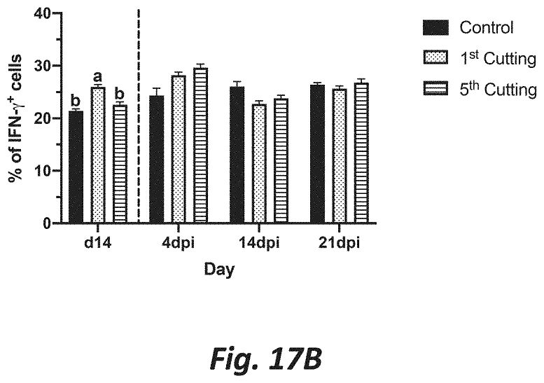

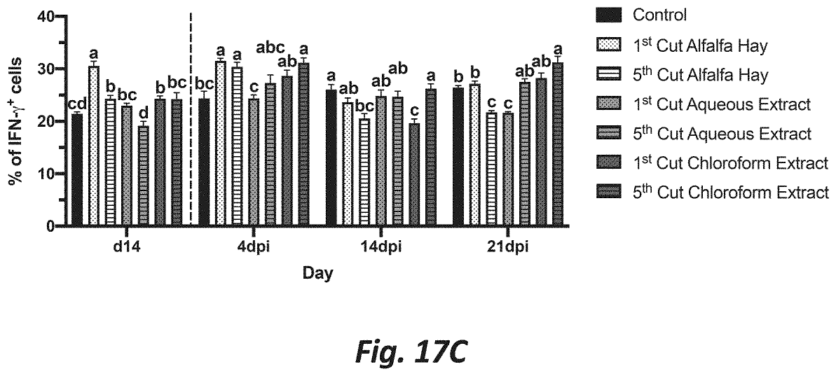

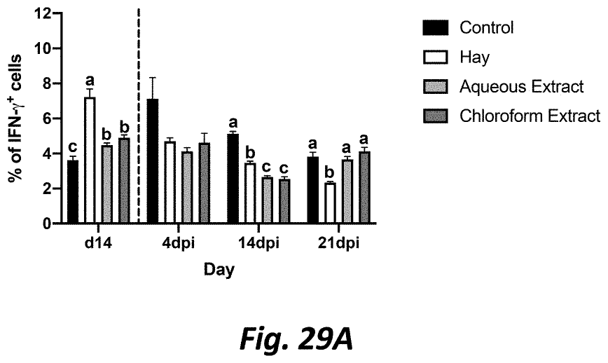

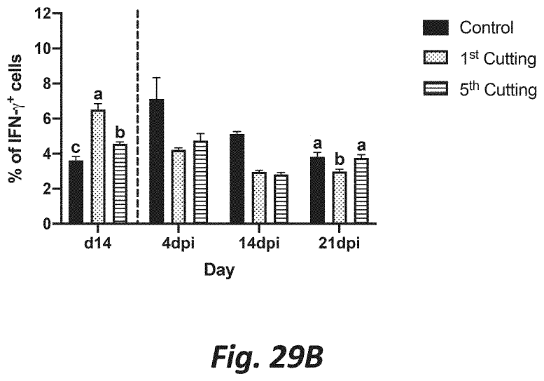

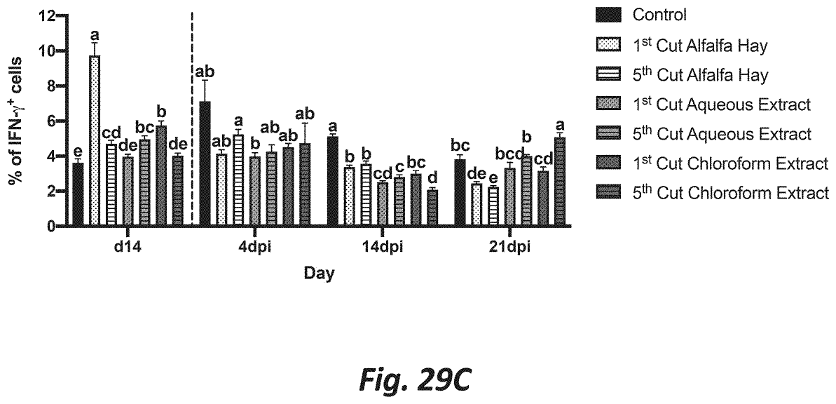

Co-expression of IFN-γ with CD4 or CD8 was used to identify splenic T-cell populations underlying observed IFN-γ responses. In examining the underlying populations of IFN-γ⁺ cells, TH1 (IFN-γ⁺CD4⁺) cells accounted for 20-30% of cytokine production at a baseline health state (see FIGS. 17A-17C), while IFN-γ⁺CD8⁺ cells accounted for a lower percentage (4-7%) (See FIGS. 29A-29C). TH1 cells comprised larger percentages of IFN-γ-producing cells in the spleens of mice fed first cutting alfalfa hay after the feeding enrichment period by 9.2% compared to control. This comparatively larger composition of TH1 cells was underlying observed increases in this cell population attributed to the main effects of form and cutting (P=0.003) (see FIG. 17C). From 0-4 dpi, mice fed hay and chloroform extract-diets showed increases in TH1 cells to levels 6.0 and 6.8% above the control (P<0.0001), followed by a reduction to levels 4.0 and 3.1% below the control at 14 dpi (P=0.03).

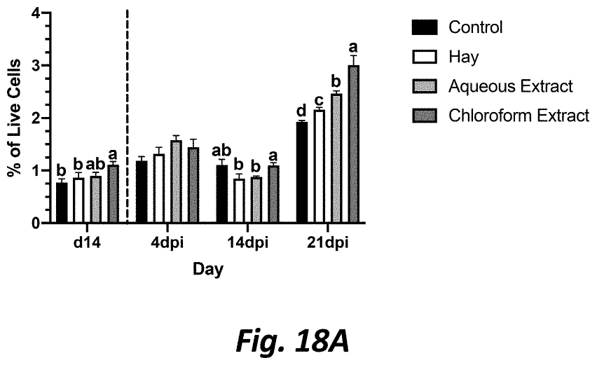

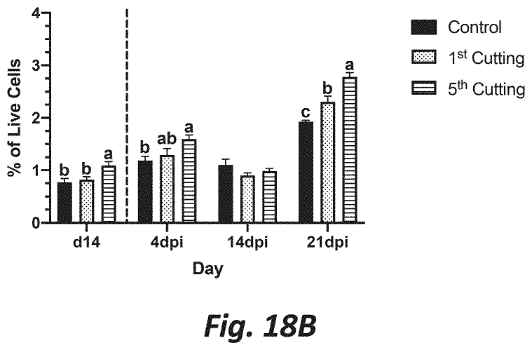

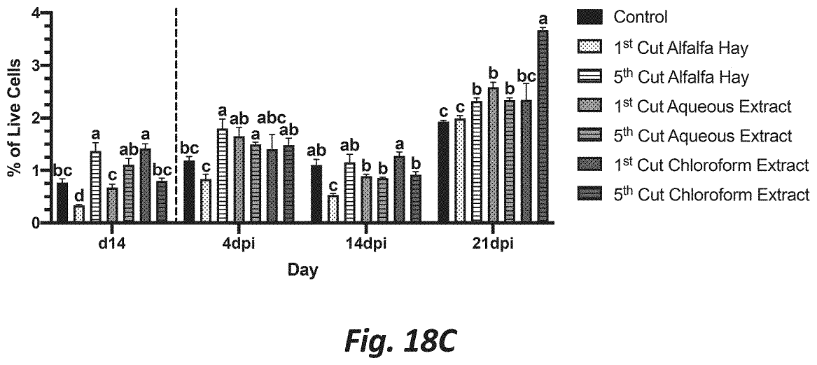

Another pro-inflammatory cytokine, TNF-α, was measured using intracellular cytokine staining. This cytokine is produced by a number of different cell types such as macrophages and T-cells. Compared to IFN-γ, the percentage of TNF-α⁺ cells in the spleens of healthy mice was considerably lower (˜1% compared to −50-60%). The highest percentages of TNF-α⁺ cells were present in the spleens of mice fed fifth cutting alfalfa at a baseline health state (P=0.0004), as shown in FIGS. 18A-18C. From 0-4 dpi, all treatments showed an increase in the percentage of TNF-α⁺ cells with the greatest amount of change observed in mice fed first cutting aqueous and fifth cutting chloroform extracts, which nearly doubled (see FIG. 18C).

While control diets maintained percentages of splenic TNF-α⁺ cells from 4-14 dpi, reductions were observed in all alfalfa supplementation forms with aqueous extracts diets showing a reduction by half to levels below the control and chloroform extract diets (P=0.0005). Notably, the greatest change to this cell population occurred from 14-21 dpi with increases to levels above those observed pre-inoculation across all treatments. The greatest percentages were observed in chloroform extract (P<0.0001) and fifth cutting alfalfa diets (P=0.0003), whose averages were impacted heavily by the four-fold increase in TNF-α⁺ cells in mice fed diets with fifth cutting chloroform extracts to levels greater than all other treatments (P<0.0001) (see FIGS. 18A and 18B).

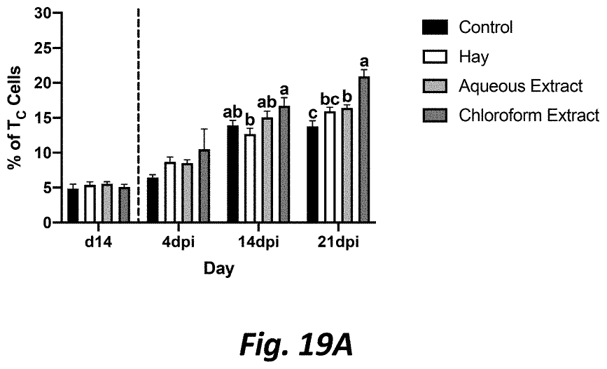

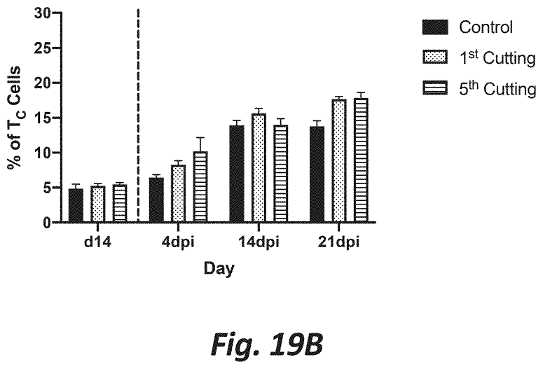

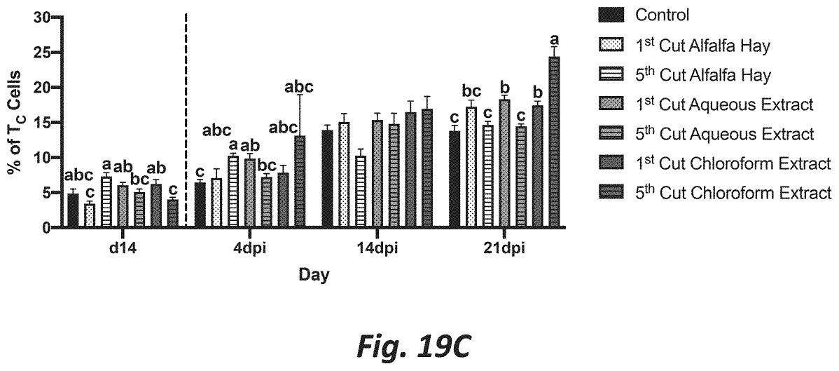

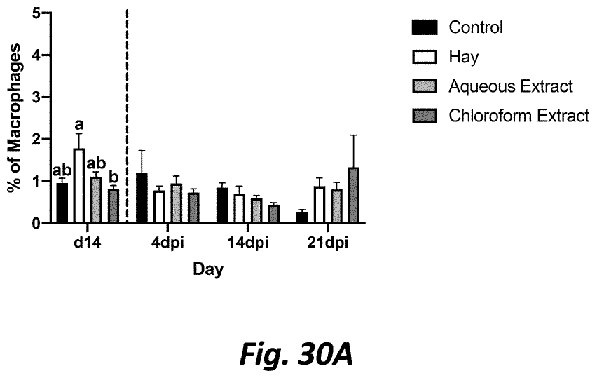

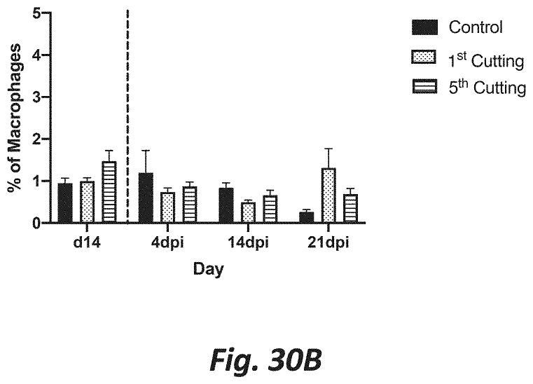

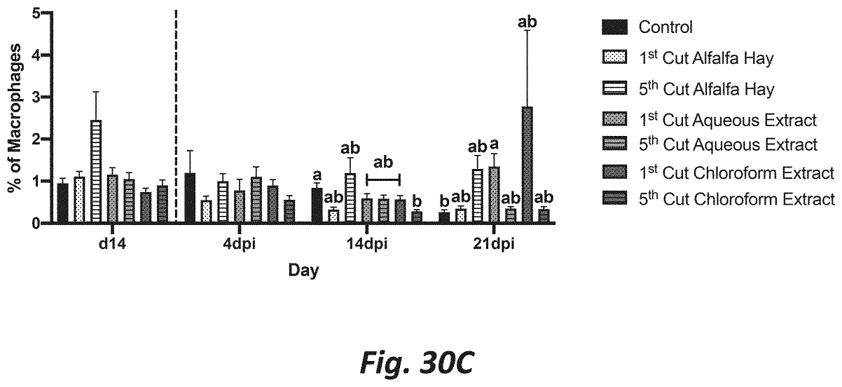

Two different cell types were analyzed for the production of TNF-α to determine which populations were responsible for the observed changes: macrophages and CD3⁺CD8⁺ Tc cells. Production of TNF-α is often associated with macrophage activity; however only a small percentage of splenic macrophages were TNF-α⁺ (1-2%) and showed only minimal changes over the course of infection (See FIGS. 30A-30C). At a baseline health state, approximately 5% of Tc cells stained positive for TNF-α but populations of these cells were not impacted by supplementation form or cutting. Notably, percentages of Tc TNF-α⁺ cells increased in the spleen at later timepoints during the infection in a pattern similar to overall TNF-α⁺ cells. These results are shown in FIGS. 19A-19C

Innate Immune Cells

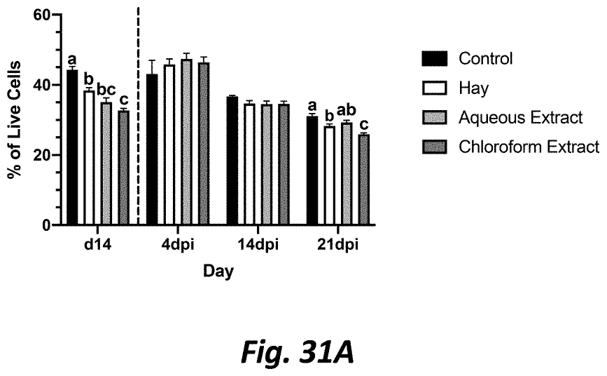

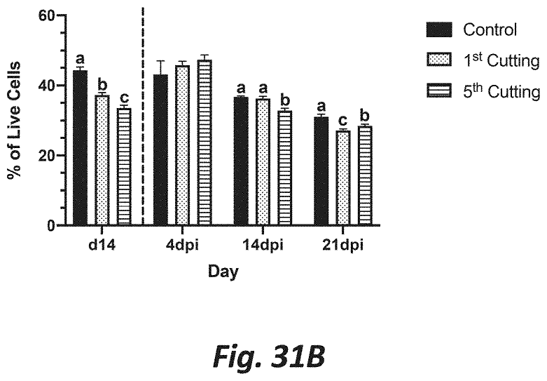

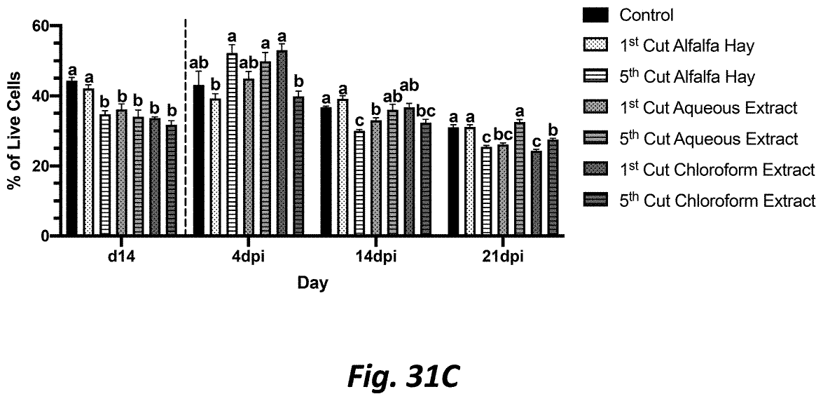

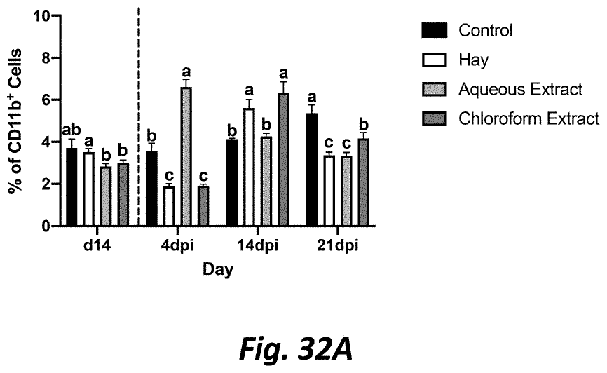

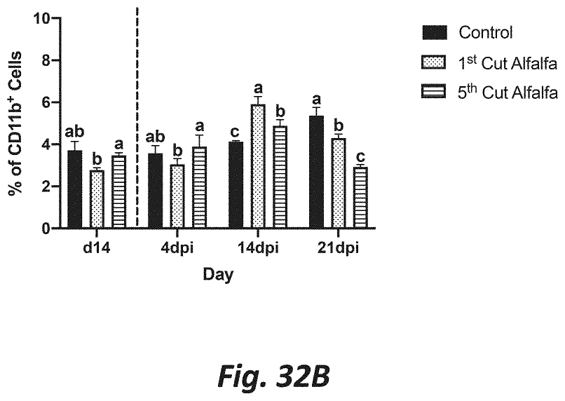

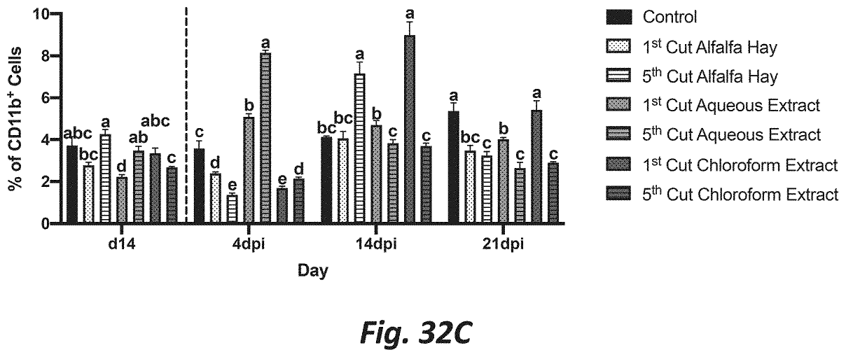

Two innate immune cells measured in the spleen were neutrophils and macrophages based on their expression of CD11b and other extracellular markers. As CD11b is a marker present on B and T lymphocytes in addition to innate immune cells, its overall expression is not overly descriptive of splenic immune cells (See FIGS. 31A-31C). Neutrophils (CD11b⁺Ly6G⁺) were detected in the spleens of healthy mice at low percentages (3-4%) and did not experience notable changes throughout the course of infection (See FIGS. 32A-32C).

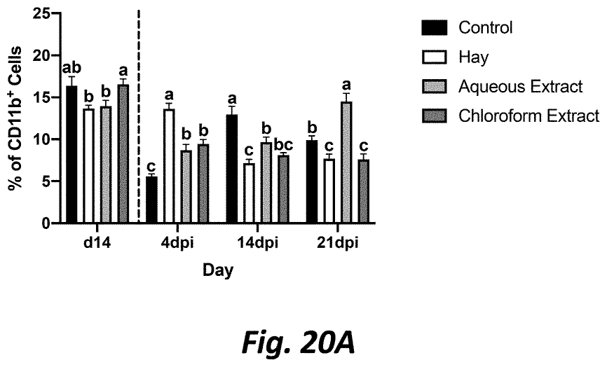

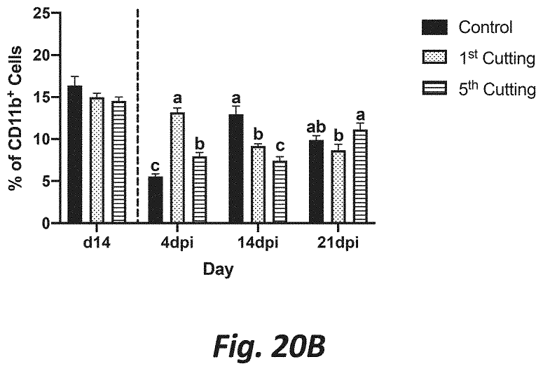

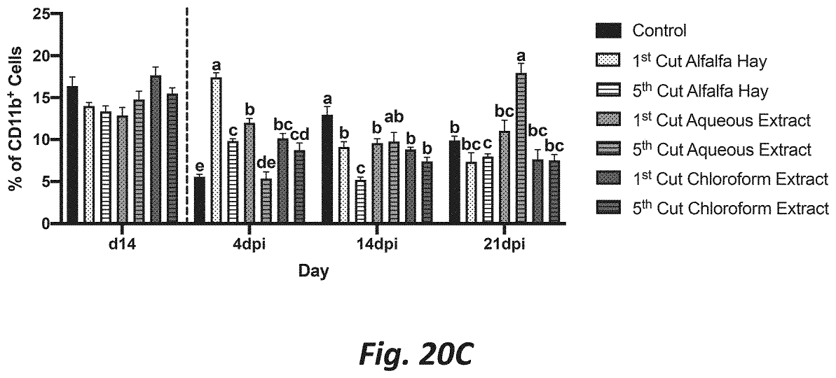

Compared to neutrophils, populations of macrophages (CD11b⁺Ly6G-F4/80⁺) in the spleen were greater, with detected populations accounting for approximately 13-16% of all live cells. These results are shown in FIGS. 20A-20C. At a baseline health state, feeding hay and aqueous extracts resulted in splenic macrophages 2.7 and 2.5% below the control (P=0.0003) (See FIG. 20A). Over the course of the infection, mice fed control diets experienced a 10.8% (⅔) reduction in macrophages at 4 dpi. From 0-4 dpi, both aqueous and chloroform extracts showed a similar decrease in macrophages but to a lesser degree than the control with 5.2 and 7.1% reductions, respectively, while hay diets showed no change during this time. (see FIG. 20A). Despite differences in responses, all forms and cuttings had greater percentages of macrophages relative to the control at 4 dpi (P<0.0001). Mice fed the control diet had a two-fold increase in macrophage populations from 4-14 dpi. During this time, mice fed hay-supplemented diets had an approximately 50% reduction in macrophages to levels below the control while percentages of these cell types were maintained by both extract-supplemented diets (P=0.002) (see FIG. 20A).

At 21 dpi, mice fed diets supplemented with aqueous extracts had a 1.5-fold increase in macrophages to pre-inoculation levels; however only the first cutting aqueous extract diet showed recovery while mice fed fifth cutting aqueous extracts had percentages of this cell population above pre-inoculation levels. (See FIG. 20C). Diets supplemented with hay and chloroform extracts showed minimal change in the last days of the infection and neither cutting resulted in averages similar to pre-inoculation levels. (See FIGS. 20A and 20B).

Adaptive Immune Cells

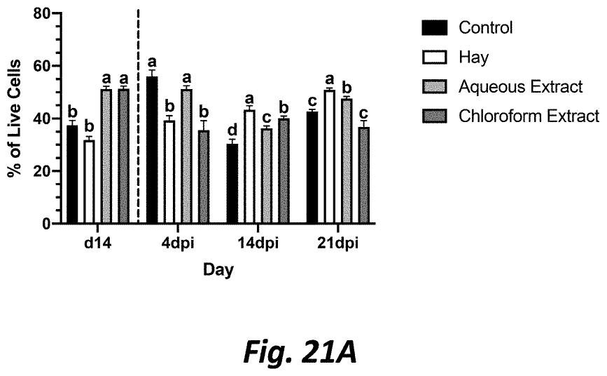

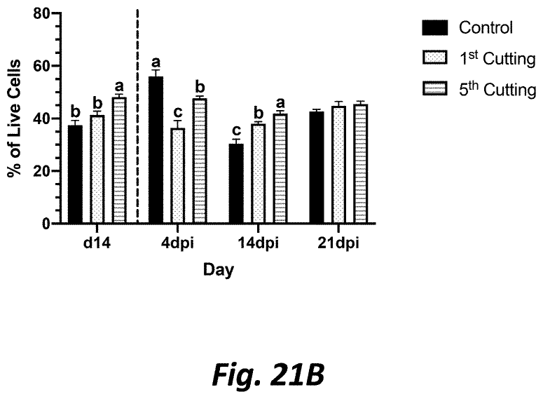

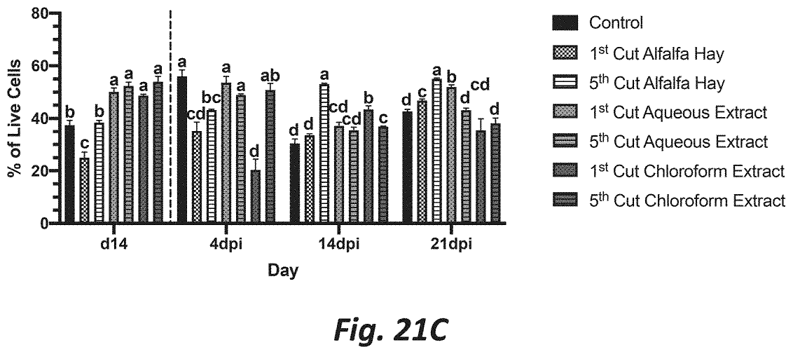

The spleen is characterized as a secondary lymphoid organ and maintains discrete populations of lymphocytes. A large portion of these cells are comprised of B-cells, of which approximately 40-50% of the live cells detected in the spleens of healthy mice were identified as B-cells (B220⁺). These results are shown in FIGS. 21A-21C. After the 14 d feeding enrichment period, mice fed both aqueous and chloroform extracts had 13.8% more B-cells than the control (P<0.0001) with an increase in this cell population to levels 10.8% above the control in mice fed fifth cutting alfalfa (P<0.0001). (See FIGS. 21A and 21B). At 4 dpi, control diets showed an 18.6% increase in B-cells, while fifth cutting alfalfa maintained splenic B-cell populations. The 50% reduction in B-cells to levels below all other treatments at 4 dpi in mice fed first cutting chloroform extracts was underlying observed reductions in this cell population attributed to the main effects of cutting and supplementation form (P<0.0001).

At 14 dpi, B-cell populations in the spleens of mice fed the control diet were reduced by almost half (25.6%) to levels below all forms and cuttings of alfalfa (P<0.0001). At this timepoint, mice fed diets supplemented with fifth cutting hay maintained B-cell populations that were 22.7% greater than the control, while those fed first cutting chloroform extracts showed a two-fold increase in this cell population (P<0.0001). (See FIG. 21C), These anomalous changes were skewing results observed in the main effects, with only aqueous extracts and fifth cutting chloroform extract showing consistent reductions in B-cell populations at this timepoint to levels similar to the control. In the final timepoint of infection, B-cell populations remained below pre-inoculation levels in the spleens of mice fed chloroform extracts, while control and aqueous extract diets showed recovery at 21 dpi. (See FIG. 21A).

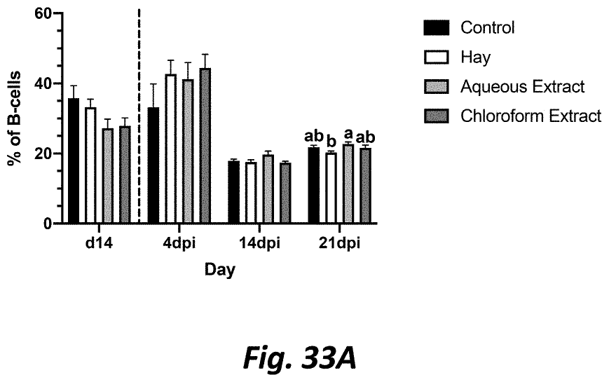

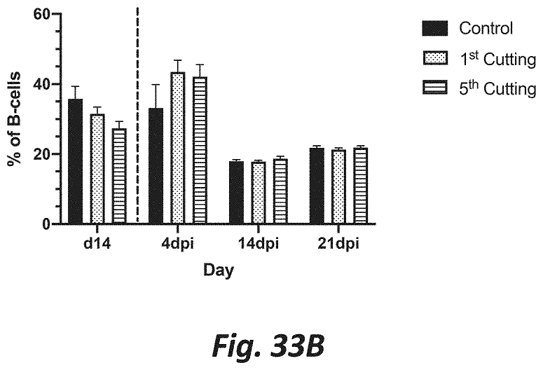

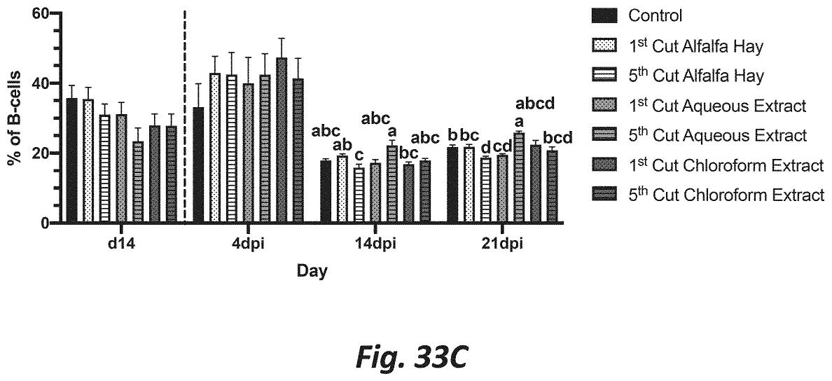

In peripheral blood, expression of CD11 b by B-cells is associated with memory B-cells and plays a role in their ability to home to sites of infection. Populations of B220⁺CD11b⁺ memory B-cells were assessed to determine if these cells were being preferentially recruited to peripheral tissues from the spleen. Throughout the course of infection, changes to this cell populations were opposite of observed changes in total B-cell populations (See FIGS. 33A-33C).

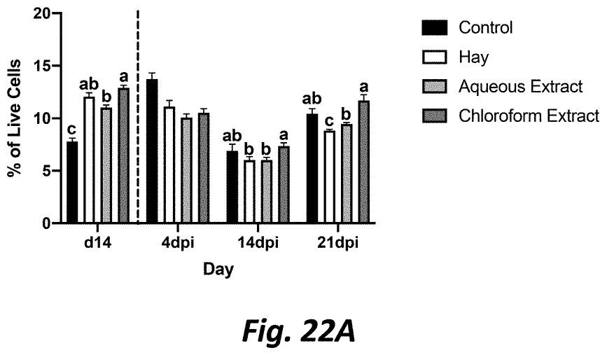

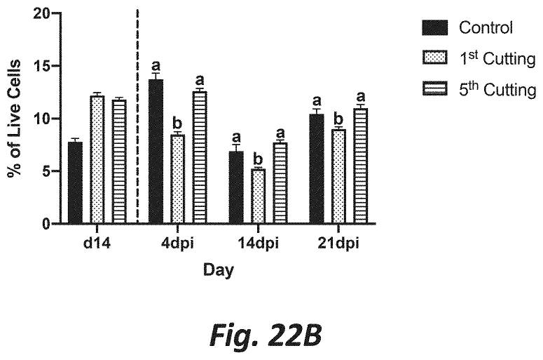

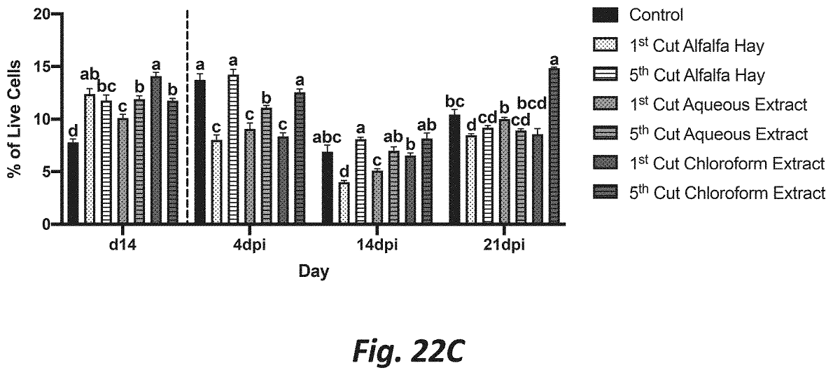

Changes to overall populations of CD3⁺ T-cells were similar to those observed in B-cells. At a baseline health state, all forms of alfalfa increased splenic T-cell populations compared to control, with chloroform extracts having the greatest T-cell presence at 12.9% (P<0.0001). These results are shown in FIGS. 22A-22C. At 4 dpi, mice fed the control diet had an approximately two-fold increase in the percentage of T-cells, while those fed fifth cutting alfalfa maintained populations of these cells. All forms of first cutting alfalfa showed early recruitment of T-cells characterized by a ⅓ reduction to levels below both the control and fifth cutting alfalfa diets (P<0.0001). (See FIG. 22A). At 14 dpi, mice fed the control diets experienced a 50% reduction in T-cells. Mice fed fifth cutting alfalfa showed a similar reduction in this population while those fed first cutting alfalfa showed further reductions to levels maintained below control and fifth cutting alfalfa (P<0.0001). In the last day of the infection period (21 dpi), all treatments showed increases in T-cell populations towards pre-inoculation levels, but only mice fed fifth cutting chloroform extract showed a return to levels above the control by 4.4% (P<0.0001).

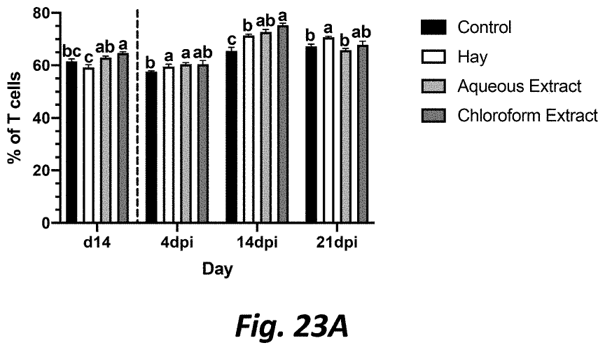

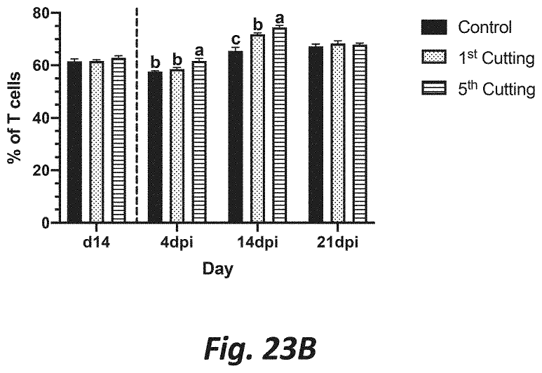

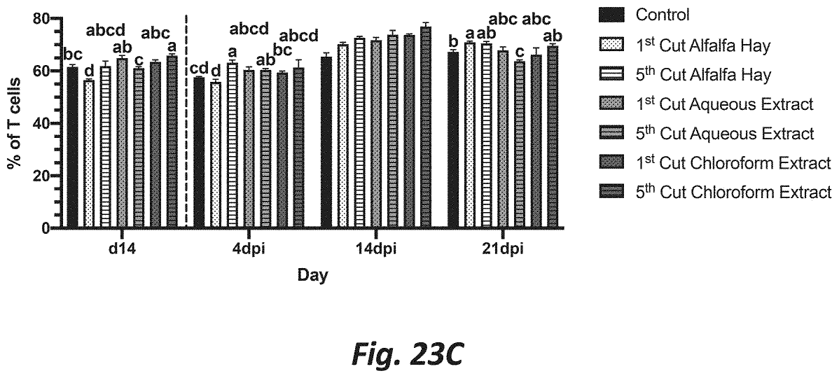

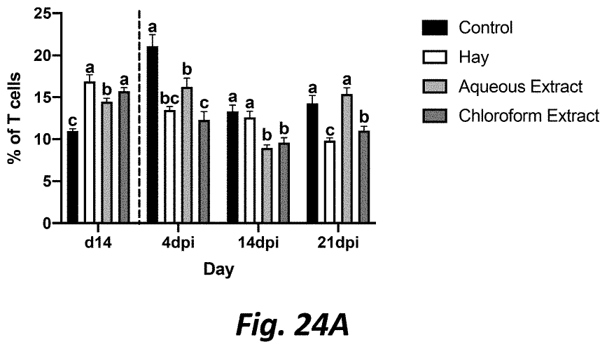

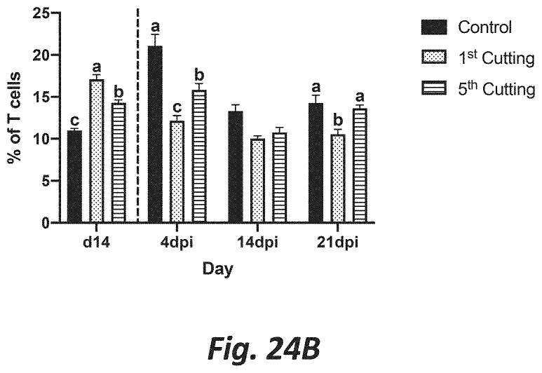

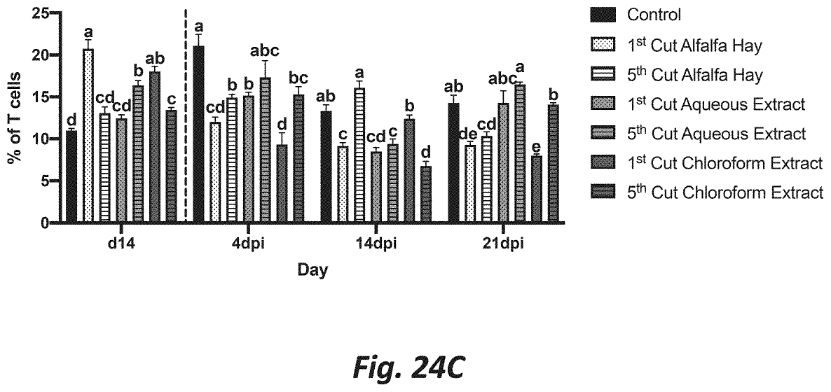

T-cell populations were further divided into CD3⁺CD4⁺ Tx and CD3⁺CD8⁺ Tc subpopulations to identify which were responding to alfalfa supplementation and C. rodentium infection. Notable differences in Tx populations between treatments were not observed after the feeding enrichment period and changes over the course of the infection were consistent across treatments (see FIGS. 23A-23C). In contrast, changes to Tc cells roughly corresponded to changes in overall T-cell populations (see FIGS. 24A-24C).

This study aimed to assess immunological changes in response to dietary alfalfa at systemic and tissue-specific levels. Analysis of serum cytokines was intended to determine systemic immune responses before and after inoculation; however, both LEGENDplex™ and ELISA assays suggested that tissue-specific assays were more useful in the context of a localized infection.

While the results obtained from serum analysis were unreliable for modeling systemic responses, extracellular cytokine staining showed responses in the spleen at a tissue level. Differential levels of inflammatory IFN-γ and TNF-α production in the spleen were observed with the former being more responsive to alfalfa form and the latter being impacted by cutting in healthy mice. Supplementation form may contribute to a more pro-inflammatory environment, as production of IFN-γ was substantially greater than TNF-α. In terms of cytokine production, alfalfa extracts contributed to a more inflammatory environment at a baseline health state by increasing the percentages of IFN-γ⁺ cells, suggesting that that non-fiber compounds enriched in alfalfa extracts shift baseline immunity toward a more inflammatory state.

In addition to changes in cytokine production, alfalfa supplementation can elicit changes to lymphocyte populations. Increases to T-cell populations were increased by all forms of supplementation, whereas fifth cutting extracts increased B-cell populations at a baseline health state. Generally, these shifts toward a more pro-inflammatory state would be regarded as detrimental; however, observed similarities in BW and ADFI observed across all treatments indicate that increases in IFN-γ and lymphocyte populations did not negatively impact overall health.

During infection with C. rodentium, percentages of colonic neutrophils peak at 4 dpi, while macrophages peak at 14 dpi. The number of B-cells in the colon is increased at 8 dpi, while percentages of both Tx and Tc peak at 14 dpi. At 21 dpi, colonic percentages of innate immune cells return to pre-inoculation levels, whereas lymphocyte populations begin to decrease but remain elevated. Due to the low cell numbers that can be obtained from the mouse colon and the large number of extracellular and intracellular markers used in this study, immune cell populations during infection were assessed in the spleen and isolated colon cells were saved for later pooled analyses. Citrobacter rodentium is characterized by an infection that is limited to the colon and is not known to colonize the spleen, which limits the understanding of the spleen's role during infection. Given the spleen's role in initiating innate and adaptive immune responses to infection, reductions in splenic cell populations may indicate recruitment to sites of infection in the peripheral tissues.

More changes to the immune response to C. rodentium were observed in the early timepoints of infection as a result of alfalfa supplementation. Chloroform extracts contributed to earlier recruitment of IFN-γ⁺ cells at 4 dpi, which was 10 d earlier than mice fed control and aqueous extracts. Responses to C. rodentium are characterized by IFN-γ production and the TH1 response associated with this cytokine. While changes to TH1 (IFN-γ⁺CD4⁺) (see FIGS. 17A-17C) cells were observed in the spleen, overall Tx populations (CD3⁺CD4⁺; see FIGS. 22A-22C) did not display a reduction associated with recruitment to peripheral tissues. This suggests that changes to TH1 populations were the result of shifts in overall IFN-γ-producing cells in the spleen and TH1 activity during infection was more localized to the colon. These observations combined suggest that early reductions to IFN-γ⁺ populations in the spleens of mice fed chloroform extracts were due to the activity of innate immune cell populations, rather than adaptive TH1 cells.

Changes to specific innate immune cell populations were less notable during the early stages of infection. Neutrophils (CD11b⁺Ly6G⁺) are found in high numbers in circulation but were detected at low percentages (3-4%) in the spleen. While statistical differences are reported between treatments throughout the study, the low presence of neutrophils in the spleen suggests that observed fluctuations may have had little biological impact and splenic neutrophil populations did not contribute to a local C. rodentium response.

Changes to macrophage populations may have had more biological relevance during infection, with supplementation form altering timelines of response. In the first 4 dpi, aqueous and chloroform extracts reduced the magnitude of macrophage recruitment compared to the control while hay diets did not show evidence of recruitment until 14 dpi. This delayed response may have contributed to the detrimental effects on mouse BW observed in mice fed hay-supplemented diets, but changes to the magnitude of response in either extract diet likely did not impact BW in early timepoints post-inoculation. Over the course of the infection period, aqueous extracts showed macrophage recovery while chloroform extracts maintained low percentages of this population over the course of infection. While recovery observed in mice fed aqueous extracts may indicate improvement in macrophage response, similarities in BW between control and aqueous extract diets at later timepoints suggest that changes to this population did not translate to improvements in mouse BW.

While form had more of an impact on cytokine production and innate immune cell populations, cutting had a greater impact on timelines associated with adaptive immune cell responses. At 4 dpi, control diets showed splenic lymphocyte proliferation in response to C. rodentium while fifth cutting alfalfa maintained these cell populations. Notably, first cutting alfalfa contributed to early recruitment of adaptive cell populations at a timepoint 10 d earlier than expected (FIGS. 4.7 and 4.8).

A majority of the cells measured in the spleen were identified as B-cells and changes to these populations during the course of infection varied between supplementation forms at later timepoints. Notably, hay diets did not show a reduction in splenic B-cells over the course of infection indicating that B-cells were not recruited from the spleen to peripheral sites of infection. This lack of a response may have detrimentally impacted the BW responses of mice fed hay as they had lower average BW compared to the control during late-infection timepoints that would be characterized by an adaptive response. By the end of the infection, control and aqueous extract diets showed recovery of B-cell populations, but BW results suggest that this recovery did not confer greater weight gain by the end of the trial. Feeding chloroform extracts kept splenic B-cells at reduced levels over the course of infection, which suggests maintenance of an adaptive response that translated to increased BW over control in the final days of infection. Changes to T-cells were similar to B-cells over the course of the infection, suggesting that these results are consistent across lymphocyte populations. The combination of the observed responses to cutting at early timepoints post-inoculation with the effects of form at later stages may have contributed to the protective effects on BW in mice fed fifth cutting chloroform extract in the early days of infection and improved BW over control in later timepoints.

Changes to underlying lymphocyte populations detail subpopulations contributing to the observed responses. The inverse relationship between overall B-cells and B220⁺CD11b⁺ memory B-cells suggests that memory B-cells were not proliferating and migrating from the spleen in response to alfalfa supplementation and C. rodentium infection (See FIGS. 32A-32C). As previously discussed, TH subpopulations were not recruited from the spleen over the course of infection, indicating that general TH responses did not involve recruitment from the spleen and were tissue-specific during C. rodentium infection. These results are shown in FIGS. 23A-23C. In the colon, TH17 and TH22 cell populations characterized by the production of IL-17 and IL-22, respectively, contribute to clearance of C. rodentium infection. The presence of these cytokines was not detected in the spleen and serum, suggesting that involvement of TH17 and TH22 cells in C. rodentium clearance is limited to the colon. In contrast, changes to Tc cells roughly corresponded to changes in overall T-cell populations suggesting that these cells were underlying the observed changes in T-cell populations and may identify the spleen as a potential source of Tc cells during C. rodentium infection. These results are shown in FIGS. 24A-24C.

Overall, the results of this study suggest that the lipid soluble compartment of fifth cutting alfalfa contributes to a more pro-inflammatory environment at a health state, which contributes to altered timelines of response during C. rodentium infection. These responses may have contributed to observed protective and beneficial impacts on mouse body weight as a parameter of overall health.

### Example 4. Use of Lipid-Soluble Compounds in Bioactive Alfalfa Additive for Modulating Murine Colon Microbiota During Infection

163 6-week-old female C57BL/6J mice (Jackson Laboratories, Bar Harbor, Me.) were housed in 45 Innovive cages (Innovive Inc., San Diego, Calif.), with 2-4 mice/cage. Upon arrival, mice were given a 7 d acclimation period to allow the intestinal microbiota to stabilize following transportation and diet change. On d0, 9 mice were euthanized and colon digesta was collected for baseline microbiota analysis. The remaining mice were assigned to 1 of 7 dietary treatments (22 mice/treatment) consisting of the Teklad Global 18% protein diet (Envigo, Huntingdon, UK) with or without supplementation of alfalfa in 3 forms (hay, aqueous extract, and chloroform extract) of early (first) and late (fifth) cutting alfalfa. All diets were formulated and prepared by Teklad Envigo (Madison, Wis.) to be isocaloric and isonitrogenous. The basal diet (TD.00588) without alfalfa was used as a control and ground first and fifth cutting hay was incorporated into the diet at a 9% inclusion level (TD.170994, TD.170995). Aqueous alfalfa extract was prepared in a 1:5 ratio of alfalfa:water for 24 h and solid extract was obtained by freeze-drying the collected filtrate. Chloroform alfalfa extract was prepared using a 72 h extraction at a 1:4 ratio of alfalfa:chloroform with supplemental heat (40° C.) and evaporating the chloroform out of the filtrate to obtain a solid product. Extracts were incorporated into their respective diets (TD.170996; TD.170997; TD.170998; TD.10999) at a 0.25% inclusion level.

After a 14 d feed adaptation period, 6 mice/treatment were euthanized for collection of the colon digesta. The remaining mice (16/treatment) were orally inoculated with 2×10¹⁰ CFUs of C. rodentium strain DBS100 (ATCC 51459, Manassas, Va.). Preparation of C. rodentium inoculum was done according to methods described according to Crepin V F, Collins J W, Habibzay M, Frankel G., “Citrobacter rodentium mouse model of bacterial infection.” NATURE PROTOC. 11:1851-76 (2016), which is herein incorporated by reference in its entirety. Briefly, LB was inoculated with C. rodentium and grown at 37° C. with shaking at 200 rpm overnight. Cultures were centrifuged at 3,000 g at 4° C. for 10 minutes and resuspended in 1.5 ml sterile PBS. Each 1.5 ml suspension of C. rodentium was sufficient to inoculate 6 mice and the amounts were scaled to produce sufficient inoculum to infect 112 mice. Following administration of 200 μl of inoculum/mouse, the remaining culture was serially diluted and plated on LB agar to enumerate CFUs.

Following inoculation, 4 mice/treatment were euthanized at 4, 8, 14, and 21 dpi for colon digesta collection. Euthanasia occurred in a biosafety cabinet and digesta was collected into sterile microtubes within a laminar flow hood. Digesta was stored at −80° C. until analysis.

DNA Extraction and Sequencing

DNA extraction from the colon digesta was performed using the DNeasy PowerLyzer PowerSoil Kit (Qiagen, Hilden, Germany) according to the manufacturer's instructions. Extracted DNA was quantified using a Nanodrop 2000 spectrophotometer (Thermo Fisher Scientific, Waltham, Mass.) and kept at −20° C. Prior to PCR amplification and sequencing, extracted DNA was diluted to approximately 30 ng/μl and plated on a microtiter plate. Microbiota sequencing was conducted using a protocol designed to amplify bacteria and archaea in the DNA facility at Iowa State University (Ames, Iowa). Briefly, genomic DNA from each sample was amplified using Platinum™ Taq DNA Polymerase (Thermo Fisher Scientific, Waltham, Mass.) with one replicate per sample using universal 16S rRNA gene bacterial primers [515F (5′-GTGYCAGCMGCCGCGGTAA-3′ and 806R (5′-GGACTACNVGGGTWTCTAAT-3] for the variable region V4. All samples underwent PCR with an initial denaturation step at 94° C. for 3 min, followed by 45 s of denaturing at 94° C., 20 s of annealing at 50° C., and 90 s of extension at 72° C. This was repeated for 35 total PCR cycles and finished with a 10 min extension at 72° C. PCR products were then purified with the QIAquick 96 PCR Purification Kit (Qiagen Sciences Inc, Germantown, Md.) according to the manufacturer's recommendations. PCR bar-coded amplicons were mixed at equal molar ratios and used for Illumina MiSeq paired-end sequencing with 150 bp read length and cluster generation with 10% PhiX control DNA on an Illumina MiSeq platform (Illumina Inc., San Diego, Calif.).

Microbiota Sequencing Data Analysis

Sequencing data were assessed for quality and screened using mothur (v.1.40.04). Prior to clustering into OTUs, paired-end reads were merged and sequences with ambiguous bases were removed. Sequences shorter than 250 bp and longer than 255 bp were removed, in addition to sequences with >8 identical consecutive bases. Sequences were then randomly subsampled to 32,000 sequences/sample. Unique sequences meeting these criteria were aligned to the SILVA v132 database. Potential chimeric sequences and those within 2 mismatches of the aligned sequences were also removed before sequences were clustered into OTUs at a 97% similarity cut-off, resulting in a total of 495,503 OTUs. The SILVA SSU reference database version 132 was used as taxonomic reference for the OTUs. Whole community comparisons were done using analysis of similarities (ANOSIM), while differences between treatments at an OTU level were analyzed using linear discriminant analysis (LDA) effect size (LEfSe; 37).

Kirby-Bauer Plates

The disc diffusion method was used to test the alfalfa extracts for antimicrobial properties. Solid aqueous and chloroform extracts of first and fifth cutting alfalfa were dissolved in their respective solvents to create 2.5% (w/v) solutions and serially diluted ten-fold to obtain two additional concentrations of test extract. Citrobacter rodentium was cultured overnight in LB media and 250 μl was plated onto LB agar. Filter discs were ethanol-sterilized and placed onto the plates with C. rodentium before 20 μl of each extract was pipetted directly onto the disc. All extracts were plated in duplicate in addition to negative controls for each solvent. Plates were cultured overnight at 37° C. and assessed for the presence of a zone of inhibition (ZOI) around each filter disc.

Ground Alfalfa Hay

Whole-community analysis of the colon microbiota by ANOSIM is presented in Table 5 below.

TABLE 5
Whole-community ANOSIM1 comparisons of the colon microbiota in
mice fed the control and diets with first or fifth cutting ground alfalfa hay.

| Comparison | R-value1 | P-value2 |
|---|---|---|
| Control vs. 1st Cut Hay | | |
| d14 (baseline) | 0.20 | 0.03 |
| 4 dpi | 1.00 | 0.03 |
| 14 dpi | 0.03 | 0.49 |
| 21 dpi | 0.48 | 0.03 |
| Control vs. 5th Cut Hay | | |
| d14 (baseline) | 0.39 | 0.04 |
| 4 dpi | 0.41 | 0.06 |
| 14 dpi | 0.38 | 0.06 |
| 21 dpi | 0.25 | 0.11 |
| 1st Cut Hay vs. 5th Cut Hay | | |
| d14 (baseline) | 0.01 | 0.36 |
| 4 dpi | 1.00 | 0.03 |
| 14 dpi | 0.24 | 0.20 |
| 21 dpi | 0.39 | 0.11 |

¹Analysis of similarity performed using mothur (v.1.40.04)
²R-values detail the source of sample variations on a scale of −1 to 1. Values closer to −1 suggest higher variation between within samples while those closer to 1 suggest higher variation between samples. R-values close to 0 indicate no differences in variation.
³Significance determined at P ≤ 0.05.

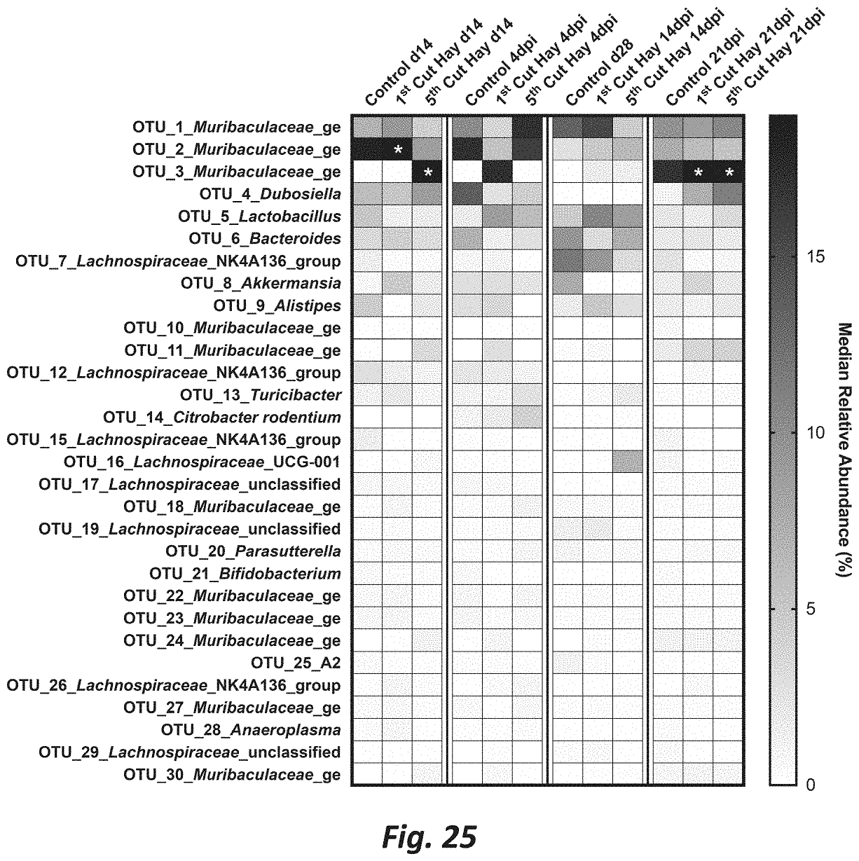

At a baseline health state (d14), both first and fifth cutting alfalfa hay altered the colon microbial community of mice to be different from control (P=0.03 and 0.04, respectively). During the infection period, mice fed first cutting hay showed differences from the control and fifth cutting hay at a whole community level at 4 dpi and differences from control at 21 dpi (P=0.03; Table 5). Of the 200 most abundant OTUs detected in the mouse colon, most were associated with Muribaculaceae, Lachnospiraceae, and Ruminococcaceae. The presence of C. rodentium was confirmed and identified as OTU 14 using Seqmatch (https://rdp.cme.msu.edu/seqmatch/). A heatmap of the 30 most abundant OTUs in mice fed the control, first cutting hay, and fifth cutting hay is presented in FIG. 25. Additional results of LEfSe analysis for the 200 most abundant OTUs are presented in Table 6-Table 17.

At a baseline health state, feeding first and fifth cutting alfalfa hay resulted in 158 and 160 significantly different OTUs compared to control, respectively. After the enrichment period, first cutting hay increased the relative abundance of Lachnospiraceae (OTUs 26, 34, 43, and 47) while fifth cutting increased both Muribaculaceae (OTUs 24, 30, 37, 45, and 48) and Lachnospiraceae (OTUs 16, 34, 47, and 49) compared to control, as shown in Tables 6 and 7 below. In these tables, the significantly different OTUs between the two groups are shown for the 200 most abundant OTUs in the mouse colon.

TABLE 6
Significantly different OTUs (P ≤ 0.05) between control and first cutting hay diets
after the feed enrichment period (d14) determined by LEfSe analysis in mothur.

| | Control | 1^{st} cutting | | | |
|---|---|---|---|---|---|
| | median | hay median | | | |
| | relative | relative | LDA | | |
| | abundance | abundance | score | | |
| OTU | (%) | (%) | (log 10) | P-value | Taxonomy |
| OTU 008 | 0.73 | 4.79 | 4.26 | 0.02 | Akkermansia |
| OTU 024 | 0.00 | 0.01 | 3.65 | 0.01 | Muribaculaceae_ge |
| OTU 025 | 0.38 | 0.08 | 3.07 | 0.01 | Lachnospiraceae A2 |
| OTU 026 | 0.08 | 0.96 | 3.45 | 0.04 | Lachnospiraceae_NK4A136_group |
| OTU 028 | 0.34 | 0.75 | 3.38 | 0.04 | Anaeroplasma |
| OTU 034 | 0.00 | 0.28 | 2.94 | 0.02 | Lachnospiraceae_unclassified |
| OTU 043 | 0.01 | 0.08 | 2.44 | 0.02 | Lachnospiraceae_NK4A136_group |
| OTU 047 | 0.01 | 0.23 | 3.11 | 0.004 | Lachnospiraceae_unclassified |
| OTU 052 | 0.06 | 0.01 | 2.50 | 0.004 | Erysipelatoclostridium |
| OTU 057 | 0.01 | 0.79 | 3.46 | 0.01 | Lachnospiraceae_unclassified |
| OTU 059 | 0.26 | 0.00 | 2.89 | 0.02 | Lachnoclostridium |
| OTU 075 | 0.34 | 0.03 | 2.91 | 0.01 | Lachnospiraceae ASF356 |
| OTU 082 | 0.11 | 0.05 | 2.53 | 0.02 | uncultured |
| OTU 094 | 0.10 | 0.00 | 2.62 | 0.003 | Enterorhabdus |
| OTU 096 | 0.02 | 0.28 | 3.23 | 0.02 | Ruminococcaceae_ge |
| OTU 098 | 0.18 | 0.04 | 2.77 | 0.04 | Lachnospiraceae_unclassified |
| OTU 105 | 0.02 | 0.12 | 2.74 | 0.04 | Lachnospiraceae_NK4A136_group |
| OTU 118 | 0.03 | 0.10 | 2.62 | 0.01 | Ruminiclostridium |
| OTU 122 | 0.01 | 0.04 | 2.34 | 0.04 | Ruminiclostridium |
| OTU 136 | 0.67 | 0.00 | 3.69 | 0.02 | Faecalibaculum |
| OTU 140 | 0.07 | 0.01 | 2.46 | 0.004 | Lachnospiraceae_unclassified |
| OTU 147 | 0.02 | 0.05 | 2.20 | 0.02 | Ruminococcaceae_UCG-014 |
| OTU 159 | 0.00 | 0.07 | 2.38 | 0.05 | Lachnospiraceae_NK4A136_group |
| OTU 161 | 0.07 | 0.02 | 2.77 | 0.004 | Lachnospiraceae unclassified |
| OTU 174 | 0.00 | 0.03 | 2.74 | 0.02 | Ruminococcaceae_UCG-014 |
| OTU 190 | 0.02 | 0.09 | 2.25 | 0.04 | Lachnospiraceae unclassified |
| OTU 199 | 0.06 | 0.02 | 2.23 | 0.01 | Lachnoclostridium |

¹Abbreviations: OTU = operational taxonomic unit; LEfSe = linear discriminant analysis effect size; LDA = linear discriminant analysis

TABLE 7
Significantly different OTUs (P ≤0.05) between control and
5^{th} cutting hay diets after the feed enrichment period (d14)
determined by LEfSe analysis in mothur.

| | | 5^{th} | | | |
|---|---|---|---|---|---|
| | | cutting | | | |
| | Control | hay | | | |
| | median | median | | | |
| | relative | relative | LDA | | |
| | abundance | abundance | score | | |
| OTU | (%) | (%) | (log 10) | P-value | Taxonomy |
| OTU 016 | 0.03 | 0.54 | 3.05 | 0.02 | Lachnospiraceae_UCG-001 |
| OTU 024 | 0.00 | 1.21 | 3.78 | 0.02 | Muribaculaceae_ge |
| OTU 030 | 0.00 | 0.94 | 3.75 | 0.03 | Muribaculaceae_ge |
| OTU 034 | 0.00 | 0.25 | 3.32 | 0.01 | Lachnospiraceae_unclassified |
| OTU 037 | 0.00 | 0.79 | 3.68 | 0.02 | Muribaculaceae_ge |
| OTU 041 | 0.40 | 0.11 | 3.20 | 0.02 | Ruminococcus_1 |
| OTU 045 | 0.00 | 0.29 | 3.23 | 0.02 | Muribaculaceae_ge |
| OTU 047 | 0.01 | 0.14 | 2.64 | 0.01 | Lachnospiraceae_unclassified |
| OTU 048 | 0.00 | 0.26 | 3.21 | 0.02 | Muribaculaceae_ge |
| OTU 049 | 0.01 | 0.18 | 2.56 | 0.02 | Lachnospiraceae_UCG-001 |
| OTU 054 | 0.00 | 0.25 | 3.09 | 0.02 | Muribaculaceae_ge |
| OTU 055 | 0.10 | 0.00 | 2.45 | 0.02 | Clostridium_sensu_stricto_1 |
| OTU 066 | 0.00 | 0.53 | 3.51 | 0.05 | Muribaculaceae_ge |
| OTU 068 | 0.00 | 0.16 | 2.90 | 0.02 | Muribaculaceae_ge |
| OTU 069 | 0.23 | 0.06 | 2.91 | 0.004 | Lachnoclostridium |
| OTU 073 | 0.00 | 0.41 | 3.49 | 0.02 | Muribaculaceae_ge |
| OTU 075 | 0.34 | 0.03 | 3.11 | 0.02 | Lachnospiraceae ASF356 |
| OTU 078 | 0.00 | 0.18 | 3.07 | 0.02 | Muribaculaceae_ge |
| OTU 089 | 0.00 | 0.09 | 2.83 | 0.02 | Mitribaculaceae_ge |
| OTU 094 | 0.10 | 0.04 | 2.53 | 0.04 | Enterorhabdus |
| OTU 096 | 0.02 | 0.17 | 2.97 | 0.02 | Ruminococcaceae_ge |
| OTU 111 | 0.09 | 0.02 | 2.48 | 0.04 | Lachnospiraceae_unclassified |
| OTU 120 | 0.00 | 0.06 | 2.28 | 0.02 | Lachnospiraceae_unclassified |
| OTU 126 | 0.00 | 0.01 | 2.05 | 0.04 | Lachnospiraceae_unclassified |
| OTU 128 | 0.18 | 0.00 | 2.67 | 0.02 | Lachnospiraceae_unclassified |
| OTU 136 | 0.67 | 0.00 | 2.96 | 0.02 | Faecalibaculum |
| OTU 139 | 0.09 | 0.01 | 2.63 | 0.01 | Muribaculaceae_ge |
| OTU 141 | 0.06 | 0.01 | 2.38 | 0.04 | Lachnospiraceae_unclassified |
| OTU 161 | 0.07 | 0.02 | 2.26 | 0.02 | Lachnospiraceae_unclassified |
| OTU 187 | 0.00 | 0.03 | 2.13 | 0.02 | Muribaculaceae_ge |
| OTU 199 | 0.06 | 0.02 | 2.44 | 0.004 | Lachnoclostridium |

¹Abbreviations: OTU = operational taxonomic unit;
LEfSe = linear discriminant analysis effect size;
LDA = linear discriminant analysis

TABLE 8
Significantly different OTUs (P ≤0.05) between 1^{st} and 5^{th}
cutting hay diets after the feed enrichment period (d14)
determined by LEfSe analysis in mothur. The significantly
different OTUs between the two groups are shown for the
200 most abundant OTUs in the mouse colon.

| | 1^{st} | 5^{th} | | | |
|---|---|---|---|---|---|
| | cutting | cutting | | | |
| | hay | hay | | | |
| | median | median | | | |
| | relative | relative | LDA | | |
| | abundance | abundance | score | | |
| OTU | (%) | (%) | (log 10) | P-value | Taxonomy |
| OTU 008 | 4.79 | 1.74 | 4.31 | 0.02 | Akkermansia |
| OTU 016 | 0.03 | 0.54 | 3.75 | 0.01 | Lachnospiraceae_UCG-001 |
| OTU 026 | 0.96 | 0.26 | 3.61 | 0.02 | Lachnospiraceae_NK4A136_group |
| OTU 028 | 0.75 | 0.04 | 3.28 | 0.04 | Anaeroplasma |
| OTU 029 | 0.01 | 0.07 | 3.18 | 0.02 | Lachnospiraceae_unclassified |
| OTU 032 | 0.25 | 0.17 | 2.58 | 0.02 | Bacteroides |
| OTU 036 | 0.16 | 0.02 | 3.09 | 0.04 | Lachnospiraceae_NK4A136_group |
| OTU 039 | 0.50 | 0.00 | 3.14 | 0.01 | Romboutsia |
| OTU 041 | 0.48 | 0.11 | 3.27 | 0.004 | Ruminococcus_1 |
| OTU 043 | 0.08 | 0.00 | 2.51 | 0.003 | Lachnospiraceae_NK4A136_group |
| OTU 049 | 0.00 | 0.18 | 3.25 | 0.01 | Lachnospiraceae_UCG-001 |
| OTU 055 | 0.29 | 0.00 | 2.86 | 0.01 | Clostridium_sensu_stricto_1 |
| OTU 057 | 0.79 | 0.00 | 3.63 | 0.003 | Lachnospiraceae_unclassified |
| OTU 066 | 0.00 | 0.53 | 3.23 | 0.02 | Muribaculaceae_ge |
| OTU 069 | 0.16 | 0.06 | 3.08 | 0.004 | Lachnoclostridium |
| OTU 073 | 0.00 | 0.41 | 3.12 | 0.02 | Muribaculaceae_ge |
| OTU 076 | 0.00 | 0.26 | 2.82 | 0.05 | Muribaculaceae_ge |
| OTU 084 | 0.00 | 0.16 | 2.74 | 0.02 | Muribaculaceae_ge |
| OTU 085 | 0.00 | 0.22 | 2.78 | 0.02 | Muribaculaceae_ge |
| OTU 094 | 0.00 | 0.04 | 2.08 | 0.02 | Enterorhabdus |
| OTU 105 | 0.12 | 0.00 | 2.73 | 0.01 | Lachnospiraceae_NK4A136_group |
| OTU 118 | 0.10 | 0.03 | 2.48 | 0.01 | Ruminiclostridium |
| OTU 123 | 0.13 | 0.05 | 2.64 | 0.02 | Ruminococcaceae_UCG-010 |
| OTU 124 | 0.10 | 0.03 | 2.20 | 0.02 | Ruminiclostridium_9 |
| OTU 131 | 0.00 | 0.09 | 2.59 | 0.05 | Muribaculaceae_ge |
| OTU 143 | 0.07 | 0.02 | 2.29 | 0.02 | Ruminococcaceae_unclassified |
| OTU 147 | 0.05 | 0.01 | 2.14 | 0.02 | Ruminococcaceae_UCG-014 |
| OTU 162 | 0.03 | 0.00 | 2.11 | 0.004 | Lachnospiraceae_unclassified |
| OTU 164 | 0.04 | 0.00 | 2.67 | 0.02 | Ruminococcaceae_UCG-014 |
| OTU 174 | 0.03 | 0.00 | 2.05 | 0.02 | Ruminococcaceae_UCG-014 |
| OTU 184 | 0.08 | 0.02 | 2.47 | 0.004 | Ruminococcaceae_UCG-014 |
| OTU 190 | 0.09 | 0.02 | 2.33 | 0.02 | Lachnospiraceae_unclassified |
| OTU 192 | 0.01 | 0.02 | 2.17 | 0.04 | Lachnospiraceae_unclassified |
| OTU 193 | 0.00 | 0.04 | 2.05 | 0.02 | Muribaculaceae_ge |
| OTU 200 | 0.08 | 0.01 | 2.47 | 0.02 | Clostridiales_unclassified |

¹Abbreviations: OTU = operational taxonomic unit;
LEfSe = linear discriminant analysis effect size;
LDA = linear discriminant analysis

In addition to increasing the relative abundance of highly-represented genera, feeding first cutting hay increased the relative abundance of Akkermansia (OTU 8; P=0.03) 6.6- and 2.8-fold and Anaeroplasma (OTU 28; P=0.04) compared to the control and fifth cutting hay diets, respectively (FIG. 25). In addition to changing the abundance of OTUs associated with Muribaculaceae, fifth cutting hay reduced the relative abundance of Ruminococcus (OTU 41; P=0.03) relative to control (See Table 7).

At 4 dpi, first cutting alfalfa hay caused shifts at the whole-community level that may be due to the 325 significantly different OTUs compared to control, whereas mice fed fifth cutting hay had 170 significantly different OTUs. Underlying these changes were increases to the relative abundance of highly abundant OTUs associated with Muribaculaceae (OTUs 1, 2, 3, 11, 24, 30) in mice fed first cutting hay compared to control, while fifth cutting hay only increased Muribaculaceae OTUs 1 and 18. In addition to changes to Muribaculaceae, first cutting hay increased the relative abundance of Lactobacillus (OTU 5; P=0.02) while reducing the relative abundance of Bacteroides (OTUs 6 and 32) and Oscillibacter (OTU 31) compared to control (P=0.02). This is shown in Table 9 below. While feeding fifth cutting hay did not significantly impact the composition of the whole community at 4 dpi, mice fed these diets had increased relative abundance of Parasutterella (OTU 20; P=0.02) and decreased abundance of Alistipes (OTU 9) compared to the control and first cutting hay diets (P=0.02; FIG. 25).

TABLE 9
Significantly different OTUs (P ≤0.05) between control and
first cutting hay diets at 4 dpi with Citrobacter rodentium
determined by LEfSe analysis in mothur.

| | | 1^{st} | | | |
|---|---|---|---|---|---|
| | | cutting | | | |
| | Control | hay | | | |
| | median | median | | | |
| | relative | relative | LDA | | |
| | abundance | abundance | score | | |
| OTU | (%) | (%) | (log 10) | P-value | Taxonomy |
| OTU 001 | 10.25 | 3.76 | 4.38 | 0.02 | Muribaculaceae_ge |
| OTU 002 | 17.18 | 5.43 | 4.69 | 0.02 | Muribaculaceae_ge |
| OTU 003 | 0.02 | 17.23 | 4.90 | 0.02 | Muribaculaceae_ge |
| OTU 005 | 1.84 | 8.79 | 4.55 | 0.02 | Lactobacillus |
| OTU 006 | 7.04 | 1.48 | 4.47 | 0.02 | Bacteroides |
| OTU 011 | 0.00 | 3.02 | 4.19 | 0.02 | Muribaculaceae_ge |
| OTU 020 | 0.29 | 0.22 | 2.23 | 0.04 | Parasutterella |
| OTU 021 | 0.67 | 0.03 | 3.59 | 0.02 | Bifidobacterium |
| OTU 022 | 0.75 | 0.15 | 3.40 | 0.02 | Muribaculaceae_ge |
| OTU 023 | 0.80 | 0.23 | 3.34 | 0.02 | Muribaculaceae_ge |
| OTU 024 | 0.00 | 0.94 | 3.66 | 0.02 | Muribaculaceae_ge |
| OTU 027 | 0.57 | 0.04 | 3.31 | 0.02 | Muribaculaceae_ge |
| OTU 029 | 0.00 | 0.09 | 2.78 | 0.01 | Lachnospiraceae_unclassified |
| OTU 030 | 0.00 | 0.67 | 3.51 | 0.02 | Muribaculaceae_ge |
| OTU 031 | 0.32 | 0.15 | 2.99 | 0.02 | Oscillibacter |
| OTU 032 | 0.32 | 0.08 | 3.06 | 0.02 | Bacteroides |
| OTU 037 | 0.00 | 0.66 | 3.52 | 0.02 | Muribaculaceae_ge |
| OTU 038 | 0.00 | 0.18 | 3.18 | 0.02 | Lachnospiraceae_unclassified |
| OTU 039 | 0.00 | 0.02 | 2.19 | 0.01 | Romboutsia |
| OTU 043 | 0.00 | 0.28 | 3.45 | 0.02 | Lachnospiraceae_NK4A136_group |
| OTU 045 | 0.00 | 0.26 | 3.11 | 0.01 | Muribaculaceae_ge |
| OTU 047 | 0.09 | 0.65 | 3.53 | 0.02 | Lachnospiraceae_unclassified |
| OTU 048 | 0.00 | 0.27 | 3.12 | 0.01 | Muribaculaceae_ge |
| OTU 053 | 0.00 | 0.52 | 3.41 | 0.02 | Lachnospiraceae_unclassified |
| OTU 054 | 0.00 | 0.26 | 3.04 | 0.01 | Muribaculaceae_ge |
| OTU 055 | 0.00 | 1.08 | 3.81 | 0.02 | Clostridium_sensu_stricto_1 |
| OTU 056 | 0.43 | 0.20 | 3.07 | 0.04 | Ruminiclostridium |
| OTU 057 | 0.00 | 0.61 | 3.35 | 0.02 | Lachnospiraceae_unclassified |
| OTU 059 | 0.11 | 0.29 | 2.99 | 0.04 | Lachnoclostridium |
| OTU 066 | 0.00 | 0.48 | 3.34 | 0.01 | Muribaculaceae_ge |
| OTU 068 | 0.00 | 0.22 | 3.00 | 0.01 | Muribaculaceae_ge |
| OTU 069 | 0.04 | 0.50 | 3.21 | 0.02 | Lachnoclostridium |
| OTU 070 | 0.18 | 0.05 | 2.76 | 0.02 | Muribaculaceae_ge |
| OTU 071 | 0.00 | 0.06 | 2.18 | 0.04 | Clostridiales_vadinBB60_group_ge |
| OTU 073 | 0.00 | 0.45 | 3.22 | 0.01 | Muribaculaceae_ge |
| OTU 075 | 0.00 | 0.12 | 2.98 | 0.02 | Lachnospiraceae ASF356 |
| OTU 076 | 0.00 | 0.31 | 3.13 | 0.01 | Muribaculaceae_ge |
| OTU 077 | 0.21 | 0.02 | 2.91 | 0.02 | Muribaculaceae_ge |
| OTU 078 | 0.00 | 0.22 | 2.89 | 0.01 | Muribaculaceae_ge |
| OTU 084 | 0.00 | 0.14 | 2.97 | 0.01 | Muribaculaceae_ge |
| OTU 085 | 0.00 | 0.14 | 2.99 | 0.01 | Muribaculaceae_ge |
| OTU 088 | 0.00 | 0.14 | 2.85 | 0.04 | Lachnospiraceae_unclassified |
| OTU 089 | 0.00 | 0.10 | 2.73 | 0.01 | Muribaculaceae_ge |
| OTU 093 | 0.09 | 0.03 | 2.64 | 0.02 | Lachnoclostridium |
| OTU 094 | 0.09 | 0.04 | 2.35 | 0.02 | Enterorhabdus |
| OTU 096 | 0.11 | 0.00 | 2.85 | 0.02 | Ruminococcaceae_ge |
| OTU 097 | 0.02 | 0.12 | 2.46 | 0.04 | Lachnospiraceae_unclassified |
| OTU 098 | 0.02 | 0.11 | 2.60 | 0.02 | Lachnospiraceae_unclassified |
| OTU 105 | 0.00 | 0.08 | 2.68 | 0.01 | Lachnospiraceae_NK4A136_group |
| OTU 110 | 0.11 | 0.00 | 2.69 | 0.02 | Lachnospiraceae_unclassified |
| OTU 122 | 0.03 | 0.01 | 2.30 | 0.02 | Ruminiclostridium |
| OTU 131 | 0.00 | 0.11 | 2.84 | 0.01 | Muribaculaceae_ge |
| OTU 134 | 0.00 | 0.06 | 2.14 | 0.05 | Muribaculaceae_ge |
| OTU 138 | 0.00 | 0.07 | 2.45 | 0.01 | Muribaculaceae_ge |
| OTU 139 | 0.19 | 0.00 | 2.79 | 0.04 | Muribaculaceae_ge |
| OTU 145 | 0.00 | 0.14 | 2.64 | 0.02 | Lachnospiraceae_unclassified |
| OTU 147 | 0.00 | 0.20 | 3.55 | 0.02 | Ruminococcaceae_UCG-014 |
| OTU 150 | 0.00 | 0.06 | 2.44 | 0.02 | Lachnospiraceae_unclassified |
| OTU 151 | 0.06 | 0.00 | 2.36 | 0.01 | Muribaculaceae_ge |
| OTU 156 | 0.07 | 0.00 | 2.51 | 0.01 | Muribaculaceae_ge |
| OTU 161 | 0.04 | 0.00 | 2.58 | 0.02 | Lachnospiraceae_unclassified |
| OTU 166 | 0.05 | 0.01 | 2.04 | 0.04 | Muribaculaceae_ge |
| OTU 167 | 0.00 | 0.04 | 2.16 | 0.02 | uncultured |
| OTU 170 | 0.04 | 0.00 | 2.43 | 0.02 | Muribaculaceae_unclassified |
| OTU 177 | 0.21 | 0.00 | 3.12 | 0.01 | Lachnospiraceae_unclassified |
| OTU 187 | 0.00 | 0.04 | 2.29 | 0.01 | Muribaculaceae_ge |
| OTU 195 | 0.01 | 0.04 | 2.26 | 0.02 | Lactobacillus |

¹Abbreviations: OTU = operational taxonomic unit;
LEfSe = linear discriminant analysis effect size;
LDA = linear discriminant analysis

TABLE 10
Significantly different OTUs (P ≤0.05) between control and
5^{th} cutting hay diets at 4 dpi with Citrobacter rodentium
determined by LEfSe analysis in mothur.

| | | 5^{th} | | | |
|---|---|---|---|---|---|
| | | cutting | | | |
| | Control | hay | | | |
| | median | median | | | |
| | relative | relative | LDA | | |
| | abundance | abundance | score | | |
| OTU | (%) | (%) | (log 10) | P-value | Taxonomy |
| OTU 001 | 10.25 | 17.07 | 4.48 | 0.02 | Muribaculaceae_ge |
| OTU 007 | 0.80 | 0.06 | 3.49 | 0.02 | Lachnospiraceae_NK4A136_group |
| OTU 009 | 2.92 | 0.00 | 4.16 | 0.02 | Alistipes |
| OTU 018 | 0.32 | 1.26 | 3.68 | 0.02 | Muribaculaceae_ge |
| OTU 020 | 0.29 | 0.87 | 3.48 | 0.02 | Parasutterella |
| OTU 021 | 0.67 | 0.04 | 3.59 | 0.02 | Bifidobacterium |
| OTU 038 | 0.00 | 0.12 | 2.78 | 0.02 | Lachnospiraceae_unclassified |
| OTU 039 | 0.00 | 0.42 | 3.60 | 0.01 | Romboutsia |
| OTU 040 | 0.20 | 0.04 | 2.88 | 0.04 | Lachnospiraceae_NK4A136_group |
| OTU 051 | 0.12 | 0.04 | 2.55 | 0.02 | GCA-900066575 |
| OTU 055 | 0.00 | 1.33 | 3.82 | 0.02 | Clostridium_sensu_stricto_1 |
| OTU 056 | 0.43 | 0.07 | 3.23 | 0.02 | Ruminiclostridium |
| OTU 057 | 0.00 | 0.05 | 2.90 | 0.02 | Lachnospiraceae_unclassified |
| OTU 059 | 0.11 | 0.00 | 2.74 | 0.01 | Lachnoclostridium |
| OTU 061 | 0.13 | 0.00 | 2.85 | 0.02 | Alistipes |
| OTU 064 | 0.04 | 0.01 | 2.10 | 0.04 | Lachnospiraceae_unclassified |
| OTU 065 | 0.00 | 0.30 | 3.16 | 0.04 | Lachnospiraceae_unclassified |
| OTU 071 | 0.00 | 0.09 | 2.53 | 0.04 | Clostridiales_vadinBB60_group_ge |
| OTU 093 | 0.09 | 0.02 | 2.56 | 0.02 | Lachnoclostridium |
| OTU 094 | 0.09 | 0.01 | 2.59 | 0.02 | Enterorhabdus |
| OTU 102 | 0.11 | 0.01 | 2.86 | 0.02 | Lachnospiraceae_UCG-006 |
| OTU 103 | 0.06 | 0.01 | 2.22 | 0.02 | Ruminiclostridium_9 |
| OTU 105 | 0.00 | 0.05 | 2.84 | 0.01 | Lachnospiraceae_NK4A136_group |
| OTU 109 | 0.07 | 0.00 | 2.67 | 0.04 | Ruminococcaceae_UCG-014 |
| OTU 110 | 0.11 | 0.01 | 2.59 | 0.04 | Lachnospiraceae_unclassified |
| OTU 119 | 0.00 | 0.02 | 2.04 | 0.02 | Lachnospiraceae_unclassified |
| OTU 140 | 0.06 | 0.02 | 2.37 | 0.02 | Lachnospiraceae_unclassified |
| OTU 147 | 0.00 | 0.01 | 2.56 | 0.02 | Ruminococcaceae_UCG-014 |
| OTU 157 | 0.00 | 0.69 | 3.54 | 0.01 | Ruminococcus_2 |
| OTU 173 | 0.00 | 0.03 | 3.51 | 0.05 | Ruminococcaceae_UCG-014 |
| OTU 177 | 0.21 | 0.00 | 3.12 | 0.02 | Lachnospiraceae_unclassified |
| OTU 195 | 0.01 | 0.03 | 2.31 | 0.04 | Lactobacillus |

¹Abbreviations: OTU = operational taxonomic unit;
LEfSe = linear discriminant analysis effect size;
LDA = linear discriminant analysis

TABLE 11
Significantly different OTUs (P ≤0.05) between 1^{st} and 5^{th}
cutting hay diets at 4 dpi with Citrobacter rodentium
determined by LEfSe analysis in mothur.

| | 1^{st} | 5^{th} | | | |
|---|---|---|---|---|---|
| | cutting | cutting | | | |
| | hay | hay | | | |
| | median | median | | | |
| | relative | relative | LDA | | |
| | abundance | abundance | score | | |
| OTU | (%) | (%) | (log 10) | P-value | Taxonomy |
| OTU 001 | 3.76 | 17.07 | 4.75 | 0.02 | Muribaculaceae_ge |
| OTU 002 | 5.43 | 16.15 | 4.70 | 0.02 | Muribaculaceae_ge |
| OTU 003 | 17.23 | 0.02 | 4.95 | 0.02 | Muribaculaceae_ge |
| OTU 007 | 1.07 | 0.06 | 3.62 | 0.02 | Lachnospiraceae_NK4A136_group |
| OTU 009 | 3.58 | 0.00 | 4.21 | 0.02 | Alistipes |
| OTU 011 | 3.02 | 0.00 | 4.20 | 0.01 | Muribaculaceae_ge |
| OTU 013 | 1.04 | 2.73 | 3.92 | 0.04 | Turicibacter |
| OTU 018 | 0.23 | 1.26 | 3.70 | 0.02 | Muribaculaceae_ge |
| OTU 020 | 0.22 | 0.87 | 3.51 | 0.02 | Parasutterella |
| OTU 022 | 0.15 | 0.92 | 3.63 | 0.02 | Muribaculaceae_ge |
| OTU 023 | 0.23 | 0.64 | 3.32 | 0.04 | Muribaculaceae_ge |
| OTU 024 | 0.94 | 0.00 | 3.69 | 0.02 | Muribaculaceae_ge |
| OTU 025 | 0.27 | 0.11 | 2.91 | 0.02 | Lachnospiraceae A2 |
| OTU 027 | 0.04 | 0.73 | 3.53 | 0.02 | Muribaculaceae_ge |
| OTU 029 | 0.09 | 0.00 | 2.76 | 0.01 | Lachnospiraceae_unclassified |
| OTU 030 | 0.67 | 0.00 | 3.55 | 0.02 | Muribaculaceae_ge |
| OTU 037 | 0.66 | 0.00 | 3.53 | 0.01 | Muribaculaceae_ge |
| OTU 039 | 0.02 | 0.42 | 3.59 | 0.02 | Romboutsia |
| OTU 045 | 0.26 | 0.00 | 3.15 | 0.01 | Muribaculaceae_ge |
| OTU 047 | 0.65 | 0.08 | 3.43 | 0.02 | Lachnospiraceae_unclassified |
| OTU 048 | 0.27 | 0.00 | 3.15 | 0.01 | Muribaculaceae_ge |
| OTU 054 | 0.26 | 0.00 | 3.12 | 0.01 | Muribaculaceae_ge |
| OTU 056 | 0.20 | 0.07 | 2.83 | 0.04 | Ruminiclostridium |
| OTU 057 | 0.61 | 0.05 | 3.16 | 0.04 | Lachnospiraceae_unclassified |
| OTU 059 | 0.29 | 0.00 | 3.14 | 0.01 | Lachnoclostridium |
| OTU 060 | 0.08 | 0.00 | 2.76 | 0.02 | Lachnospiraceae_unclassified |
| OTU 061 | 0.20 | 0.00 | 3.01 | 0.02 | Alistipes |
| OTU 066 | 0.48 | 0.00 | 3.37 | 0.01 | Muribaculaceae_ge |
| OTU 068 | 0.22 | 0.00 | 3.08 | 0.01 | Muribaculaceae_ge |
| OTU 069 | 0.50 | 0.14 | 3.26 | 0.02 | Lachnoclostridium |
| OTU 070 | 0.05 | 0.23 | 3.10 | 0.02 | Muribaculaceae_ge |
| OTU 073 | 0.45 | 0.00 | 3.29 | 0.01 | Muribaculaceae_ge |
| OTU 075 | 0.12 | 0.03 | 2.75 | 0.02 | Lachnospiraceae ASF356 |
| OTU 076 | 0.31 | 0.00 | 3.14 | 0.01 | Muribaculaceae_ge |
| OTU 077 | 0.02 | 0.21 | 3.03 | 0.02 | Muribaculaceae_ge |
| OTU 078 | 0.22 | 0.00 | 2.98 | 0.01 | Muribaculaceae_ge |
| OTU 084 | 0.14 | 0.00 | 2.93 | 0.01 | Muribaculaceae_ge |
| OTU 085 | 0.14 | 0.00 | 2.96 | 0.01 | Muribaculaceae_ge |
| OTU 088 | 0.14 | 0.03 | 2.77 | 0.02 | Lachnospiraceae_unclassified |
| OTU 089 | 0.10 | 0.00 | 2.73 | 0.01 | Muribaculaceae_ge |
| OTU 094 | 0.04 | 0.01 | 2.25 | 0.02 | Enterorhabdus |
| OTU 097 | 0.12 | 0.07 | 2.22 | 0.04 | Lachnospiraceae_unclassified |
| OTU 098 | 0.11 | 0.05 | 2.39 | 0.04 | Lachnospiraceae_unclassified |
| OTU 102 | 0.06 | 0.01 | 2.60 | 0.02 | Lachnospiraceae_UCG-006 |
| OTU 104 | 0.09 | 0.01 | 2.16 | 0.04 | Eggerthellaceae_unclassified |
| OTU 107 | 0.07 | 0.00 | 2.50 | 0.02 | Lachnospiraceae A2 |
| OTU 109 | 0.04 | 0.00 | 2.21 | 0.02 | Ruminococcaceae_UCG-014 |
| OTU 110 | 0.00 | 0.01 | 2.03 | 0.04 | Lachnospiraceae_unclassified |
| OTU 119 | 0.00 | 0.02 | 2.01 | 0.04 | Lachnospiraceae_unclassified |
| OTU 121 | 0.00 | 0.06 | 2.38 | 0.02 | Lachnospiraceae_unclassified |
| OTU 130 | 0.04 | 0.00 | 2.19 | 0.01 | Lachnospiraceae_unclassified |
| OTU 131 | 0.11 | 0.00 | 2.80 | 0.01 | Muribaculaceae_ge |
| OTU 134 | 0.06 | 0.00 | 2.31 | 0.05 | Muribaculaceae_ge |
| OTU 138 | 0.07 | 0.00 | 2.54 | 0.01 | Muribaculaceae_ge |
| OTU 145 | 0.14 | 0.02 | 2.71 | 0.04 | Lachnospiraceae_unclassified |
| OTU 147 | 0.20 | 0.01 | 3.37 | 0.04 | Ruminococcaceae_UCG-014 |
| OTU 151 | 0.00 | 0.07 | 2.55 | 0.01 | Muribaculaceae_ge |
| OTU 152 | 0.05 | 0.01 | 2.18 | 0.02 | uncultured |
| OTU 155 | 0.05 | 0.01 | 2.27 | 0.02 | Clostridiales_unclassified |
| OTU 156 | 0.00 | 0.10 | 2.79 | 0.01 | Muribaculaceae_ge |
| OTU 157 | 0.00 | 0.69 | 3.54 | 0.01 | Ruminococcus_2 |
| OTU 166 | 0.01 | 0.05 | 2.18 | 0.02 | Muribaculaceae_ge |
| OTU 167 | 0.04 | 0.01 | 2.42 | 0.02 | uncultured |
| OTU 173 | 0.00 | 0.03 | 3.51 | 0.05 | Ruminococcaceae_UCG-014 |
| OTU 182 | 0.01 | 0.05 | 2.35 | 0.02 | Muribaculaceae_ge |
| OTU 187 | 0.04 | 0.00 | 2.33 | 0.02 | Muribaculaceae_ge |

¹Abbreviations: OTU = operational taxonomic unit;
LEfSe = linear discriminant analysis effect size;
LDA = linear discriminant analysis

In contrast with other timepoints, diets containing either cutting of hay did not result in significant shifts to overall communities relative to control at 14 dpi; however, feeding fifth cutting hay resulted in 341 significantly different OTUs compared to control and first cutting only altered 137 OTUs. Feeding first cutting alfalfa decreased the relative abundance of Bacteroides (OTU 32; P=0.04), relative to control and Dobusiella (OTU 3) compared to both the control and fifth cutting hay (P=0.02). These results are shown in Tables 12-14 below.

TABLE 12
Significantly different OTUs (P ≤0.05) between control and
1^{st} cutting hay diets at 14 dpi with Citrobacter rodentium
determined by LEfSe analysis in mothur.

| | | 1^{st} | | | |
|---|---|---|---|---|---|
| | | cutting | | | |
| | Control | hay | | | |
| | median | median | | | |
| | relative | relative | LDA | | |
| | abundance | abundance | score | | |
| OTU | (%) | (%) | (log 10) | P-value | Taxonomy |
| OTU 003 | 0.02 | 1.68 | 3.92 | 0.02 | Muribaculaceae_ge |
| OTU 004 | 0.04 | 0.02 | 2.10 | 0.02 | Dubosiella |
| OTU 008 | 7.58 | 0.03 | 4.70 | 0.02 | Akkermansia |
| OTU 024 | 0.00 | 0.16 | 2.89 | 0.01 | Muribaculaceae_ge |
| OTU 032 | 0.65 | 0.16 | 3.48 | 0.04 | Bacteroides |
| OTU 038 | 1.10 | 0.11 | 3.56 | 0.04 | Lachnospiraceae_unclassified |
| OTU 045 | 0.00 | 0.20 | 2.99 | 0.05 | Aluribaculaceae_ge |
| OTU 048 | 0.00 | 0.19 | 2.97 | 0.05 | Muribaculaceae_ge |
| OTU 054 | 0.00 | 0.14 | 2.84 | 0.05 | Muribaculaceae_ge |
| OTU 068 | 0.00 | 0.10 | 2.71 | 0.05 | Muribaculaceae_ge |
| OTU 078 | 0.00 | 0.08 | 2.60 | 0.01 | Muribaculaceae_ge |
| OTU 081 | 0.03 | 0.00 | 2.98 | 0.04 | Roseburia |
| OTU 089 | 0.00 | 0.09 | 2.65 | 0.05 | Muribaculaceae_ge |
| OTU 104 | 0.03 | 0.10 | 2.68 | 0.02 | Eggerthellaceae_unclassified |
| OTU 125 | 0.11 | 0.00 | 2.85 | 0.01 | Akkermansia |
| OTU 134 | 0.00 | 0.05 | 2.41 | 0.05 | Muribaculaceae_ge |
| OTU 144 | 0.06 | 0.00 | 2.52 | 0.01 | Lachnoclostridium |
| OTU 156 | 0.03 | 0.00 | 2.14 | 0.05 | Muribaculaceae_ge |

¹Abbreviations: OTU = operational taxonomic unit;
LEfSe = linear discriminant analysis effect size;
LDA = linear discriminant analysis

TABLE 13
Significantly different OTUs (P ≤0.05) between control and
5^{th} cutting hay diets at 14 dpi with Citrobacter rodentium
determined by LEfSe analysis in mothur.

| | | 5^{th} | | | |
|---|---|---|---|---|---|
| | | cutting | | | |
| | Control | hay | | | |
| | median | median | | | |
| | relative | relative | LDA | | |
| | abundance | abundance | score | | |
| OTU | (%) | (%) | (log 10) | P-value | Taxonomy |
| OTU 003 | 0.02 | 1.51 | 3.22 | 0.02 | Muribaculaceae_ge |
| OTU 007 | 11.71 | 3.19 | 4.58 | 0.04 | Lachnospiraceae_NK4A136_group |
| OTU 008 | 7.58 | 0.02 | 4.70 | 0.04 | Akkermansia |
| OTU 011 | 0.22 | 0.00 | 3.14 | 0.02 | Muribaculaceae_ge |
| OTU 013 | 0.14 | 1.92 | 4.22 | 0.02 | Turicibacter |
| OTU 016 | 0.06 | 7.04 | 4.63 | 0.02 | Lachnospiraceae_UCG-001 |
| OTU 019 | 1.38 | 0.25 | 3.70 | 0.04 | Lachnospiraceae_unclassified |
| OTU 021 | 0.00 | 0.05 | 3.65 | 0.02 | Bifidobacterium |
| OTU 025 | 1.22 | 0.02 | 3.62 | 0.02 | Lachnospiraceae A2 |
| OTU 031 | 0.07 | 0.60 | 3.36 | 0.04 | Oscillibacter |
| OTU 033 | 0.70 | 0.06 | 3.54 | 0.02 | Lachnospiraceae_NK4A136_group |
| OTU 036 | 0.00 | 0.09 | 2.38 | 0.04 | Lachnospiraceae_NK4A136_group |
| OTU 038 | 1.10 | 0.00 | 3.61 | 0.02 | Lachnospiraceae_unclassified |
| OTU 040 | 0.03 | 0.00 | 2.21 | 0.04 | Lachnospiraceae_NK4A136_group |
| OTU 047 | 0.00 | 0.06 | 3.49 | 0.04 | Lachnospiraceae_unclassified |
| OTU 049 | 0.01 | 2.22 | 4.09 | 0.02 | Lachnospiraceae_UCG-001 |
| OTU 051 | 0.49 | 0.14 | 3.27 | 0.02 | GCA-900066575 |
| OTU 052 | 0.54 | 0.16 | 3.67 | 0.02 | Erysipelatoclostridium |
| OTU 055 | 0.00 | 0.04 | 2.39 | 0.01 | Clostridium_sensu_stricto_1 |
| OTU 058 | 0.50 | 0.04 | 3.24 | 0.02 | Lachnospiraceae_unclassified |
| OTU 069 | 0.00 | 0.02 | 2.74 | 0.02 | Lachnoclostridium |
| OTU 076 | 0.01 | 0.00 | 2.19 | 0.05 | Mitribaculaceae_ge |
| OTU 082 | 0.07 | 0.16 | 2.86 | 0.02 | uncultured |
| OTU 090 | 0.02 | 0.23 | 2.88 | 0.02 | Lachnospiraceae_unclassified |
| OTU 104 | 0.03 | 0.12 | 2.66 | 0.02 | Eggerthellaceae_unclassified |
| OTU 105 | 0.00 | 0.14 | 2.85 | 0.05 | Lachnospiraceae_NK4A136_group |
| OTU 110 | 0.04 | 0.15 | 3.21 | 0.02 | Lachnospiraceae_unclassified |
| OTU 112 | 0.11 | 0.06 | 2.54 | 0.02 | Lachnospiraceae_unclassified |
| OTU 114 | 0.26 | 0.06 | 2.88 | 0.02 | GCA-900066575 |
| OTU 119 | 0.00 | 0.29 | 3.42 | 0.02 | Lachnospiraceae_unclassified |
| OTU 121 | 0.00 | 0.08 | 3.30 | 0.01 | Lachnospiraceae_unclassified |
| OTU 132 | 0.01 | 0.08 | 2.30 | 0.02 | Muribaculaceae_ge |
| OTU 135 | 0.04 | 0.00 | 2.25 | 0.02 | Intestinimonas |
| OTU 137 | 0.01 | 0.18 | 2.68 | 0.02 | Lachnospiraceae_unclassified |
| OTU 144 | 0.06 | 0.00 | 2.52 | 0.01 | Lachnoclostridium |
| OTU 148 | 0.12 | 0.00 | 2.62 | 0.02 | Lachnospiraceae_unclassified |
| OTU 150 | 0.00 | 0.06 | 2.65 | 0.02 | Lachnospiraceae_unclassified |
| OTU 152 | 0.03 | 0.00 | 2.04 | 0.02 | uncultured |
| OTU 156 | 0.03 | 0.00 | 2.14 | 0.05 | Muribaculaceae_ge |
| OTU 161 | 0.00 | 0.02 | 2.04 | 0.04 | Lachnospiraceae_unclassified |
| OTU 162 | 0.04 | 0.19 | 2.81 | 0.02 | Lachnospiraceae_unclassified |
| OTU 167 | 0.00 | 0.11 | 2.79 | 0.02 | uncultured |
| OTU 168 | 0.13 | 0.02 | 2.67 | 0.04 | Lachnospiraceae_NK4A136_group |
| OTU 178 | 0.03 | 0.15 | 2.71 | 0.02 | Ruminiclostridium_5 |
| OTU 180 | 0.05 | 0.00 | 3.04 | 0.04 | Clostridiales_vadinBB60_group_ge |
| OTU 181 | 0.02 | 0.10 | 2.70 | 0.02 | Oscillibacter |
| OTU 183 | 0.00 | 0.18 | 3.01 | 0.02 | Lachnospiraceae_UCG-006 |

¹Abbreviations: OTU = operational taxonomic unit;
LEfSe = linear discriminant analysis effect size;
LDA = linear discriminant analysis

TABLE 14
Significantly different OTUs (P ≤0.05) between 1^{st} and 5^{th}
cutting hay diets at 14 dpi with Citrobacter rodentium
determined by LEfSe analysis in mothur.

| | 1^{st} | 5^{th} | | | |
|---|---|---|---|---|---|
| | cutting | cutting | | | |
| | hay | hay | | | |
| | median | median | | | |
| | relative | relative | LDA | | |
| | abundance | abundance | score | | |
| OTU | (%) | (%) | (log 10) | P-value | Taxonomy |
| OTU 004 | 0.02 | 0.05 | 2.94 | 0.04 | Dubosiella |
| OTU 011 | 0.59 | 0.00 | 3.31 | 0.02 | Muribaculaceae_ge |
| OTU 016 | 0.02 | 7.04 | 4.63 | 0.02 | Lachnospiraceae_UCG-001 |
| OTU 021 | 0.00 | 0.05 | 3.65 | 0.02 | Bifidobacterium |
| OTU 025 | 0.33 | 0.02 | 3.48 | 0.02 | Lachnospiraceae A2 |
| OTU 029 | 0.59 | 0.01 | 3.56 | 0.04 | Lachnospiraceae_unclassified |
| OTU 036 | 0.00 | 0.09 | 2.40 | 0.04 | Lachnospiraceae_NK4A136_group |
| OTU 040 | 0.27 | 0.00 | 3.25 | 0.02 | Lachnospiraceae_NK4A136_group |
| OTU 047 | 0.00 | 0.06 | 3.49 | 0.02 | Lachnospiraceae_unclassified |
| OTU 049 | 0.00 | 2.22 | 4.10 | 0.02 | Lachnospiraceae_UCG-001 |
| OTU 053 | 0.00 | 0.01 | 2.09 | 0.05 | Lachnospiraceae_unclassified |
| OTU 081 | 0.00 | 0.26 | 3.12 | 0.02 | Roseburia |
| OTU 090 | 0.04 | 0.23 | 2.77 | 0.04 | Lachnospiraceae_unclassified |
| OTU 097 | 0.00 | 0.07 | 2.54 | 0.04 | Lachnospiraceae_unclassified |
| OTU 099 | 0.00 | 0.30 | 3.17 | 0.05 | Lachnospiraceae_NK4A136_group |
| OTU 111 | 0.10 | 0.00 | 2.75 | 0.02 | Lachnospiraceae_unclassified |
| OTU 118 | 0.00 | 0.08 | 2.06 | 0.01 | Ruminiclostridium |
| OTU 119 | 0.00 | 0.29 | 3.42 | 0.02 | Lachnospiraceae_unclassified |
| OTU 121 | 0.00 | 0.08 | 3.30 | 0.02 | Lachnospiraceae_unclassified |
| OTU 132 | 0.02 | 0.08 | 2.26 | 0.04 | Muribaculaceae_ge |
| OTU 134 | 0.05 | 0.00 | 2.24 | 0.05 | Muribaculaceae_ge |
| OTU 135 | 0.04 | 0.00 | 2.44 | 0.02 | Intestinimonas |
| OTU 137 | 0.00 | 0.18 | 2.71 | 0.04 | Lachnospiraceae_unclassified |
| OTU 138 | 0.04 | 0.00 | 2.15 | 0.05 | Muribaculaceae_ge |
| OTU 150 | 0.00 | 0.06 | 2.65 | 0.02 | Lachnospiraceae_unclassified |
| OTU 155 | 0.01 | 0.00 | 2.96 | 0.05 | Clostridiales_unclassified |
| OTU 161 | 0.00 | 0.02 | 2.01 | 0.02 | Lachnospiraceae_unclassified |
| OTU 162 | 0.01 | 0.19 | 2.85 | 0.02 | Lachnospiraceae_unclassified |
| OTU 167 | 0.00 | 0.11 | 2.79 | 0.02 | uncultured |
| OTU 178 | 0.01 | 0.15 | 2.84 | 0.02 | Ruminiclostridium_5 |
| OTU 180 | 0.07 | 0.00 | 2.67 | 0.04 | Clostridiales_vadinBB60_group_ge |
| OTU 183 | 0.03 | 0.18 | 2.94 | 0.04 | Lachnospiraceae_UCG-006 |
| OTU 199 | 0.09 | 0.00 | 2.86 | 0.05 | Lachnoclostridium |

¹Abbreviations: OTU = operational taxonomic unit;
LEfSe = linear discriminant analysis effect size;
LDA = linear discriminant analysis

Feeding fifth cutting hay increased the relative abundance of Turicibacter (OTU 13; P=0.02) by 13.7-fold compared to control and Bifidobacterium (OTU 21) compared to both the control and first cutting hay (P=0.02; FIG. 25).

In the last timepoint of infection, mice fed first cutting hay had 181 significantly different OTUs compared to control while those fed fifth cutting differed from control by 161 OTUs. Only minor changes to Muribaculaceae were observed at this time during the infection, with first cutting hay increasing the relative abundance of Muribaculaceae OTU 3 (P=0.02; FIG. 25). Feeding first cutting hay increased relative abundance of Ruminococcus (OTU 41; P=0.02) compared to control accompanied with a reduction in Anaeroplasma (OTU 28; P=0.04). Mice fed fifth cutting hay had increased relative abundance of Romboutsia (OTU 39) compared to control and first cutting hay (P=0.02). These results are shown in Tables 15-17 below. Interestingly, while no differences in Turicibacter (OTU 13) were observed between first or fifth cutting hay and the control, mice fed fifth cutting hay had increased relative abundance of this OTU 2.5-fold compared to mice fed first cutting (FIG. 25).

TABLE 15
Significantly different OTUs (P ≤0.05) between control and
1^{st} cutting hay diets at 21 dpi with Citrobacter rodentium
determined by LEfSe analysis in mothur.

| | | 1^{st} | | | |
|---|---|---|---|---|---|
| | | cutting | | | |
| | Control | hay | | | |
| | median | median | | | |
| | relative | relative | LDA | | |
| | abundance | abundance | score | | |
| OTU | (%) | (%) | (log 10) | P-value | Taxonomy |
| OTU 003 | 16.92 | 19.75 | 4.56 | 0.02 | Muribaculaceae_ge |
| OTU 004 | 1.11 | 11.24 | 4.46 | 0.02 | Dubosiella |
| OTU 007 | 2.56 | 0.77 | 4.47 | 0.02 | Lachnospiraceae_NK4A136_group |
| OTU 010 | 0.61 | 0.00 | 3.51 | 0.02 | Muribaculaceae_ge |
| OTU 011 | 1.74 | 4.04 | 3.98 | 0.02 | Muribaculaceae_ge |
| OTU 020 | 0.29 | 0.54 | 3.26 | 0.04 | Parasutterella |
| OTU 021 | 0.44 | 0.13 | 3.41 | 0.02 | Bifidobacterium |
| OTU 028 | 0.23 | 0.02 | 3.32 | 0.04 | Anaeroplasma |
| OTU 029 | 0.49 | 0.06 | 3.47 | 0.02 | Lachnospiraceae_unclassified |
| OTU 035 | 0.11 | 0.08 | 2.47 | 0.04 | Lachnoclostridium |
| OTU 040 | 0.55 | 0.25 | 3.39 | 0.02 | Lachnospiraceae_NK4A136_group |
| OTU 041 | 0.00 | 0.04 | 2.96 | 0.02 | Ruminococcus_1 |
| OTU 042 | 0.17 | 0.06 | 3.02 | 0.02 | Ruminiclostridium_5 |
| OTU 046 | 0.17 | 0.07 | 2.83 | 0.02 | uncultured |
| OTU 050 | 0.17 | 0.01 | 2.83 | 0.02 | uncultured |
| OTU 055 | 0.00 | 0.01 | 2.92 | 0.02 | Clostridium_sensu_stricto_1 |
| OTU 059 | 0.13 | 0.05 | 3.08 | 0.02 | Lachnoclostridium |
| OTU 066 | 0.26 | 0.64 | 3.22 | 0.02 | Muribaculaceae_ge |
| OTU 072 | 0.00 | 0.01 | 3.61 | 0.01 | Mollicutes_RF39_ge |
| OTU 073 | 0.23 | 0.49 | 3.11 | 0.02 | Muribaculaceae_ge |
| OTU 076 | 0.15 | 0.36 | 2.53 | 0.02 | Muribaculaceae_ge |
| OTU 087 | 0.06 | 0.03 | 2.45 | 0.02 | uncultured |
| OTU 092 | 0.05 | 0.08 | 2.00 | 0.04 | Ruminiclostridium_9 |
| OTU 101 | 0.01 | 0.21 | 2.83 | 0.02 | Dubosiella |
| OTU 107 | 0.04 | 0.01 | 2.31 | 0.04 | Lachnospiraceae A2 |
| OTU 109 | 0.00 | 0.00 | 2.41 | 0.01 | Ruminococcaceae_UCG-014 |
| OTU 111 | 0.05 | 0.04 | 2.45 | 0.02 | Lachnospiraceae_unclassified |
| OTU 113 | 0.04 | 0.01 | 2.28 | 0.02 | Anaerotruncus |
| OTU 115 | 0.02 | 0.00 | 2.03 | 0.04 | Muribaculaceae_ge |
| OTU 121 | 0.00 | 0.08 | 2.26 | 0.05 | Lachnospiraceae_unclassified |
| OTU 131 | 0.04 | 0.15 | 2.80 | 0.02 | Muribaculaceae_ge |
| OTU 181 | 0.02 | 0.01 | 2.04 | 0.04 | Oscillibacter |
| OTU 184 | 0.00 | 0.00 | 2.54 | 0.01 | Ruminococcaceae_UCG-014 |

¹Abbreviations: OTU = operational taxonomic unit;
LEfSe = linear discriminant analysis effect size;
LDA = linear discriminant analysis

TABLE 16
Significantly different OTUs (P ≤0.05) between control and
5^{th} cutting hay diets at 21 dpi with Citrobacter rodentium
determined by LEfSe analysis in mothur.

| | | 5^{th} | | | |
|---|---|---|---|---|---|
| | | cutting | | | |
| | Control | hay | | | |
| | median | median | | | |
| | relative | relative | LDA | | |
| | abundance | abundance | score | | |
| OTU | (%) | (%) | (log 10) | P-value | Taxonomy |
| OTU 007 | 2.56 | 0.77 | 4.45 | 0.02 | Lachnospiraceae_NK4A136_group |
| OTU 010 | 0.61 | 0.00 | 3.51 | 0.02 | Muribaculaceae_ge |
| OTU 011 | 1.74 | 4.04 | 4.13 | 0.02 | Muribaculaceae_ge |
| OTU 020 | 0.29 | 0.54 | 3.20 | 0.02 | Parasutterella |
| OTU 021 | 0.44 | 0.13 | 3.38 | 0.02 | Bifidobacterium |
| OTU 029 | 0.49 | 0.06 | 3.43 | 0.02 | Lachnospiraceae_unclassified |
| OTU 039 | 0.01 | 0.28 | 3.13 | 0.02 | Romboutsia |
| OTU 040 | 0.55 | 0.25 | 3.25 | 0.04 | Lachnospiraceae_NK4A136_group |
| OTU 047 | 0.00 | 0.00 | 2.41 | 0.05 | Lachnospiraceae_unclassified |
| OTU 063 | 0.13 | 0.03 | 2.81 | 0.02 | Lachnospiraceae_NK4A136_group |
| OTU 066 | 0.26 | 0.64 | 3.36 | 0.02 | Muribaculaceae_ge |
| OTU 073 | 0.23 | 0.49 | 3.24 | 0.02 | Muribaculaceae_ge |
| OTU 076 | 0.15 | 0.36 | 3.08 | 0.02 | Muribaculaceae_ge |
| OTU 079 | 0.13 | 0.07 | 2.70 | 0.02 | Ruminiclostridium_9 |
| OTU 093 | 0.06 | 0.02 | 2.40 | 0.04 | Lachnoclostridium |
| OTU 096 | 0.00 | 0.16 | 2.90 | 0.04 | Ruminococcaceae_ge |
| OTU 101 | 0.01 | 0.21 | 2.84 | 0.04 | Dubosiella |
| OTU 102 | 0.04 | 0.01 | 2.38 | 0.02 | Lachnospiraceae_UCG-006 |
| OTU 107 | 0.04 | 0.01 | 2.36 | 0.02 | Lachnospiraceae A2 |
| OTU 110 | 0.02 | 0.12 | 2.92 | 0.02 | Lachnospiraceae_unclassified |
| OTU 119 | 0.00 | 0.14 | 2.85 | 0.02 | Lachnospiraceae_unclassified |
| OTU 127 | 0.03 | 0.01 | 2.15 | 0.04 | Oscillibacter |
| OTU 131 | 0.04 | 0.15 | 2.80 | 0.02 | Muribaculaceae_ge |
| OTU 132 | 0.06 | 0.00 | 2.39 | 0.05 | Muribaculaceae_ge |
| OTU 134 | 0.06 | 0.17 | 2.66 | 0.04 | Muribaculaceae_ge |
| OTU 144 | 0.05 | 0.00 | 2.26 | 0.02 | Lachnoclostridium |
| OTU 150 | 0.01 | 0.00 | 2.20 | 0.05 | Lachnospiraceae_unclassified |

¹Abbreviations: OTU = operational taxonomic unit;
LEfSe = linear discriminant analysis effect size;
LDA = linear discriminant analysis

TABLE 17
Significantly different OTUs (P ≤0.05) between 1^{st} and 5^{th}
cutting hay diets at 21 dpi with Citrobacter rodentium
determined by LEfSe analysis in mothur.

| | 1^{st} | 5^{th} | | | |
|---|---|---|---|---|---|
| | cutting | cutting | | | |
| | hay | hay | | | |
| | median | median | | | |
| | relative | relative | LDA | | |
| | abundance | abundance | score | | |
| OTU | (%) | (%) | (log 10) | P-value | Taxonomy |
| OTU 013 | 0.17 | 0.43 | 3.15 | 0.02 | Turicibacter |
| OTU 019 | 0.04 | 0.13 | 2.80 | 0.04 | Lachnospiraceae_unclassified |
| OTU 039 | 0.05 | 0.28 | 3.09 | 0.02 | Romboutsia |
| OTU 046 | 0.00 | 0.07 | 2.53 | 0.02 | uncultured |
| OTU 055 | 0.37 | 0.01 | 3.14 | 0.02 | Clostridium_sensu_stricto_1 |
| OTU 059 | 0.01 | 0.05 | 2.34 | 0.02 | Lachnoclostridium |
| OTU 060 | 0.01 | 0.06 | 2.65 | 0.04 | Lachnospiraceae_unclassified |
| OTU 072 | 0.44 | 0.01 | 3.49 | 0.02 | Mollicutes_RF39_ge |
| OTU 081 | 0.01 | 0.00 | 2.02 | 0.02 | Roseburia |
| OTU 088 | 0.02 | 0.09 | 2.55 | 0.02 | Lachnospiraceae_unclassified |
| OTU 096 | 0.00 | 0.16 | 2.91 | 0.02 | Ruminococcaceae_ge |
| OTU 103 | 0.01 | 0.06 | 2.32 | 0.04 | Ruminiclostridium_9 |
| OTU 109 | 0.04 | 0.00 | 2.35 | 0.02 | Ruminococcaceae_UCG-014 |
| OTU 110 | 0.01 | 0.12 | 2.91 | 0.02 | Lachnospiraceae_unclassified |
| OTU 119 | 0.00 | 0.14 | 2.84 | 0.02 | Lachnospiraceae_unclassified |
| OTU 184 | 0.05 | 0.00 | 2.49 | 0.02 | Ruminococcaceae_UCG-014 |

¹Abbreviations: OTU = operational taxonomic unit;
LEfSe = linear discriminant analysis effect size;
LDA = linear discriminant analysis

Aqueous Extracts

At a whole community level, feeding fifth cutting aqueous extracts resulted in differences between whole communities compared to control and first cutting aqueous extract after 14 d of feeding enrichment (P=0.05 and 0.04, respectively). In the first 4 d post-inoculation, both aqueous extracts had different whole microbial communities compared to control, with additional differences between first and fifth cutting extracts (P=0.03). In the last timepoint of the infection (21 dpi) mice fed fifth cutting aqueous extract had a different microbial composition compared to control and first cutting aqueous extract (P=0.03), as shown in Table 18.

TABLE 18
Whole-community ANOSIM¹ comparisons of the colon
microbiota in mice fed the control and diets supplemented with
aqueous extracts of first and fifth cutting alfalfa

| Comparison | R-va1ue2 | P-va1ue3 |
|---|---|---|
| Control vs. 1st Cut Aqueous Extract | | |
| d14 (baseline) | 0.12 | 0.13 |
| 4 dpi | 1.00 | 0.03 |
| 14 dpi | −0.08 | 0.75 |
| 21 dpi | 0.24 | 0.11 |
| Control vs. 5th Cut Aqueous Extract | | |
| d14 (baseline) | 0.24 | 0.05 |
| 4 dpi | 0.55 | 0.03 |
| 14 dpi | −0.07 | 0.55 |
| 21 dpi | 0.51 | 0.03 |
| 1st Cut Aqueous vs. 5th Cut Aqueous Extract | | |
| d14 (baseline) | 0.14 | 0.14 |
| 4 dpi | 0.71 | 0.03 |
| 14 dpi | −0.06 | 0.52 |
| 21 dpi | 0.72 | 0.03 |

¹Analysis of similarity performed using mothur (v.1.40.04)
2R-values detail the source of sample variations on a scale of −1 to 1. Values closer to −1 suggest higher variation between within samples while those closer to 1 suggest higher variation between samples. R-values close to 0 indicate no differences in variation.
3Significance determined at P ≤0.05.

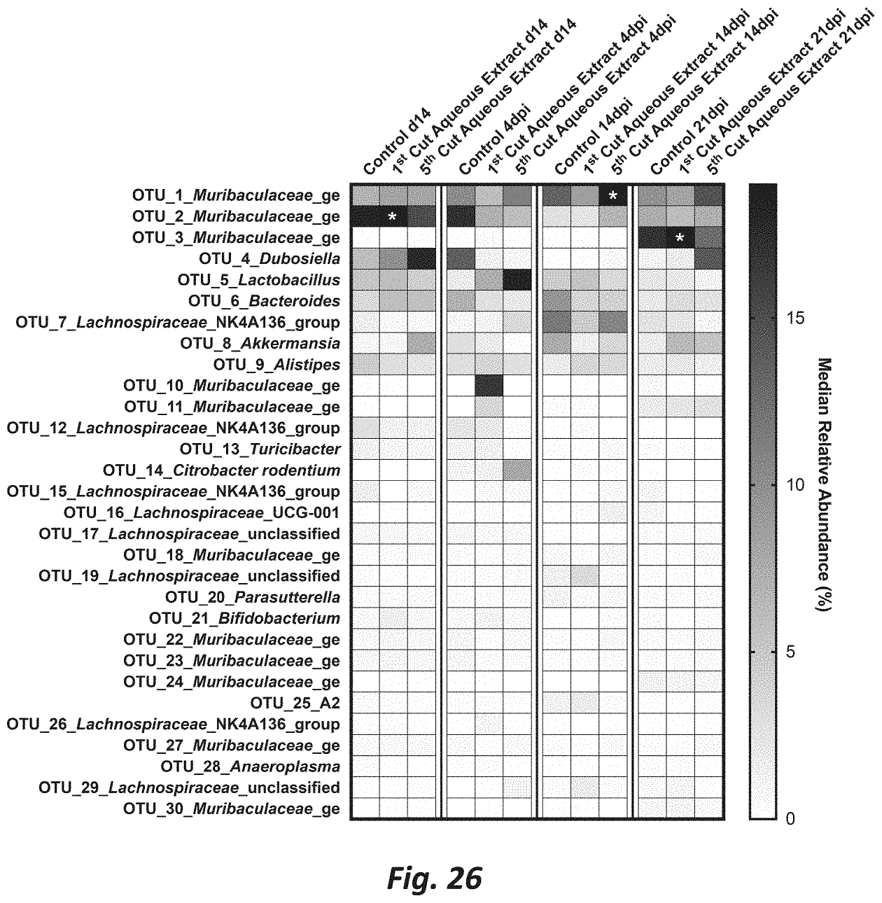

OTU-level analysis at a baseline health state (d14) showed that mice fed first cutting aqueous extracts had 109 significantly different OTUs compared to control, whereas mice fed fifth cutting aqueous extract had 138 significantly different OTUs. Minor changes to the colon microbiota were observed at this timepoint with first and fifth cutting aqueous extracts increasing the relative abundance of Lachnospiraceae OTUs 15 and 12, respectively (P=0.05 and 0.04, respectively). Similar to ground hay diets, a heatmap of the 30 most abundant OTUs in the colons of mice fed the control and both aqueous extract diets is presented in FIG. 26. Complete results of the LEfSe analysis for the 200 most abundant OTUs in mice fed aqueous extract diets is presented in Tables 19-30.

At 4 dpi, mice fed first cutting aqueous extract had 334 significantly different OTUs from the control, while mice fed fifth cutting alfalfa had 169 different OTUs. Compared to the control, first cutting aqueous extract increased the relative abundance of OTUs associated with Muribaculaceae (OTUs 3, 10, 11, and 24) and Lachnospiraceae (OTUs 38, 43, and 47) while fifth cutting only increased Lachnospiraceae (OTUs 7, 29, 38, and 40) compared to the control. These results are shown in Tables 19-20 below. In addition to changes in highly-represented genera, first cutting aqueous extract increased Lactobacillus (OTU 5; P=0.01) compared to control and Romboutsia (OUT 39) compared to control and fifth cutting extract (P=0.01 and 0.02, respectively; see Table 19). Mice fed fifth cutting aqueous extract had reduced relative abundance of Ruminiclostridium (OTU 42) compared to control and first cutting extract (P=0.02; See Tables 20-21).

TABLE 19
Significantly different OTUs (P ≤ 0.05) between control and 1^{st} cutting aqueous
extract diets after the feed enrichment period (d14) determined by LEfSe
analysis in mothur.

| | | 1^{st} cutting | | | |
|---|---|---|---|---|---|
| | | aqueous | | | |
| | Control | extract | | | |
| | median | median | LDA | | |
| | relative | relative | score | | |
| | abundance | abundance | (log | | |
| OTU | (%) | (%) | 10) | P-value | Taxonomy |
| OTU 015 | 1.55 | 0.00 | 3.39 | 0.05 | Lachnospiraceae_NK4A136_group |
| OTU 041 | 0.40 | 0.14 | 2.65 | 0.04 | Ruminococcus_1 |
| OTU 051 | 0.12 | 0.04 | 2.27 | 0.01 | GCA-900066575 |
| OTU 075 | 0.34 | 0.02 | 2.88 | 0.01 | Lachnospiraceae ASF356 |
| OTU 083 | 0.01 | 0.18 | 2.76 | 0.04 | Ruminococcaceae_UCG-013 |
| OTU 097 | 0.12 | 0.01 | 2.74 | 0.004 | Lachnospiraceae_unclassified |
| OTU 098 | 0.18 | 0.03 | 2.78 | 0.04 | Lachnospiraceae unclassified |
| OTU 126 | 0.00 | 0.04 | 2.14 | 0.02 | Lachnospiraceae_unclassified |
| OTU 128 | 0.18 | 0.02 | 2.79 | 0.02 | Lachnospiraceae unclassified |
| OTU 136 | 0.67 | 0.00 | 3.69 | 0.05 | Faecalibaculum |
| OTU 161 | 0.07 | 0.00 | 2.82 | 0.003 | Lachnospiraceae_unclassified |
| OTU 163 | 0.08 | 0.00 | 2.46 | 0.05 | Lachnospiraceae_unclassified |
| OTU 170 | 0.00 | 0.03 | 2.37 | 0.005 | Muribaculaceae_unclassified |
| OTU 179 | 0.00 | 0.01 | 3.62 | 0.02 | Lachnospiraceae_unclassified |
| OTU 190 | 0.02 | 0.00 | 2.35 | 0.004 | Lachnospiraceae_unclassified |
| OTU 199 | 0.06 | 0.01 | 2.26 | 0.01 | Lachnoclostridium |

TABLE 20
Significantly different OTUs (P ≤ 0.05) between control and 5^{th} cutting aqueous
extract diets after the feed enrichment period (d14) determined by LEfSe
analysis in mothur.

| | | 5^{th} cutting | | | |
|---|---|---|---|---|---|
| | | aqueous | | | |
| | Control | extract | | | |
| | median | median | LDA | | |
| | relative | relative | score | | |
| | abundance | abundance | (log | | |
| OTU | (%) | (%) | 10) | P-value | Taxonomy |
| OTU 012 | 2.86 | 1.30 | 3.57 | 0.04 | Lachnospiraceae_NK4A136_group |
| OTU 025 | 0.38 | 0.14 | 2.87 | 0.04 | Lachnospiraceae A2 |
| OTU 041 | 0.40 | 0.12 | 2.88 | 0.04 | Ruminococcus_1 |
| OTU 069 | 0.23 | 0.02 | 2.75 | 0.01 | Lachnoclostridium |
| OTU 075 | 0.34 | 0.02 | 2.90 | 0.01 | Lachnospiraceae ASF356 |
| OTU 082 | 0.11 | 0.06 | 2.32 | 0.02 | uncultured |
| OTU 095 | 0.13 | 0.03 | 2.63 | 0.004 | Lachnospiraceae_unclassified |
| OTU 097 | 0.12 | 0.03 | 2.59 | 0.004 | Lachnospiraceae_unclassified |
| OTU 098 | 0.18 | 0.02 | 2.79 | 0.02 | Lachnospiraceae unclassified |
| OTU 103 | 0.09 | 0.02 | 2.54 | 0.04 | Ruminiclostridium_9 |
| OTU 104 | 0.04 | 0.10 | 2.51 | 0.01 | Eggerthellaceae_unclassified |
| OTU 107 | 0.21 | 0.01 | 2.77 | 0.01 | Lachnospiraceae A2 |
| OTU 128 | 0.18 | 0.02 | 2.87 | 0.02 | Lachnospiraceae_unclassified |
| OTU 133 | 0.03 | 0.00 | 2.35 | 0.05 | Lachnospiraceae_unclassified |
| OTU 136 | 0.67 | 0.00 | 3.69 | 0.05 | Faecalibaculum |
| OTU 140 | 0.07 | 0.04 | 2.21 | 0.004 | Lachnospiraceae_unclassified |
| OTU 145 | 0.03 | 0.00 | 2.41 | 0.05 | Lachnospiraceae_unclassified |
| OTU 150 | 0.12 | 0.01 | 2.51 | 0.04 | Lachnospiraceae_unclassified |
| OTU 161 | 0.07 | 0.01 | 2.75 | 0.02 | Lachnospiraceae unclassified |
| OTU 171 | 0.00 | 0.12 | 2.56 | 0.03 | Muribaculaceae_ge |
| OTU 180 | 0.00 | 0.01 | 2.32 | 0.03 | Clostridiales vadinBB60 group ge |
| OTU 186 | 0.02 | 0.08 | 2.40 | 0.04 | Dubosiella |
| OTU 199 | 0.06 | 0.02 | 2.16 | 0.02 | Lachnoclostridium |

TABLE 21
Significantly different OTUs (P ≤ 0.05) between 1^{st} and 5^{th}
cutting aqueous extract diets after the feed enrichment period (d14)
determined by LEfSe analysis in mothur.

| | 1^{st} cutting | 5^{th} cutting | | | |
|---|---|---|---|---|---|
| | aqueous | aqueous | | | |
| | extract | extract | | | |
| | median | median | LDA | | |
| | relative | relative | score | | |
| | abundance | abundance | (log | | |
| OTU | (%) | (%) | 10) | P-value | Taxonomy |
| OTU 015 | 0.00 | 0.58 | 3.60 | 0.02 | Lachnospiraceae_NK4A136_group |
| OTU 035 | 0.17 | 0.07 | 2.63 | 0.02 | Lachnoclostridium |
| OTU 083 | 0.18 | 0.03 | 2.36 | 0.04 | Ruminococcaceae_UCG-013 |
| OTU 097 | 0.01 | 0.03 | 2.20 | 0.02 | Lachnospiraceae_unclassified |
| OTU 133 | 0.15 | 0.00 | 2.57 | 0.05 | Lachnospiraceae unclassified |
| OTU 163 | 0.00 | 0.02 | 2.41 | 0.03 | Lachnospiraceae_unclassified |
| OTU 179 | 0.01 | 0.00 | 3.62 | 0.02 | Lachnospiraceae_unclassified |
| OTU 190 | 0.00 | 0.03 | 2.23 | 0.03 | Lachnospiraceae_unclassified |

Fewer changes were found between the extracts at 14 dpi, with first and fifth cutting aqueous extracts having 131 and 112 significantly different OTUs compared to control, respectively. Both extracts increased the relative abundance of Lachnospiraceae OTU 40 compared to control (P=0.02), but fifth cutting aqueous extract also increased the relative abundance of Lachnospiraceae OTU 34 and Muribaculaceae OTU 11 (P=0.04 and 0.01, respectively). These results are shown in Tables 22-24 below.

TABLE 22
Significantly different OTUs (P ≤ 0.05) between control and
1^{st} cutting aqueous extract diets at 4 dpi with Citrobacter rodentium
determined by LEfSe analysis in mothur.

| | | 1^{st} cutting | | | |
|---|---|---|---|---|---|
| | | aqueous | | | |
| | Control | extract | | | |
| | median | median | LDA | | |
| | relative | relative | score | | |
| | abundance | abundance | (log | | |
| OTU | (%) | (%) | 10) | P-value | Taxonomy |
| OTU 001 | 10.25 | 6.02 | 3.84 | 0.04 | Muribaculaceae_ge |
| OTU 002 | 17.18 | 7.09 | 4.66 | 0.02 | Muribaculaceae_ge |
| OTU 003 | 0.02 | 0.33 | 3.41 | 0.02 | Muribaculaceae_ge |
| OTU 004 | 13.75 | 1.41 | 4.87 | 0.02 | Dubosiella |
| OTU 005 | 1.84 | 7.33 | 4.16 | 0.02 | Lactobacillus |
| OTU 006 | 7.04 | 2.78 | 4.35 | 0.02 | Bacteroides |
| OTU 010 | 0.00 | 16.61 | 4.94 | 0.02 | Muribaculaceae ge |
| OTU 011 | 0.00 | 3.70 | 4.29 | 0.02 | Muribaculaceae_ge |
| OTU 022 | 0.75 | 0.21 | 3.35 | 0.02 | Muribaculaceae ge |
| OTU 023 | 0.80 | 0.36 | 3.30 | 0.02 | Muribaculaceae_ge |
| OTU 024 | 0.00 | 0.04 | 2.34 | 0.02 | Muribaculaceae_ge |
| OTU 027 | 0.57 | 0.14 | 3.19 | 0.02 | Muribaculaceae ge |
| OTU 032 | 0.32 | 0.17 | 2.95 | 0.02 | Bacteroides |
| OTU 038 | 0.00 | 0.17 | 2.71 | 0.02 | Lachnospiraceae unclassified |
| OTU 039 | 0.00 | 0.04 | 2.44 | 0.01 | Romboutsia |
| OTU 042 | 0.24 | 0.08 | 2.89 | 0.04 | Ruminiclostridium_5 |
| OTU 043 | 0.00 | 0.08 | 2.46 | 0.02 | Lachnospiraceae_NK4A136_group |
| OTU 047 | 0.09 | 0.50 | 3.10 | 0.04 | Lachnospiraceae_unclassified |
| OTU 052 | 0.12 | 0.02 | 2.52 | 0.02 | Erysipelatoclostridium |
| OTU 053 | 0.00 | 0.54 | 3.47 | 0.02 | Lachnospiraceae_unclassified |
| OTU 055 | 0.00 | 0.38 | 3.27 | 0.02 | Clostridium sensu stricto 1 |
| OTU 057 | 0.00 | 0.50 | 3.51 | 0.02 | Lachnospiraceae_unclassified |
| OTU 066 | 0.00 | 0.02 | 2.08 | 0.01 | Muribaculaceae_ge |
| OTU 069 | 0.04 | 0.48 | 3.31 | 0.04 | Lachnoclostridium |
| OTU 070 | 0.18 | 0.05 | 2.59 | 0.02 | Muribaculaceae_ge |
| OTU 075 | 0.00 | 0.11 | 2.38 | 0.04 | Lachnospiraceae ASF356 |
| OTU 076 | 0.00 | 0.27 | 3.13 | 0.01 | Muribaculaceae_ge |
| OTU 077 | 0.21 | 0.05 | 2.74 | 0.02 | Muribaculaceae_ge |
| OTU 083 | 0.02 | 0.14 | 2.76 | 0.02 | Ruminococcaceae_UCG-013 |
| OTU 084 | 0.00 | 0.25 | 3.17 | 0.01 | Muribaculaceae_ge |
| OTU 085 | 0.00 | 0.21 | 3.04 | 0.01 | Muribaculaceae_ge |
| OTU 092 | 0.05 | 0.10 | 2.14 | 0.04 | Ruminiclostridium_9 |
| OTU 093 | 0.09 | 0.05 | 2.46 | 0.02 | Lachnoclostridium |
| OTU 094 | 0.09 | 0.04 | 2.18 | 0.02 | Enterorhabdus |
| OTU 101 | 0.10 | 0.02 | 2.50 | 0.02 | Dubosiella |
| OTU 102 | 0.11 | 0.05 | 2.80 | 0.04 | Lachnospiraceae_UCG-006 |
| OTU 105 | 0.00 | 0.05 | 2.08 | 0.01 | Lachnospiraceae_NK4A136_group |
| OTU 106 | 0.00 | 0.49 | 3.39 | 0.01 | Muribaculaceae_ge |
| OTU 110 | 0.11 | 0.02 | 2.60 | 0.04 | Lachnospiraceae_unclassified |
| OTU 115 | 0.00 | 0.42 | 3.35 | 0.01 | Muribaculaceae_ge |
| OTU 128 | 0.02 | 0.08 | 2.42 | 0.02 | Lachnospiraceae_unclassified |
| OTU 129 | 0.04 | 0.00 | 2.18 | 0.02 | uncultured |
| OTU 131 | 0.00 | 0.10 | 2.81 | 0.01 | Muribaculaceae_ge |
| OTU 133 | 0.00 | 0.19 | 2.95 | 0.01 | Lachnospiraceae_unclassified |
| OTU 134 | 0.00 | 0.10 | 2.80 | 0.01 | Muribaculaceae_ge |
| OTU 138 | 0.00 | 0.09 | 2.77 | 0.01 | Muribaculaceae_ge |
| OTU 139 | 0.19 | 0.00 | 2.81 | 0.02 | Muribaculaceae_ge |
| OTU 144 | 0.00 | 0.08 | 2.68 | 0.01 | Lachnoclostridium |
| OTU 145 | 0.00 | 0.32 | 3.06 | 0.02 | Lachnospiraceae_unclassified |
| OTU 147 | 0.00 | 0.05 | 2.53 | 0.02 | Ruminococcaceae_UCG-014 |
| OTU 150 | 0.00 | 0.06 | 2.47 | 0.02 | Lachnospiraceae_unclassified |
| OTU 151 | 0.06 | 0.02 | 2.01 | 0.04 | Muribaculaceae_ge |
| OTU 153 | 0.00 | 0.29 | 3.19 | 0.01 | Muribaculaceae_ge |
| OTU 154 | 0.00 | 0.29 | 3.22 | 0.01 | Muribaculaceae_ge |
| OTU 156 | 0.07 | 0.00 | 2.35 | 0.02 | Muribaculaceae_ge |
| OTU 167 | 0.00 | 0.06 | 2.29 | 0.04 | uncultured |
| OTU 169 | 0.00 | 0.31 | 3.34 | 0.01 | Muribaculaceae_ge |
| OTU 170 | 0.04 | 0.00 | 2.43 | 0.01 | Muribaculaceae_unclassified |
| OTU 173 | 0.00 | 0.02 | 2.46 | 0.01 | Ruminococcaceae_UCG-014 |
| OTU 177 | 0.21 | 0.00 | 3.12 | 0.01 | Lachnospiraceae_unclassified |
| OTU 181 | 0.01 | 0.03 | 2.15 | 0.02 | Oscillibacter |
| OTU 186 | 0.03 | 0.00 | 2.30 | 0.04 | Dubosiella |
| OTU 189 | 0.00 | 0.33 | 3.36 | 0.01 | Muribaculaceae_ge |
| OTU 193 | 0.10 | 0.00 | 2.78 | 0.05 | Muribaculaceae_ge |

TABLE 23
Significantly different OTUs (P ≤ 0.05) between control and
5^{th} cutting aqueous extract diets at 4 dpi with Citrobacter rodentium
determined by LEfSe analysis in mothur.

| | | 5^{th} cutting | | | |
|---|---|---|---|---|---|
| | | aqueous | | | |
| | Control | extract | | | |
| | median | median | LDA | | |
| | relative | relative | score | | |
| | abundance | abundance | (log | | |
| OTU | (%) | (%) | 10) | P-value | Taxonomy |
| OTU 004 | 13.75 | 0.80 | 4.91 | 0.04 | Dubosiella |
| OTU 006 | 7.04 | 2.01 | 4.55 | 0.02 | Bacteroides |
| OTU 007 | 0.80 | 3.47 | 4.72 | 0.04 | Lachnospiraceae_NK4A136_group |
| OTU 029 | 0.00 | 1.06 | 4.11 | 0.05 | Lachnospiraceae_unclassified |
| OTU 032 | 0.32 | 0.09 | 3.20 | 0.02 | Bacteroides |
| OTU 038 | 0.00 | 0.18 | 3.31 | 0.02 | Lachnospiraceae_unclassified |
| OTU 040 | 0.20 | 0.93 | 4.08 | 0.04 | Lachnospiraceae NK4A136 group |
| OTU 056 | 0.43 | 0.07 | 3.23 | 0.02 | Ruminiclostridium |
| OTU 075 | 0.00 | 0.06 | 2.45 | 0.04 | Lachnospiraceae ASF356 |
| OTU 093 | 0.09 | 0.03 | 2.61 | 0.02 | Lachnoclostridium |
| OTU 098 | 0.02 | 0.09 | 2.49 | 0.02 | Lachnospiraceae_unclassified |
| OTU 101 | 0.10 | 0.00 | 2.64 | 0.04 | Dubosiella |
| OTU 109 | 0.07 | 0.00 | 2.67 | 0.01 | Ruminococcaceae_UCG-014 |
| OTU 110 | 0.11 | 0.03 | 2.54 | 0.02 | Lachnospiraceae unclassified |
| OTU 112 | 0.01 | 0.06 | 2.80 | 0.04 | Lachnospiraceae_unclassified |
| OTU 139 | 0.19 | 0.00 | 2.82 | 0.04 | Muribaculaceae_ge |
| OTU 140 | 0.06 | 0.04 | 2.23 | 0.04 | Lachnospiraceae_unclassified |
| OTU 144 | 0.00 | 0.02 | 2.44 | 0.01 | Lachnoclostridium |
| OTU 159 | 0.01 | 0.11 | 2.92 | 0.02 | Lachnospiraceae NK4A136 group |
| OTU 170 | 0.04 | 0.01 | 2.43 | 0.04 | Muribaculaceae_unclassified |
| OTU 172 | 0.03 | 0.00 | 2.28 | 0.04 | Lachnospiraceae unclassified |
| OTU 177 | 0.21 | 0.00 | 3.12 | 0.01 | Lachnospiraceae_unclassified |
| OTU 181 | 0.01 | 0.03 | 2.40 | 0.02 | Oscillibacter |
| OTU 185 | 0.04 | 0.01 | 2.12 | 0.02 | Family_XIII_UCG-001 |
| OTU 193 | 0.10 | 0.00 | 2.78 | 0.05 | Muribaculaceae_ge |
| OTU 200 | 0.02 | 0.00 | 2.05 | 0.05 | Clostridiales_unclassified |

TABLE 24
Significantly different OTUs (P ≤ 0.05) between 1^{st} and 5^{th}
cutting aqueous extract diets at 4 dpi with Citrobacter rodentium
determined by LEfSe analysis in mothur.

| | 1^{st} cutting | 5^{th} cutting | | | |
|---|---|---|---|---|---|
| | aqueous | aqueous | | | |
| | extract | extract | | | |
| | median | median | LDA | | |
| | relative | relative | score | | |
| | abundance | abundance | (log | | |
| OTU | (%) | (%) | 10) | P-value | Taxonomy |
| OTU 003 | 0.33 | 0.00 | 3.28 | 0.02 | Muribaculaceae_ge |
| OTU 010 | 16.61 | 0.00 | 4.94 | 0.01 | Muribaculaceae_ge |
| OTU 011 | 3.70 | 0.00 | 4.27 | 0.02 | Muribaculaceae_ge |
| OTU 013 | 1.31 | 0.12 | 3.85 | 0.02 | Turicibacter |
| OTU 024 | 0.04 | 0.00 | 2.22 | 0.02 | Muribaculaceae ge |
| OTU 026 | 0.92 | 0.00 | 3.59 | 0.02 | Lachnospiraceae_NK4A136_group |
| OTU 034 | 0.00 | 0.52 | 3.25 | 0.02 | Lachnospiraceae unclassified |
| OTU 035 | 0.06 | 0.44 | 3.41 | 0.04 | Lachnoclostridium |
| OTU 039 | 0.04 | 0.00 | 2.34 | 0.02 | Romboutsia |
| OTU 040 | 0.10 | 0.93 | 4.10 | 0.02 | Lachnospiraceae_NK4A136_group |
| OTU 041 | 0.51 | 0.00 | 3.31 | 0.02 | Ruminococcus_1 |
| OTU 042 | 0.08 | 0.35 | 3.58 | 0.02 | Ruminiclostridium 5 |
| OTU 053 | 0.54 | 0.00 | 3.32 | 0.02 | Lachnospiraceae_unclassified |
| OTU 055 | 0.38 | 0.00 | 3.39 | 0.01 | Clostridium sensu stricto 1 |
| OTU 056 | 0.28 | 0.07 | 2.92 | 0.04 | Ruminiclostridium |
| OTU 057 | 0.50 | 0.00 | 3.34 | 0.02 | Lachnospiraceae_ unclassified |
| OTU 058 | 0.02 | 0.14 | 3.34 | 0.02 | Lachnospiraceae_unclassified |
| OTU 063 | 0.14 | 0.04 | 2.59 | 0.04 | Lachnospiraceae_NK4A136_group |
| OTU 067 | 1.25 | 0.00 | 3.65 | 0.04 | Lachnospiraceae NK4A136 group |
| OTU 069 | 0.48 | 0.00 | 3.33 | 0.02 | Lachnoclostridium |
| OTU 076 | 0.27 | 0.00 | 3.13 | 0.01 | Muribaculaceae ge |
| OTU 084 | 0.25 | 0.00 | 3.16 | 0.01 | Muribaculaceae_ge |
| OTU 085 | 0.21 | 0.00 | 3.04 | 0.01 | Muribaculaceae_ge |
| OTU 092 | 0.10 | 0.02 | 2.71 | 0.02 | Ruminiclostridium_9 |
| OTU 095 | 0.14 | 0.03 | 2.78 | 0.02 | Lachnospiraceae_unclassified |
| OTU 098 | 0.03 | 0.09 | 2.45 | 0.02 | Lachnospiraceae_unclassified |
| OTU 105 | 0.05 | 0.00 | 2.77 | 0.01 | Lachnospiraceae_NK4A136_group |
| OTU 106 | 0.49 | 0.00 | 3.44 | 0.01 | Muribaculaceae_ge |
| OTU 109 | 0.06 | 0.00 | 2.68 | 0.01 | Ruminococcaceae_UCG-014 |
| OTU 114 | 0.00 | 0.03 | 2.90 | 0.02 | Lachnospiraceae GCA-900066575 |
| OTU 115 | 0.42 | 0.00 | 3.36 | 0.01 | Muribaculaceae_ge |
| OTU 129 | 0.00 | 0.05 | 2.36 | 0.04 | uncultured |
| OTU 131 | 0.10 | 0.00 | 2.74 | 0.02 | Muribaculaceae ge |
| OTU 134 | 0.10 | 0.00 | 2.72 | 0.01 | Muribaculaceae_ge |
| OTU 138 | 0.09 | 0.00 | 2.73 | 0.01 | Muribaculaceae_ge |
| OTU 145 | 0.32 | 0.01 | 3.08 | 0.04 | Lachnospiraceae_unclassified |
| OTU 147 | 0.05 | 0.00 | 2.41 | 0.02 | Ruminococcaceae_UCG-014 |
| OTU 150 | 0.06 | 0.01 | 2.45 | 0.02 | Lachnospiraceae_unclassified |
| OTU 153 | 0.29 | 0.00 | 3.14 | 0.01 | Muribaculaceae_ge |
| OTU 154 | 0.29 | 0.00 | 3.21 | 0.01 | Muribaculaceae_ge |
| OTU 159 | 0.01 | 0.11 | 2.91 | 0.02 | Lachnospiraceae_NK4A136_group |
| OTU 160 | 0.08 | 0.00 | 2.64 | 0.05 | Alistipes |
| OTU 162 | 0.00 | 0.02 | 2.02 | 0.04 | Lachnospiraceae_unclassified |
| OTU 164 | 0.03 | 0.00 | 2.38 | 0.02 | Ruminococcaceae_UCG-014 |
| OTU 169 | 0.31 | 0.00 | 3.29 | 0.01 | Muribaculaceae_ge |
| OTU 173 | 0.02 | 0.00 | 2.36 | 0.01 | Ruminococcaceae_UCG-014 |
| OTU 183 | 0.04 | 0.00 | 2.16 | 0.02 | Lachnospiraceae_UCG-006 |
| OTU 184 | 0.03 | 0.01 | 2.37 | 0.02 | Ruminococcaceae_UCG-014 |
| OTU 188 | 0.03 | 0.00 | 2.44 | 0.02 | Ruminococcaceae_UCG-014 |
| OTU 189 | 0.33 | 0.00 | 3.28 | 0.01 | Muribaculaceae_ge |
| OTU 190 | 0.04 | 0.00 | 2.07 | 0.02 | Lachnospiraceae_unclassified |
| OTU 198 | 0.01 | 0.02 | 2.14 | 0.04 | Lachnospiraceae_UCG-004 |
| OTU 200 | 0.05 | 0.00 | 2.26 | 0.01 | Clostridiales_unclassified |

TABLE 25
Significantly different OTUs (P ≤ 0.05) between control and
1^{st} cutting aqueous extract diets at 14 dpi with Citrobacter rodentium
determined by LEfSe analysis in mothur.

| | | 1^{st} cutting | | | |
|---|---|---|---|---|---|
| | | aqueous | | | |
| | Control | extract | | | |
| | median | median | LDA | | |
| | relative | relative | score | | |
| | abundance | abundance | (log | | |
| OTU | (%) | (%) | 10) | P-value | Taxonomy |
| OTU 040 | 0.03 | 0.42 | 3.81 | 0.02 | Lachnospiraceae_NK4A136_group |
| OTU 052 | 0.54 | 0.11 | 3.61 | 0.04 | Erysipelatoclostridium |
| OTU 056 | 0.03 | 0.11 | 3.02 | 0.04 | Ruminiclostridium |
| OTU 081 | 0.03 | 0.00 | 2.99 | 0.02 | Roseburia |
| OTU 088 | 0.01 | 0.13 | 3.32 | 0.02 | Lachnospiraceae_unclassified |
| OTU 094 | 0.06 | 0.02 | 2.19 | 0.02 | Enterorhabdus |
| OTU 098 | 0.03 | 0.09 | 2.44 | 0.04 | Lachnospiraceae_unclassified |
| OTU 113 | 0.08 | 0.31 | 2.96 | 0.04 | Anaerotruncus |
| OTU 116 | 0.00 | 0.06 | 2.50 | 0.02 | Lachnospiraceae_unclassified |
| OTU 128 | 0.00 | 0.01 | 2.33 | 0.05 | Lachnospiraceae_unclassified |
| OTU 180 | 0.05 | 0.00 | 3.03 | 0.04 | Clostridiales_vadinBB60_group_ge |
| OTU 188 | 0.00 | 0.01 | 3.37 | 0.05 | Ruminococcaceae_UCG-014 |

TABLE 26
Significantly different OTUs (P ≤ 0.05) between control and
5^{th} cutting aqueous extract diets at 14 dpi with Citrobacter rodentium
determined by LEfSe analysis in mothur.

| | | 5^{th} cutting | | | |
|---|---|---|---|---|---|
| | | aqueous | | | |
| | Control | extract | | | |
| | median | median | LDA | | |
| | relative | relative | score | | |
| | abundance | abundance | (log | | |
| OTU | (%) | (%) | 10) | P-value | Taxonomy |
| OTU 011 | 0.22 | 0.00 | 3.14 | 0.01 | Muribaculaceae_ge |
| OTU 034 | 0.02 | 0.26 | 3.08 | 0.04 | Lachnospiraceae unclassified |
| OTU 040 | 0.03 | 0.38 | 2.93 | 0.02 | Lachnospiraceae_NK4A136_group |
| OTU 058 | 0.50 | 0.08 | 3.25 | 0.02 | Lachnospiraceae_unclassified |
| OTU 076 | 0.01 | 0.00 | 2.19 | 0.05 | Muribaculaceae ge |
| OTU 083 | 0.00 | 0.19 | 3.42 | 0.02 | Ruminococcaceae_UCG-013 |
| OTU 091 | 0.00 | 0.04 | 2.33 | 0.01 | Clostridiales_vadinBB60_group_ge |
| OTU 113 | 0.08 | 0.03 | 2.54 | 0.02 | Anaerotruncus |
| OTU 114 | 0.26 | 0.01 | 3.08 | 0.02 | Lachnospiraceae GCA-900066575 |
| OTU 119 | 0.00 | 0.11 | 2.72 | 0.02 | Lachnospiraceae_unclassified |
| OTU 123 | 0.00 | 0.04 | 2.55 | 0.02 | Ruminococcaceae_UCG-010 |
| OTU 149 | 0.00 | 0.10 | 2.24 | 0.04 | Lachnospiraceae_unclassified |
| OTU 185 | 0.00 | 0.03 | 2.01 | 0.04 | Family_XIII_UCG-001 |
| OTU 192 | 0.00 | 0.04 | 2.09 | 0.04 | Lachnospiraceae_unclassified |

TABLE 27
Significantly different OTUs (P ≤ 0.05) between 1^{st} and 5^{th}
cutting aqueous extract diets at 14 dpi with Citrobacter rodentium
determined by LEfSe analysis in mothur.

| | 1^{st} cutting | 5^{th} cutting | | | |
|---|---|---|---|---|---|
| | aqueous | aqueous | | | |
| | extract | extract | | | |
| | median | median | LDA | | |
| | relative | relative | score | | |
| | abundance | abundance | (log | | |
| OTU | (%) | (%) | 10) | P-value | Taxonomy |
| OTU 011 | 0.16 | 0.00 | 3.57 | 0.05 | Muribaculaceae_ge |
| OTU 013 | 0.03 | 0.55 | 3.70 | 0.02 | Turicibacter |
| OTU 019 | 3.33 | 0.40 | 4.30 | 0.04 | Lachnospiraceae_unclassified |
| OTU 028 | 0.00 | 0.03 | 2.05 | 0.02 | Anaeroplasma |
| OTU 058 | 0.43 | 0.08 | 3.26 | 0.02 | Lachnospiraceae unclassified |
| OTU 072 | 0.00 | 0.09 | 2.64 | 0.01 | Mollicutes_RF39_ge |
| OTU 085 | 0.01 | 0.00 | 2.48 | 0.05 | Muribaculaceae ge |
| OTU 091 | 0.00 | 0.04 | 2.30 | 0.02 | Clostridiales_vadinBB60_group_ge |
| OTU 092 | 0.00 | 0.04 | 2.38 | 0.04 | Ruminiclostridium_9 |
| OTU 095 | 0.00 | 0.15 | 2.45 | 0.01 | Lachnospiraceae_unclassified |
| OTU 108 | 0.00 | 0.13 | 2.79 | 0.04 | Clostridiales_vadinBB60_group ge |
| OTU 113 | 0.31 | 0.03 | 3.02 | 0.02 | Anaerotruncus |
| OTU 119 | 0.00 | 0.11 | 2.58 | 0.04 | Lachnospiraceae_unclassified |
| OTU 146 | 0.08 | 0.00 | 2.64 | 0.05 | Lachnospiraceae_NK4A136_group |
| OTU 159 | 0.04 | 0.00 | 2.16 | 0.02 | Lachnospiraceae_NK4A136_group |
| OTU 171 | 0.00 | 0.04 | 2.52 | 0.05 | Muribaculaceae_ge |

TABLE 28
Significantly different OTUs¹ (P ≤ 0.05) between control
and 1^{st} cutting aqueous extract diets at 21 dpi with Citrobacter rodentium
determined by LEfSe analysis in mothur.

| | | 1^{st} cutting | | | |
|---|---|---|---|---|---|
| | | aqueous | | | |
| | Control | extract | | | |
| | median | median | LDA | | |
| | relative | relative | score | | |
| | abundance | abundance | (log | | |
| OTU | (%) | (%) | 10) | P-value | Taxonomy |
| OTU 003 | 16.92 | 25.68 | 4.33 | 0.03 | Muribaculaceae_ge |
| OTU 008 | 1.71 | 6.31 | 4.20 | 0.03 | Akkermansia |
| OTU 010 | 0.61 | 0.01 | 3.60 | 0.03 | Muribaculaceae_ge |
| OTU 011 | 1.74 | 2.34 | 3.65 | 0.03 | Muribaculaceae_ge |
| OTU 021 | 0.44 | 0.03 | 3.51 | 0.03 | Bifidobacterium |
| OTU 043 | 0.18 | 0.00 | 3.58 | 0.03 | Lachnospiraceae_NK4A136_group |
| OTU 059 | 0.13 | 0.04 | 2.60 | 0.03 | Lachnoclostridium |
| OTU 066 | 0.26 | 0.41 | 2.52 | 0.03 | Muribaculaceae_ge |
| OTU 073 | 0.23 | 0.34 | 2.61 | 0.03 | Muribaculaceae_ge |
| OTU 083 | 0.15 | 0.34 | 3.19 | 0.03 | Ruminococcaceae_UCG-013 |
| OTU 107 | 0.04 | 0.02 | 2.38 | 0.03 | Lachnospiraceae A2 |
| OTU 115 | 0.02 | 0.00 | 2.16 | 0.03 | Muribaculaceae ge |
| OTU 127 | 0.03 | 0.01 | 2.27 | 0.03 | Oscillibacter |
| OTU 131 | 0.04 | 0.11 | 2.62 | 0.03 | Muribaculaceae_ge |
| OTU 159 | 0.03 | 0.00 | 2.47 | 0.03 | Lachnospiraceae_NK4A136_group |
| OTU 160 | 0.00 | 0.06 | 2.49 | 0.03 | Alistipes |

TABLE 29
Significantly different OTUs (P ≤ 0.05) between control and
5^{th} cutting aqueous extract diets at 21 dpi with Citrobacter rodentium
determined by LEfSe analysis in mothur.

| | | 5^{th} | | | |
|---|---|---|---|---|---|
| | | cutting | | | |
| | | aqueous | | | |
| | Control | extract | | | |
| | median | median | LDA | | |
| | relative | relative | score | | |
| | abundance | abundance | (log | | |
| OTU | (%) | (%) | 10) | P-value | Taxonomy |
| OTU 004 | 1.11 | 14.16 | 4.83 | 0.02 | Dubosiella |
| OTU 007 | 2.56 | 1.00 | 3.87 | 0.04 | Lachnospiraceae_NK4A136_group |
| OTU 010 | 0.61 | 0.00 | 3.51 | 0.02 | Muribaculaceae_ge |
| OTU 011 | 1.74 | 2.73 | 3.37 | 0.04 | Muribaculaceae_ge |
| OTU 013 | 0.31 | 0.03 | 2.96 | 0.02 | Turicibacter |
| OTU 018 | 0.25 | 0.51 | 3.18 | 0.02 | Muribaculaceae_ge |
| OTU 028 | 0.23 | 0.01 | 2.50 | 0.04 | Anaeroplasma |
| OTU 040 | 0.55 | 0.17 | 3.27 | 0.02 | Lachnospiraceae_NK4A136_group |
| OTU 050 | 0.17 | 0.05 | 2.90 | 0.02 | uncultured |
| OTU 076 | 0.15 | 0.27 | 2.51 | 0.02 | Muribaculaceae_ge |
| OTU 080 | 0.02 | 0.10 | 2.72 | 0.02 | Dubosiella |
| OTU 094 | 0.07 | 0.10 | 2.21 | 0.04 | Enterorhabdus |
| OTU 101 | 0.01 | 0.20 | 2.93 | 0.02 | Dubosiella |
| OTU 110 | 0.02 | 0.00 | 2.17 | 0.02 | Lachnospiraceae_unclassified |
| OTU 113 | 0.04 | 0.01 | 2.27 | 0.02 | Anaerotruncus |
| OTU 115 | 0.02 | 0.00 | 2.05 | 0.01 | Muribaculaceae_ge |
| OTU 125 | 0.02 | 0.07 | 2.61 | 0.04 | Akkermansia |
| OTU 134 | 0.06 | 0.20 | 2.60 | 0.04 | Muribaculaceae_ge |
| OTU 138 | 0.06 | 0.18 | 2.59 | 0.04 | Muribaculaceae_ge |
| OTU 142 | 0.00 | 0.09 | 2.62 | 0.02 | Muribaculaceae_ge |
| OTU 146 | 0.00 | 0.13 | 2.78 | 0.01 | Lachnospiraceae_NK4A136_group |

TABLE 30
Significantly different OTUs (P ≤ 0.05) between control and
5^{th} cutting aqueous extract diets at 21 dpi with Citrobacter rodentium
determined by LEfSe analysis in mothur.

| | 1^{st} cutting | 5^{th} cutting | | | |
|---|---|---|---|---|---|
| | aqueous | aqueous | | | |
| | extract | extract | | | |
| | median | median | LDA | | |
| | relative | relative | score | | |
| | abundance | abundance | (log | | |
| OTU | (%) | (%) | 10) | P-value | Taxonomy |
| OTU 001 | 8.26 | 14.60 | 4.73 | 0.03 | Muribaculaceae_ge |
| OTU 003 | 25.68 | 12.61 | 4.95 | 0.03 | Muribaculaceae ge |
| OTU 004 | 1.83 | 14.16 | 4.78 | 0.03 | Dubosiella |
| OTU 018 | 0.20 | 0.51 | 3.35 | 0.03 | Muribaculaceae_ge |
| OTU 022 | 0.26 | 0.57 | 3.44 | 0.03 | Muribaculaceae_ge |
| OTU 027 | 0.10 | 0.45 | 3.29 | 0.03 | Muribaculaceae_ge |
| OTU 030 | 1.02 | 0.56 | 3.59 | 0.03 | Muribaculaceae_ge |
| OTU 043 | 0.00 | 0.22 | 2.90 | 0.03 | Lachnospiraceae_NK4A136_group |
| OTU 070 | 0.05 | 0.19 | 2.93 | 0.03 | Muribaculaceae ge |
| OTU 077 | 0.05 | 0.14 | 2.82 | 0.03 | Muribaculaceae_ge |
| OTU 083 | 0.34 | 0.04 | 3.13 | 0.03 | Ruminococcaceae_UCG-013 |
| OTU 084 | 0.12 | 0.22 | 2.85 | 0.03 | Muribaculaceae_ge |
| OTU 094 | 0.03 | 0.10 | 2.58 | 0.03 | Enterorhabdus |
| OTU 101 | 0.02 | 0.20 | 2.83 | 0.03 | Dubosiella |
| OTU 103 | 0.04 | 0.02 | 2.02 | 0.03 | Ruminiclostridium_9 |
| OTU 112 | 0.04 | 0.02 | 2.13 | 0.03 | Lachnospiraceae_unclassified |
| OTU 113 | 0.09 | 0.01 | 2.42 | 0.03 | Anaerotruncus |
| OTU 114 | 0.00 | 0.03 | 2.20 | 0.03 | Lachnospiraceae GCA-900066575 |
| OTU 122 | 0.13 | 0.03 | 2.73 | 0.03 | Ruminiclostridium |
| OTU 129 | 0.01 | 0.04 | 2.35 | 0.03 | uncultured |
| OTU 134 | 0.06 | 0.20 | 2.79 | 0.03 | Muribaculaceae_ge |
| OTU 142 | 0.03 | 0.09 | 2.59 | 0.03 | Muribaculaceae_ge |
| OTU 146 | 0.00 | 0.13 | 2.38 | 0.03 | Lachnospiraceae_NK4A136_group |
| OTU 151 | 0.01 | 0.04 | 2.42 | 0.03 | Muribaculaceae_ge |
| OTU 171 | 0.00 | 0.04 | 2.61 | 0.03 | Muribaculaceae_ge |
| OTU 192 | 0.04 | 0.03 | 2.05 | 0.03 | Lachnospiraceae_unclassified |

In the last timepoint of the infection, mice fed first cutting aqueous extract had 70 OTUs significantly differ from the control, while those fed fifth cutting extract had 169 different OTUs. Mice fed first cutting aqueous extract had 3.7-fold increased relative abundance of Akkermansia (OTU 8) and reduced Bifidobacterium (OTU 21) compared to control (P=0.03; FIG. 26). Feeding fifth cut aqueous extract reduced the relative abundance of Turicibacter (OTU 13) 10.3-fold and Anaeroplasma (OTU 28) compared to the control diet (P=0.02 and 0.04) and Dubosiella (OTU 4) compared to the control and first cutting extract (P=0.02 and 0.03, respectively; FIG. 26).

Chloroform Extracts

Throughout the trial, first cutting chloroform extracts did not differ from control in terms of whole community comparisons as determined by ANOSIM. Feeding diets supplemented with fifth cutting chloroform extract altered the intestinal microbiota at a whole-community levels compared to control and first cutting chloroform extract at a baseline health state (P=0.04) and at 4 dpi (P=0.03). Chloroform extracts of fifth cutting alfalfa did not alter the microbiome at a whole-community level at later timepoints of C. rodentium infection (14 and 21 dpi) as shown in Table 31.

TABLE 31
Whole-community ANOSIM¹ comparisons of the colon microbiota
of mice fed the control or diets supplemented with chloroform
extracts from first and fifth cutting alfalfa

| | | |
|---|---|---|
| Comparison | R-value² | P-value³ |

Control vs. 1st Cut Chloroform Extract

| | | |
|---|---|---|
| d14 (baseline) | 0.18 | 0.09 |
| 4 dpi | 0.30 | 0.11 |
| 14 dpi | 0.06 | 0.29 |
| 21 dpi | 0.03 | 0.32 |

Control vs. 5th Cut Chloroform Extract

| | | |
|---|---|---|
| d14 (baseline) | 0.25 | 0.04 |
| 4 dpi | 1.00 | 0.03 |
| 14 dpi | −0.13 | 0.81 |
| 21 dpi | 0.23 | 0.15 |

1st Cut Chloroform vs. 5th Cut Chloroform Extract

| | | |
|---|---|---|
| d14 (baseline) | 0.42 | 0.04 |
| 4 dpi | 0.54 | 0.03 |
| 14 dpi | 0.15 | 0.18 |
| 21 dpi | 0.00 | 0.49 |

¹Analysis of similarity performed using mothur (v.1.40.04)
²R-values detail the source of sample variations on a scale of −1 to 1. Values closer to −1 suggest higher variation between within samples while those closer to 1 suggest higher variation between samples. R-values close to 0 indicate no differences in variation.
³Significance determined at P ≤ 0.05.

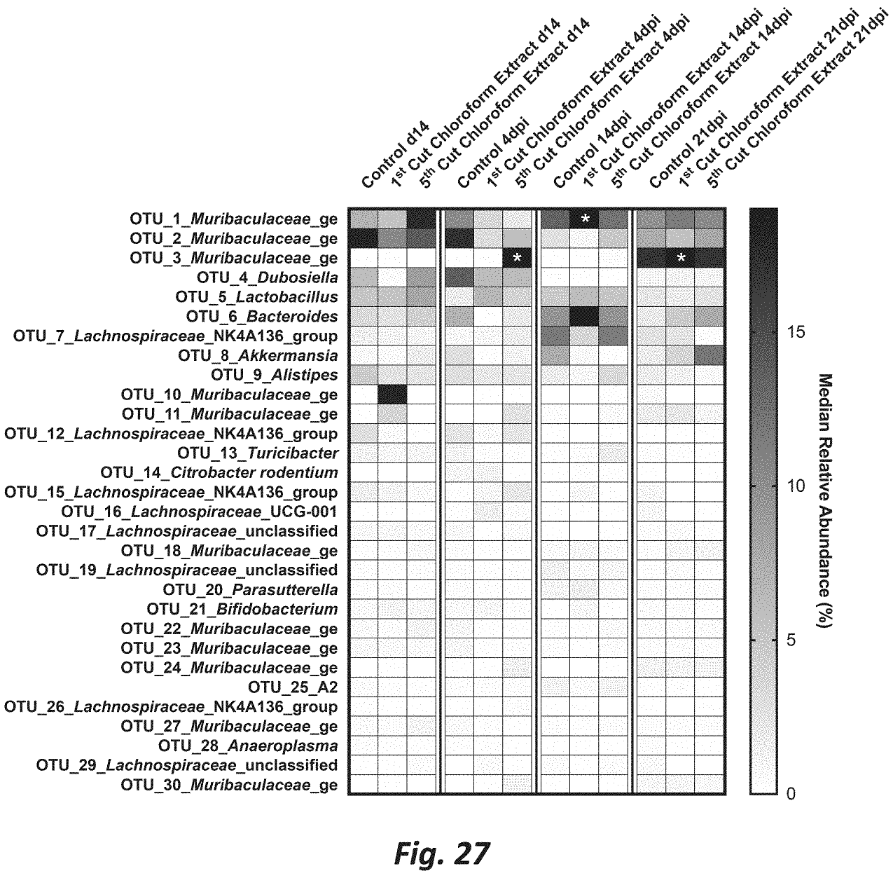

A heatmap of the 30 most abundant OTUs in the colons of mice fed the control and chloroform extract diets is presented in FIG. 27 along with LEfSe analysis of the 200 most abundant OTUs in Tables 32-43 below.

At a baseline health state, fifth cutting chloroform extracts had 143 significantly different OTUs compared to control, which is greater than the 99 different OTUs observed between first cutting chloroform extract and the control at this timepoint. Of these altered OTUs, first cutting chloroform extract reduced the relative abundance of Romboutsia (OTU 39; P=0.02) and Faecalibaculum (OTU 136; P=0.05), while feeding fifth cutting chloroform extract increased the relative abundance of more highly abundant OTUs associated with Muribaculaceae (OTUs 1, 18, 22, 27) out of the 200 most abundant (See Tables 32-33). In particular, fifth cutting chloroform extract increased the relative abundance of Muribaculaceae OTUs 1, 22, and 27 over both the control and first cutting chloroform diets, which may be contributing to the significantly altered overall community (FIG. 27).

TABLE 32
Significantly different OTUs (P ≤ 0.05) between control and
1^{st} cutting chloroform extract diets after the feed enrichment period (d14)
determined by LEfSe analysis in mothur.

| | | 1^{st} cutting | | | |
|---|---|---|---|---|---|
| | | chloroform | | | |
| | Control | extract | | | |
| | Median | median | LDA | | |
| | relative | relative | score | | |
| | abundance | abundance | (log | | |
| OTU | (%) | (%) | 10) | P-value | Taxonomy |
| OTU 024 | 0.00 | 0.00 | 3.59 | 0.02 | Muribaculaceae_ge |
| OTU 025 | 0.38 | 0.12 | 3.05 | 0.04 | Lachnospiraceae A2 |
| OTU 039 | 0.03 | 0.00 | 2.18 | 0.02 | Romboutsia |
| OTU 040 | 0.02 | 0.29 | 3.18 | 0.01 | Lachnospiraceae NK4A136 group |
| OTU 046 | 0.01 | 0.04 | 2.42 | 0.01 | uncultured |
| OTU 047 | 0.01 | 0.27 | 3.16 | 0.004 | Lachnospiraceae_unclassified |
| OTU 051 | 0.12 | 0.05 | 2.17 | 0.02 | Lachnospiraceae GCA-900066575 |
| OTU 055 | 0.10 | 0.00 | 2.60 | 0.02 | Clostridium_sensu_stricto_1 |
| OTU 067 | 0.20 | 0.00 | 2.82 | 0.01 | Lachnospiraceae NK4A136 group |
| OTU 069 | 0.23 | 0.09 | 2.88 | 0.02 | Lachnoclostridium |
| OTU 075 | 0.34 | 0.07 | 2.89 | 0.04 | Lachnospiraceae ASF356 |
| OTU 083 | 0.01 | 0.04 | 2.43 | 0.01 | Ruminococcaceae_UCG-013 |
| OTU 092 | 0.12 | 0.08 | 2.39 | 0.04 | Ruminiclostridium_9 |
| OTU 128 | 0.18 | 0.01 | 2.90 | 0.02 | Lachnospiraceae_unclassified |
| OTU 136 | 0.67 | 0.00 | 3.69 | 0.05 | Faecalibaculum |
| OTU 140 | 0.07 | 0.03 | 2.32 | 0.004 | Lachnospiraceae_unclassified |
| OTU 159 | 0.00 | 0.04 | 2.16 | 0.00 | Lachnospiraceae_NK4A136_group |
| OTU 189 | 0.00 | 0.34 | 3.04 | 0.02 | Muribaculaceae_ge |
| OTU 199 | 0.06 | 0.01 | 2.53 | 0.01 | Lachnoclostridium |

TABLE 33
Significantly different OTUs (P ≤ 0.05) between control and 5^{th} cutting
chloroform extract diets after the feed enrichment period (d14) determined by
LEfSe analysis in mothur.

| | | 5^{th} cutting | | | |
|---|---|---|---|---|---|
| | | chloroform | | | |
| | Control | extract | | | |
| | median | median | | | |
| | relative | relative | LDA | | |
| | abundance | abundance | score | | |
| OTU | (%) | (%) | (log 10) | P-value | Taxonomy |
| OTU 001 | 6.97 | 17.52 | 4.84 | 0.02 | Muribaculaceae_ge |
| OTU 010 | 0.01 | 0.00 | 4.60 | 0.02 | Muribaculaceae ge |
| OTU 012 | 2.86 | 0.00 | 3.99 | 0.04 | Lachnospiraceae_NK4A136_group |
| OTU 018 | 0.16 | 0.62 | 3.28 | 0.04 | Muribaculaceae_ge |
| OTU 022 | 0.60 | 1.09 | 3.20 | 0.02 | Muribaculaceae_ge |
| OTU 025 | 0.38 | 0.08 | 3.19 | 0.02 | Lachnospiraceae A2 |
| OTU 026 | 0.08 | 0.00 | 3.32 | 0.004 | Lachnospiraceae_NK4A136_group |
| OTU 027 | 0.41 | 1.04 | 3.17 | 0.02 | Muribaculaceae_ge |
| OTU 034 | 0.00 | 0.52 | 3.77 | 0.05 | Lachnospiraceae unclassified |
| OTU 036 | 0.64 | 0.03 | 3.41 | 0.04 | Lachnospiraceae_NK4A136_group |
| OTU 038 | 0.09 | 0.00 | 2.84 | 0.03 | Lachnospiraceae_unclassified |
| OTU 040 | 0.02 | 0.29 | 3.57 | 0.01 | Lachnospiraceae_NK4A136_group |
| OTU 046 | 0.01 | 0.27 | 3.37 | 0.01 | uncultured |
| OTU 051 | 0.12 | 0.04 | 2.60 | 0.01 | Lachnospiraceae GCA-900066575 |
| OTU 067 | 0.20 | 0.00 | 2.83 | 0.01 | Lachnospiraceae_NK4A136_group |
| OTU 069 | 0.23 | 0.01 | 3.03 | 0.004 | Lachnoclostridium |
| OTU 075 | 0.34 | 0.02 | 3.10 | 0.01 | ASF356 |
| OTU 077 | 0.14 | 0.30 | 2.54 | 0.02 | Muribaculaceae_ge |
| OTU 083 | 0.01 | 0.13 | 2.80 | 0.01 | Ruminococcaceae UCG-013 |
| OTU 092 | 0.12 | 0.06 | 2.55 | 0.02 | Ruminiclostridium_9 |
| OTU 095 | 0.13 | 0.06 | 2.44 | 0.02 | Lachnospiraceae unclassified |
| OTU 098 | 0.18 | 0.03 | 2.62 | 0.02 | Lachnospiraceae_unclassified |
| OTU 104 | 0.04 | 0.08 | 2.19 | 0.01 | Eggerthellaceae_unclassified |
| OTU 126 | 0.00 | 0.07 | 2.67 | 0.03 | Lachnospiraceae unclassified |
| OTU 150 | 0.12 | 0.01 | 2.52 | 0.04 | Lachnospiraceae_unclassified |
| OTU 159 | 0.00 | 0.04 | 2.65 | 0.01 | Lachnospiraceae_NK4A136_group |
| OTU 172 | 0.05 | 0.00 | 2.57 | 0.02 | Lachnospiraceae_unclassified |
| OTU 199 | 0.06 | 0.00 | 2.54 | 0.01 | Lachnoclostridium |
| OTU 200 | 0.04 | 0.01 | 2.30 | 0.02 | Clostridiales_unclassified |

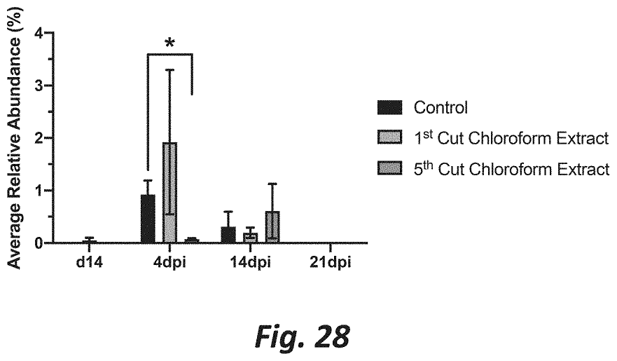

In the earliest timepoint of infection (4 dpi), feeding first cutting chloroform extracts resulted in 36 different OTUs from the control whereas fifth cutting extract resulted in 294 significantly different OTUs from the control. These changes are likely due to the greater relative abundance of 18 OTUs associated with Muribaculaceae and 8 associated with Lachnospiraceae in mice fed fifth cutting chloroform extracts (Table 36). In contrast, feeding first cutting chloroform extract did not increase the relative abundance of any OTUs associated with either of these genera, but reduced the relative abundance of Eryspelatoclostridium (OTU 52) and Roseburia (OTU 81; P=0.03; Table 35). In addition to increasing OTUs associated with Muribaculaceae, fifth cutting chloroform extract reduced the relative abundance of Parasutterella (OTU 20; P=0.04) and Bifidobacterium (OTU 21) compared to control (P=0.02; FIG. 27). The most notable change observed at 4 dpi was the 17- and 13-fold reduction in the median and average relative abundance of C. rodentium (OTU 14), respectively, in the colons of mice fed fifth cutting chloroform extracts compared to the control (P=0.02 FIGS. 27 and 28).

TABLE 34
Significantly different OTUs (P ≤ 0.05) between 1^{st} and 5^{th} cutting chloroform
extract diets after the feed enrichment period (d14) determined by LEfSe
analysis in mothur.

| | 1^{st} cutting | 5^{th} cutting | | | |
|---|---|---|---|---|---|
| | chloroform | chloroform | | | |
| | extract | extract | | | |
| | median | median | | | |
| | relative | relative | LDA | | |
| | abundance | abundance | score | | |
| OTU | (%) | (%) | (log 10) | P-value | Taxonomy |
| OTU 001 | 5.38 | 17.52 | 4.82 | 0.01 | Muribaculaceae_ge |
| OTU 010 | 18.10 | 0.00 | 4.39 | 0.002 | Muribaculaceae_ge |
| OTU 011 | 3.74 | 0.00 | 3.82 | 0.005 | Muribaculaceae_ge |
| OTU 022 | 1.05 | 0.77 | 2.85 | 0.02 | Muribaculaceae_ge |
| OTU 024 | 0.00 | 0.00 | 3.12 | 0.05 | Muribaculaceae ge |
| OTU 027 | 0.23 | 1.04 | 2.98 | 0.01 | Muribaculaceae_ge |
| OTU 036 | 0.44 | 0.03 | 3.09 | 0.02 | Lachnospiraceae_NK4A136_group |
| OTU 038 | 0.05 | 0.00 | 2.55 | 0.02 | Lachnospiraceae_unclassified |
| OTU 046 | 0.04 | 0.27 | 3.33 | 0.04 | uncultured |
| OTU 047 | 0.27 | 0.04 | 3.04 | 0.004 | Lachnospiraceae_unclassified |
| OTU 053 | 0.13 | 0.00 | 3.40 | 0.03 | Lachnospiraceae_unclassified |
| OTU 069 | 0.09 | 0.01 | 2.67 | 0.01 | Lachnoclostridium |
| OTU 070 | 0.08 | 0.33 | 2.35 | 0.02 | Muribaculaceae_ge |
| OTU 076 | 0.39 | 0.00 | 2.80 | 0.01 | Muribaculaceae_ge |
| OTU 077 | 0.06 | 0.30 | 2.28 | 0.01 | Muribaculaceae_ge |
| OTU 084 | 0.38 | 0.00 | 2.75 | 0.01 | Muribaculaceae_ge |
| OTU 085 | 0.36 | 0.00 | 2.73 | 0.01 | Muribaculaceae_ge |
| OTU 106 | 0.74 | 0.00 | 2.96 | 0.02 | Muribaculaceae_ge |
| OTU 115 | 0.66 | 0.00 | 2.94 | 0.02 | Muribaculaceae_ge |
| OTU 131 | 0.10 | 0.00 | 2.31 | 0.02 | Muribaculaceae_ge |
| OTU 134 | 0.09 | 0.00 | 2.33 | 0.01 | Muribaculaceae_ge |
| OTU 138 | 0.09 | 0.00 | 2.18 | 0.01 | Muribaculaceae_ge |
| OTU 142 | 0.00 | 0.12 | 2.64 | 0.05 | Muribaculaceae_ge |
| OTU 144 | 0.03 | 0.00 | 2.18 | 0.01 | Lachnoclostridium |
| OTU 149 | 0.04 | 0.01 | 2.14 | 0.04 | Lachnospiraceae_unclassified |
| OTU 153 | 0.43 | 0.00 | 2.69 | 0.02 | Muribaculaceae_ge |
| OTU 154 | 0.39 | 0.00 | 2.66 | 0.02 | Muribaculaceae_ge |
| OTU 156 | 0.04 | 0.11 | 2.20 | 0.04 | Muribaculaceae_ge |
| OTU 158 | 0.04 | 0.01 | 2.50 | 0.02 | Ruminococcaceae unclassified |
| OTU 166 | 0.02 | 0.06 | 2.27 | 0.01 | Muribaculaceae_ge |
| OTU 169 | 0.36 | 0.00 | 2.70 | 0.02 | Muribaculaceae ge |
| OTU 189 | 0.34 | 0.00 | 2.66 | 0.02 | Muribaculaceae_ge |

TABLE 35
Significantly different OTUs (P ≤ 0.05) between control and
1^{st} cutting chloroform extract diets at 4 dpi with Citrobacter rodentium
determined by LEfSe analysis in mothur.

| | | 1^{st} | | | |
|---|---|---|---|---|---|
| | | cutting | | | |
| | | chloroform | | | |
| | Control | extract | | | |
| | median | median | | | |
| | relative | relative | LDA | | |
| | abundance | abundance | score | | |
| OTU | (%) | (%) | (log 10) | P-value | Taxonomy |
| OTU 006 | 7.04 | 0.05 | 4.45 | 0.03 | Bacteroides |
| OTU 032 | 0.32 | 0.00 | 3.15 | 0.03 | Bacteroides |
| OTU 051 | 0.12 | 0.02 | 2.72 | 0.03 | Lachnospiraceae GCA-900066575 |
| OTU 052 | 0.12 | 0.00 | 2.67 | 0.03 | Erysipelatoclostridium |
| OTU 081 | 0.25 | 0.00 | 3.38 | 0.03 | Roseburia |
| OTU 109 | 0.07 | 0.00 | 2.55 | 0.03 | Ruminococcaceae_UCG-014 |
| OTU 120 | 0.05 | 0.00 | 2.12 | 0.03 | Lachnospiraceae unclassified |
| OTU 129 | 0.04 | 0.00 | 2.62 | 0.03 | uncultured |
| OTU 139 | 0.19 | 0.00 | 2.97 | 0.03 | Muribaculaceae_ge |
| OTU 170 | 0.04 | 0.00 | 2.27 | 0.03 | Muribaculaceae_unclassified |
| OTU 177 | 0.21 | 0.00 | 2.93 | 0.03 | Lachnospiraceae_unclassified |

TABLE 36
Significantly different OTUs (P ≤ 0.05) between control and
5^{th} cutting chloroform extract diets at 4 dpi with Citrobacter rodentium determined
by LEfSe analysis in mothur.

| | | 5^{th} cutting | | | |
|---|---|---|---|---|---|
| | Control | chloroform | | | |
| | median | extract median | LDA | | |
| | relative | relative | score | | |
| | abundance | abundance | (log | | |
| OTU | (%) | (%) | 10) | P-value | Taxonomy |
| OTU 001 | 10.25 | 2.05 | 4.56 | 0.02 | Muribaculaceae ge |
| OTU 002 | 17.18 | 5.76 | 4.76 | 0.02 | Muribaculaceae_ge |
| OTU 003 | 0.02 | 22.32 | 5.05 | 0.02 | Muribaculaceae_ge |
| OTU 006 | 7.04 | 1.97 | 4.45 | 0.02 | Bacteroides |
| OTU 011 | 0.00 | 2.60 | 3.98 | 0.02 | Muribaculaceae ge |
| OTU 014 | 1.02 | 0.06 | 3.64 | 0.02 | Enterobacteriaceae_unclassified |
| OTU 015 | 0.08 | 2.15 | 4.02 | 0.04 | Lachnospiraceae_NK4A136_group |
| OTU 020 | 0.29 | 0.15 | 2.90 | 0.04 | Parasutterella |
| OTU 021 | 0.67 | 0.18 | 3.52 | 0.02 | Bifidobacterium |
| OTU 022 | 0.75 | 0.10 | 3.50 | 0.02 | Muribaculaceae ge |
| OTU 023 | 0.80 | 0.22 | 3.43 | 0.02 | Muribaculaceae_ge |
| OTU 024 | 0.00 | 1.37 | 3.74 | 0.02 | Muribaculaceae_ge |
| OTU 027 | 0.57 | 0.05 | 3.40 | 0.02 | Muribaculaceae_ge |
| OTU 029 | 0.00 | 0.06 | 2.67 | 0.05 | Lachnospiraceae unclassified |
| OTU 030 | 0.00 | 1.07 | 3.65 | 0.02 | Muribaculaceae ge |
| OTU 032 | 0.32 | 0.11 | 3.02 | 0.02 | Bacteroides |
| OTU 037 | 0.00 | 0.85 | 3.60 | 0.02 | Muribaculaceae_ge |
| OTU 038 | 0.00 | 0.09 | 2.60 | 0.02 | Lachnospiraceae unclassified |
| OTU 045 | 0.00 | 0.19 | 2.99 | 0.01 | Muribaculaceae ge |
| OTU 047 | 0.09 | 1.14 | 3.92 | 0.02 | Lachnospiraceae unclassified |
| OTU 048 | 0.00 | 0.25 | 3.04 | 0.01 | Muribaculaceae_ge |
| OTU 054 | 0.00 | 0.21 | 2.93 | 0.01 | Muribaculaceae_ge |
| OTU 066 | 0.00 | 0.57 | 3.35 | 0.01 | Muribaculaceae_ge |
| OTU 068 | 0.00 | 0.15 | 2.86 | 0.01 | Muribaculaceae ge |
| OTU 070 | 0.18 | 0.03 | 2.81 | 0.02 | Muribaculaceae ge |
| OTU 073 | 0.00 | 0.42 | 3.28 | 0.01 | Muribaculaceae_ge |
| OTU 076 | 0.00 | 0.23 | 2.83 | 0.01 | Muribaculaceae_ge |
| OTU 077 | 0.21 | 0.00 | 2.96 | 0.02 | Muribaculaceae_ge |
| OTU 078 | 0.00 | 0.22 | 2.96 | 0.01 | Muribaculaceae ge |
| OTU 084 | 0.00 | 0.13 | 2.63 | 0.01 | Muribaculaceae ge |
| OTU 085 | 0.00 | 0.15 | 2.67 | 0.01 | Muribaculaceae_ge |
| OTU 089 | 0.00 | 0.08 | 2.52 | 0.01 | Muribaculaceae_ge |
| OTU 093 | 0.09 | 0.07 | 2.45 | 0.02 | Lachnoclostridium |
| OTU 119 | 0.00 | 0.07 | 2.73 | 0.04 | Lachnospiraceae_unclassified |
| OTU 122 | 0.03 | 0.00 | 2.40 | 0.02 | Ruminiclostridium |
| OTU 131 | 0.00 | 0.12 | 2.58 | 0.01 | Muribaculaceae_ge |
| OTU 145 | 0.00 | 0.19 | 3.13 | 0.02 | Lachnospiraceae_unclassified |
| OTU 149 | 0.01 | 0.08 | 2.53 | 0.02 | Lachnospiraceae_unclassified |
| OTU 151 | 0.06 | 0.00 | 2.31 | 0.02 | Muribaculaceae_ge |
| OTU 156 | 0.07 | 0.00 | 2.51 | 0.01 | Muribaculaceae ge |
| OTU 161 | 0.04 | 0.00 | 2.58 | 0.02 | Lachnospiraceae unclassified |
| OTU 163 | 0.00 | 0.14 | 2.98 | 0.02 | Lachnospiraceae_unclassified |
| OTU 170 | 0.04 | 0.00 | 2.43 | 0.02 | Muribaculaceae_unclassified |
| OTU 177 | 0.21 | 0.00 | 3.11 | 0.02 | Lachnospiraceae_unclassified |
| OTU 187 | 0.00 | 0.03 | 2.14 | 0.01 | Muribaculaceae ge |

At 14 dpi, the number of significantly different OTUs between both chloroform extracts and the control did not differ greatly, with 127 different OTUs in mice fed first cutting chloroform extract and 135 in those fed fifth cutting. Both chloroform extracts had greater relative abundance of Turicibacter (OTU 13) compared to control (P=0.02), with fifth cutting chloroform extracts having 12.2-fold greater abundance of this OTU compared to first cutting (P=0.02; FIG. 27). Mice fed first cutting chloroform extracts had increased relative abundance of Bifidobacterium (OTU 21; P=0.02) and Romboutsia (OTU 39) compared to both the control and fifth cutting extracts (P=0.04 and 0.02, respectively; Table 38 and Table 40). Feeding fifth cutting chloroform extracts had greater impacts on highly abundant OTUs associated with Muribaculaceae at this timepoint, with increases to OTUs 3, 10, and 24 compared to control and first cutting (OTU 3 only; FIG. 27). Feeding fifth cutting chloroform resulted in a decreased relative abundance of Roseburia (OTU 81) compared to control and first cutting extract (P=0.01 and 0.05, respectively; Table 39).

TABLE 37
Significantly different OTUs (P ≤ 0.05) between 1^{st} and 5^{th}
cutting chloroform extract diets at 4 dpi with Citrobacter rodentium
determined by LEfSe analysis in mothur.

| | 1^{st} cutting | 5^{th} cutting | | | |
|---|---|---|---|---|---|
| | chloroform | chloroform | | | |
| | extract median | extract median | | | |
| | relative | relative | LDA | | |
| | abundance | abundance | score | | |
| OTU | (%) | (%) | (log 10) | P-value | Taxonomy |
| OTU 003 | 0.03 | 22.32 | 5.11 | 0.03 | Muribaculaceae_ge |
| OTU 011 | 0.00 | 2.60 | 4.11 | 0.03 | Muribaculaceae_ge |
| OTU 024 | 0.00 | 1.37 | 3.85 | 0.03 | Muribaculaceae_ge |
| OTU 030 | 0.01 | 1.07 | 3.76 | 0.03 | Muribaculaceae_ge |
| OTU 037 | 0.00 | 0.85 | 3.70 | 0.03 | Mitribaculaceae_ge |
| OTU 047 | 0.16 | 1.14 | 3.71 | 0.03 | Lachnospiraceae_unclassified |
| OTU 052 | 0.00 | 0.05 | 2.60 | 0.03 | Erysipelatoclostridium |
| OTU 066 | 0.00 | 0.57 | 3.51 | 0.03 | Muribaculaceae_ge |
| OTU 073 | 0.00 | 0.42 | 3.42 | 0.03 | Muribaculaceae ge |
| OTU 076 | 0.00 | 0.23 | 3.08 | 0.03 | Muribaculaceae_ge |
| OTU 078 | 0.00 | 0.22 | 3.04 | 0.03 | Muribaculaceae_ge |
| OTU 083 | 0.01 | 0.25 | 3.08 | 0.03 | Ruminococcaceae_UCG013 |
| OTU 085 | 0.00 | 0.15 | 2.88 | 0.03 | Muribaculaceae_ge |
| OTU 089 | 0.00 | 0.08 | 2.59 | 0.03 | Muribaculaceae ge |
| OTU 130 | 0.01 | 0.04 | 2.53 | 0.03 | Lachnospiraceae_unclassified |
| OTU 131 | 0.00 | 0.12 | 2.80 | 0.03 | Muribaculaceae_ge |
| OTU 145 | 0.00 | 0.19 | 2.89 | 0.03 | Lachnospiraceae unclassified |
| OTU 158 | 0.02 | 0.05 | 2.30 | 0.03 | Ruminococcaceae_unclassified |

TABLE 38
Significantly different OTUs (P ≤ 0.05) between control and
1^{st} cutting chloroform extract diets at 14 dpi with Citrobacter rodentium determined by
LEfSe analysis in mothur.

| | | 1^{st} cutting | | | |
|---|---|---|---|---|---|
| | | chloroform | | | |
| | Control | extract | | | |
| | median | median | | | |
| | relative | relative | LDA | | |
| | abundance | abundance | score | | |
| OTU | (%) | (%) | (log 10) | P-value | Taxonomy |
| OTU 007 | 11.71 | 3.71 | 4.49 | 0.02 | Lachnospiraceae_NK4A136_group |
| OTU 011 | 0.22 | 0.00 | 2.85 | 0.02 | Muribaculaceae_ge |
| OTU 013 | 0.14 | 0.37 | 3.34 | 0.02 | Turicibacter |
| OTU 015 | 0.00 | 0.76 | 4.04 | 0.04 | Lachnospiraceae_NK4A136_group |
| OTU 021 | 0.00 | 0.94 | 3.85 | 0.02 | Bifidobacterium |
| OTU 038 | 1.10 | 0.00 | 3.74 | 0.02 | Lachnospiraceae_unclassified |
| OTU 039 | 0.26 | 1.62 | 3.92 | 0.04 | Romboutsia |
| OTU 058 | 0.50 | 0.15 | 2.98 | 0.04 | Lachnospiraceae_unclassified |
| OTU 108 | 0.06 | 0.00 | 2.76 | 0.05 | Clostridiales_vadinBB60_group_ge |
| OTU 112 | 0.11 | 0.03 | 2.52 | 0.04 | Lachnospiraceae_unclassified |
| OTU 119 | 0.00 | 0.21 | 3.27 | 0.02 | Lachnospiraceae_unclassified |
| OTU 144 | 0.06 | 0.00 | 2.56 | 0.01 | Lachnoclostridium |
| OTU 146 | 0.02 | 0.00 | 2.02 | 0.05 | Lachnospiraceae_NK4A136_group |
| OTU 168 | 0.13 | 0.03 | 2.40 | 0.02 | Lachnospiraceae_NK4A136_group |
| OTU 180 | 0.05 | 0.00 | 3.22 | 0.02 | Clostridiales_vadinBB60_group_ge |

TABLE 39
Significantly different OTUs (P ≤ 0.05) between control and
5^{th} cutting chloroform extract diets at 14 dpi with Citrobacter rodentium
determined by LEfSe analysis in mothur.

| | | 5^{th} cutting | | | |
|---|---|---|---|---|---|
| | Control | chloroform | | | |
| | median | extract median | | | |
| | relative | relative | LDA | | |
| | abundance | abundance | score | | |
| OTU | (%) | (%) | (log 10) | P-value | Taxonomy |
| OTU 003 | 0.02 | 0.35 | 3.22 | 0.02 | Muribaculaceae_ge |
| OTU 010 | 0.00 | 0.14 | 2.85 | 0.04 | Muribaculaceae ge |
| OTU 013 | 0.14 | 1.71 | 3.83 | 0.02 | Turicibacter |
| OTU 024 | 0.00 | 0.03 | 2.18 | 0.05 | Muribaculaceae_ge |
| OTU 034 | 0.02 | 1.28 | 3.80 | 0.04 | Lachnospiraceae_unclassified |
| OTU 040 | 0.03 | 0.39 | 3.23 | 0.02 | Lachnospiraceae_NK4A136_group |
| OTU 043 | 0.01 | 2.66 | 4.11 | 0.02 | Lachnospiraceae_NK4A136_group |
| OTU 054 | 0.00 | 0.05 | 2.44 | 0.05 | Muribaculaceae_ge |
| OTU 055 | 0.00 | 0.06 | 2.49 | 0.01 | Clostridium sensu stricto 1 |
| OTU 063 | 0.15 | 0.02 | 2.81 | 0.02 | Lachnospiraceae_NK4A136_group |
| OTU 068 | 0.00 | 0.02 | 2.05 | 0.05 | Muribaculaceae_ge |
| OTU 081 | 0.03 | 0.00 | 2.99 | 0.01 | Roseburia |
| OTU 089 | 0.00 | 0.04 | 2.26 | 0.05 | Muribaculaceae_ge |
| OTU 103 | 0.09 | 0.13 | 2.46 | 0.04 | Ruminiclostridium_9 |
| OTU 144 | 0.06 | 0.29 | 3.05 | 0.04 | Lachnoclostridium |
| OTU 194 | 0.02 | 0.00 | 2.07 | 0.02 | Ruminiclostridium 5 |
| OTU 198 | 0.04 | 0.00 | 2.29 | 0.04 | Lachnospiraceae_UCG-004 |

TABLE 40
Significantly different OTUs (P ≤ 0.05) between 1^{st} and 5^{th}
cutting chloroform extract diets at 14 dpi with Citrobacter rodentium
determined by LEfSe analysis in mothur.

| | 1^{st} cutting | 5^{th} cutting | | | |
|---|---|---|---|---|---|
| | chloroform | chloroform | | | |
| | extract | extract | | | |
| | median | median | | | |
| | relative | relative | LDA | | |
| | abundance | abundance | score | | |
| OTU | (%) | (%) | (log 10) | P-value | Taxonomy |
| OTU 003 | 0.02 | 0.35 | 3.22 | 0.02 | Muribaculaceae_ge |
| OTU 013 | 0.37 | 1.71 | 3.65 | 0.02 | Turicibacter |
| OTU 018 | 0.89 | 0.45 | 3.19 | 0.04 | Muribaculaceae_ge |
| OTU 021 | 0.94 | 0.00 | 3.85 | 0.02 | Bifidobacterium |
| OTU 024 | 0.00 | 0.03 | 2.18 | 0.05 | Muribaculaceae_ge |
| OTU 038 | 0.00 | 1.30 | 3.81 | 0.02 | Lachnospiraceae_unclassified |
| OTU 039 | 1.62 | 0.35 | 3.89 | 0.02 | Romboutsia |
| OTU 043 | 0.00 | 2.66 | 4.11 | 0.01 | Lachnospiraceae_NK4A136_group |
| OTU 054 | 0.00 | 0.05 | 2.44 | 0.05 | Muribaculaceae ge |
| OTU 055 | 0.00 | 0.06 | 2.49 | 0.02 | Clostridium_sensu_stricto_1 |
| OTU 068 | 0.00 | 0.02 | 2.05 | 0.05 | Muribaculaceae_ge |
| OTU 076 | 0.00 | 0.05 | 2.43 | 0.05 | Muribaculaceae_ge |
| OTU 081 | 0.03 | 0.00 | 2.94 | 0.05 | Roseburia |
| OTU 084 | 0.00 | 0.05 | 2.37 | 0.05 | Muribaculaceae ge |
| OTU 089 | 0.00 | 0.04 | 2.27 | 0.05 | Muribaculaceae_ge |
| OTU 130 | 0.04 | 0.01 | 2.05 | 0.02 | Lachnospiraceae_unclassified |
| OTU 138 | 0.00 | 0.05 | 2.38 | 0.05 | Muribaculaceae ge |
| OTU 144 | 0.00 | 0.29 | 3.16 | 0.01 | Lachnoclostridium |
| OTU 175 | 0.00 | 0.16 | 2.88 | 0.02 | Lachnospiraceae unclassified |
| OTU 180 | 0.00 | 0.03 | 2.12 | 0.02 | Clostridiales_vadinBB60_group_ge |

In the last timepoint of the study corresponding with resolution of infection (21 dpi), mice fed first cutting chloroform extracts had 129 significantly different OTUs compared to the control whereas mice fed fifth cutting extracts had 238 different OTUs. Both extracts had greater abundance of Akkermansia (OTU 8) compared to control (P=0.04 and 0.02; FIG. 27); however, fifth cutting extract increased the relative abundance of Akkermansia (OTU 125) 9- and 3.6-fold, respectively, compared to both the control and first cutting extract (P=0.02 and 0.04; Table 42 and Table 43). At this timepoint, mice fed first cutting chloroform extract had increased relative abundance of Roseburia (OTU 81) compared to control and fifth cutting (P=0.04), with additional increases in Mollicutes (OTU 72) compared to control (P=0.05) (See Table 41). Mice fed fifth cutting chloroform extract had reductions in the relative abundance of Oscillibacter (OTU 31) compared to control and first cutting (P=0.04 and 0.02, respectively; Table 42).

TABLE 41
Significantly different OTUs (P ≤ 0.05) between control and
1^{st} cutting chloroform extract diets at 21dpi with Citrobacter rodentium
determined by LEfSe analysis in mothur.

| | | 1^{st} cutting | | | |
|---|---|---|---|---|---|
| | | chloroform | | | |
| | Control | extract | | | |
| | median | median | | | |
| | relative | relative | LDA | | |
| | abundance | abundance | score | | |
| OTU | (%) | (%) | (log 10) | P-value | Taxonomy |
| OTU 008 | 1.71 | 3.87 | 3.84 | 0.04 | Akkermansia |
| OTU 010 | 0.61 | 0.00 | 3.60 | 0.02 | Muribaculaceae_ge |
| OTU 015 | 0.94 | 0.00 | 3.67 | 0.05 | Lachnospiraceae_NK4A136_group |
| OTU 016 | 0.77 | 0.00 | 3.58 | 0.04 | Lachnospiraceae_UCG-001 |
| OTU 018 | 0.25 | 0.97 | 3.56 | 0.02 | Muribaculaceae_ge |
| OTU 028 | 0.23 | 0.01 | 3.45 | 0.02 | Anaeroplasma |
| OTU 029 | 0.49 | 0.00 | 3.39 | 0.02 | Lachnospiraceae unclassified |
| OTU 040 | 0.55 | 0.02 | 3.34 | 0.02 | Lachnospiraceae_NK4A136_group |
| OTU 049 | 0.24 | 0.00 | 3.08 | 0.05 | Lachnospiraceae UCG-001 |
| OTU 053 | 0.003 | 0.00 | 3.28 | 0.05 | Lachnospiraceae_unclassified |
| OTU 059 | 0.13 | 0.01 | 2.79 | 0.02 | Lachnoclostridium |
| OTU 072 | 0.00 | 0.005 | 2.19 | 0.05 | Mollicutes_RF39_ge |
| OTU 081 | 0.00 | 0.51 | 3.24 | 0.04 | Roseburia |
| OTU 095 | 0.04 | 0.00 | 2.18 | 0.04 | Lachnospiraceae_unclassified |
| OTU 107 | 0.04 | 0.00 | 2.46 | 0.02 | Lachnospiraceae A2 |
| OTU 115 | 0.02 | 0.00 | 2.16 | 0.01 | Muribaculaceae_ge |
| OTU 119 | 0.00 | 0.08 | 2.50 | 0.02 | Lachnospiraceae_unclassified |
| OTU 163 | 0.04 | 0.00 | 2.27 | 0.05 | Lachnospiraceae_unclassified |
| OTU 165 | 0.00 | 0.05 | 2.22 | 0.05 | Bacteroides |
| OTU 175 | 0.02 | 0.00 | 2.36 | 0.05 | Lachnospiraceae_unclassified |

TABLE 42
Significantly different OTUs (P ≤ 0.05) between control and
5^{th} cutting chloroform extract diets at 21 dpi with Citrobacter rodentium
determined by LEfSe analysis in mothur.

| | | 5^{th} cutting | | | |
|---|---|---|---|---|---|
| | Control | chloroform | | | |
| | median | extract median | | | |
| | relative | relative | LDA | | |
| | abundance | abundance | score | | |
| OTU | (%) | (%) | (log 10) | P-value | Taxonomy |
| OTU 006 | 1.95 | 7.67 | 4.25 | 0.04 | Bacteroides |
| OTU 008 | 1.71 | 11.98 | 4.45 | 0.02 | Akkermansia |
| OTU 010 | 0.61 | 0.00 | 3.51 | 0.02 | Muribaculaceae_ge |
| OTU 028 | 0.23 | 0.00 | 3.36 | 0.04 | Anaeroplasma |
| OTU 029 | 0.49 | 0.00 | 3.48 | 0.01 | Lachnospiraceae_unclassified |
| OTU 031 | 0.10 | 0.03 | 2.79 | 0.04 | Oscillibacter |
| OTU 032 | 0.09 | 0.45 | 3.00 | 0.04 | Bacteroides |
| OTU 033 | 0.16 | 0.03 | 2.87 | 0.02 | Lachnospiraceae_NK4A136_group |
| OTU 040 | 0.55 | 0.01 | 3.42 | 0.02 | Lachnospiraceae_NK4A136_group |
| OTU 042 | 0.17 | 0.00 | 3.06 | 0.02 | Ruminiclostridium 5 |
| OTU 043 | 0.18 | 0.00 | 3.40 | 0.02 | Lachnospiraceae_NK4A136_group |
| OTU 056 | 0.14 | 0.00 | 2.96 | 0.04 | Ruminiclostridium |
| OTU 059 | 0.13 | 0.00 | 3.09 | 0.01 | Lachnoclostridium |
| OTU 062 | 0.11 | 0.00 | 2.99 | 0.04 | Ruminococcaceae unclassified |
| OTU 063 | 0.13 | 0.00 | 2.90 | 0.02 | Lachnospiraceae_NK4A136_group |
| OTU 065 | 0.23 | 0.00 | 3.17 | 0.05 | Lachnospiraceae_unclassified |
| OTU 069 | 0.03 | 0.00 | 2.97 | 0.04 | Lachnoclostridium |
| OTU 076 | 0.15 | 0.06 | 2.73 | 0.02 | Muribaculaceae ge |
| OTU 086 | 0.04 | 0.01 | 2.65 | 0.02 | uncultured |
| OTU 090 | 0.06 | 0.00 | 2.61 | 0.02 | Lachnospiraceae_unclassified |
| OTU 093 | 0.06 | 0.00 | 2.53 | 0.02 | Lachnoclostridium |
| OTU 096 | 0.00 | 0.00 | 2.14 | 0.05 | Ruminococcaceae ge |
| OTU 102 | 0.04 | 0.00 | 2.41 | 0.02 | Lachnospiraceae UCG-006 |
| OTU 107 | 0.04 | 0.00 | 2.33 | 0.04 | Lachnospiraceae A2 |
| OTU 111 | 0.05 | 0.01 | 2.38 | 0.02 | Lachnospiraceae_unclassified |
| OTU 115 | 0.02 | 0.00 | 2.03 | 0.01 | Muribaculaceae_ge |
| OTU 123 | 0.04 | 0.00 | 2.33 | 0.05 | Ruminococcaceae_UCG-010 |
| OTU 125 | 0.02 | 0.18 | 2.67 | 0.02 | Akkermansia |
| OTU 126 | 0.08 | 0.00 | 2.86 | 0.02 | Lachnospiraceae unclassified |
| OTU 143 | 0.04 | 0.00 | 2.18 | 0.02 | Ruminococcaceae_unclassified |
| OTU 144 | 0.05 | 0.01 | 2.07 | 0.04 | Lachnoclostridium |
| OTU 149 | 0.02 | 0.00 | 2.26 | 0.05 | Lachnospiraceae_unclassified |
| OTU 159 | 0.03 | 0.00 | 2.33 | 0.01 | Lachnospiraceae_NK4A136_group |
| OTU 163 | 0.04 | 0.00 | 2.53 | 0.05 | Lachnospiraceae_unclassified |
| OTU 175 | 0.02 | 0.00 | 2.22 | 0.05 | Lachnospiraceae_unclassified |
| OTU 192 | 0.03 | 0.00 | 2.26 | 0.02 | Lachnospiraceae_unclassified |
| OTU 197 | 0.03 | 0.00 | 2.26 | 0.05 | Acetatifactor |
| OTU 198 | 0.04 | 0.00 | 2.25 | 0.04 | Lachnospiraceae UCG-004 |

TABLE 43
Significantly different OTUs (P ≤ 0.05) between 1^{st} and 5^{th}
cutting chloroform extract diets at 21 dpi with Citrobacter rodentium
determined by LEfSe analysis in mothur.

| | 1^{st} cutting | 5^{th} cutting | | | |
|---|---|---|---|---|---|
| | chloroform | chloroform | | | |
| | extract | extract | | | |
| | median | median | LDA | | |
| | relative | relative | score | | |
| | abundance | abundance | (log | | |
| OTU | (%) | (%) | 10) | P-value | Taxonomy |
| OTU 031 | 0.24 | 0.03 | 2.94 | 0.02 | Oscillibacter |
| OTU 034 | 0.44 | 0.19 | 3.30 | 0.02 | Lachnospiraceae_unclassified |
| OTU 042 | 0.13 | 0.00 | 2.83 | 0.02 | Ruminiclostridium_5 |
| OTU 057 | 0.00 | 0.005 | 2.63 | 0.05 | Lachnospiraceae_unclassified |
| OTU 062 | 0.09 | 0.00 | 2.47 | 0.02 | Ruminococcaceae_unclassified |
| OTU 063 | 0.12 | 0.00 | 2.64 | 0.02 | Lachnospiraceae_NK4A136_group |
| OTU 071 | 0.15 | 0.00 | 2.51 | 0.04 | Clostridiales_vadinBB60_group_ge |
| OTU 081 | 0.51 | 0.00 | 3.17 | 0.04 | Roseburia |
| OTU 093 | 0.05 | 0.00 | 2.28 | 0.02 | Lachnoclostridium |
| OTU 102 | 0.05 | 0.00 | 2.26 | 0.02 | Lachnospiraceae_UCG-006 |
| OTU 104 | 0.07 | 0.04 | 2.07 | 0.02 | Eggerthellaceae_unclassified |
| OTU 111 | 0.04 | 0.01 | 2.03 | 0.04 | Lachnospiraceae_unclassified |
| OTU 119 | 0.08 | 0.00 | 2.50 | 0.02 | Lachnospiraceae_unclassified |
| OTU 122 | 0.05 | 0.01 | 2.20 | 0.04 | Ruminiclostridium |
| OTU 123 | 0.03 | 0.00 | 2.20 | 0.05 | Ruminococcaceae_UCG-010 |
| OTU 124 | 0.04 | 0.00 | 2.24 | 0.02 | Ruminiclostridium_9 |
| OTU 125 | 0.05 | 0.18 | 2.61 | 0.04 | Akkermansia |
| OTU 126 | 0.04 | 0.00 | 2.23 | 0.02 | Lachnospiraceae_unclassified |
| OTU 129 | 0.01 | 0.00 | 2.33 | 0.02 | uncultured |
| OTU 131 | 0.07 | 0.03 | 2.53 | 0.04 | Muribaculaceae_ge |
| OTU 134 | 0.14 | 0.02 | 2.87 | 0.04 | Muribaculaceae ge |
| OTU 159 | 0.03 | 0.00 | 2.23 | 0.01 | Lachnospiraceae_NK4A136_group |
| OTU 161 | 0.04 | 0.00 | 2.48 | 0.04 | Lachnospiraceae_unclassified |

Kirby-Bauer Plates

None of the extracts resulted in an observable ZOI in C. rodentium culture plates following overnight incubation at any of the tested concentrations.

Microbiota Impact

Alterations to the colonic microbiota in response to alfalfa supplementation varied between form and cutting at different timepoints during 14 d enrichment and after inoculation. Changes to the colon microbiota between different supplementation forms after the 14 d feeding enrichment were predictable based on the presence of fiber. Both first and fifth cutting hay resulted in significant changes to whole community composition, while changes observed in extract diets were limited to fifth cutting alfalfa (Tables 5-7). These consistent, comparatively larger changes to the microbiota in mice fed hay compared to extract-supplemented diets were expected due to the high amounts of insoluble fiber in the ground hay (34.3 and 24.6% as-fed in first and fifth cutting, respectively) acting as a fermentation substrate.

Despite consistent changes to the overall community by alfalfa hay, changes at the OTU level varied between each cutting and could be roughly traced to a specific compartment within the plant. In healthy animals, first cutting hay only increased the relative abundance of Lachnospiraceae OTUs, while fifth cutting hay also increased the relative abundance of multiple OTUs associated with Muribaculaeae, a family that is generally regarded as beneficial despite limited knowledge about the function of its members beyond the breakdown of complex carbohydrates (Tables 6 and 7). Chloroform extracts from fifth cutting alfalfa similarly increased the relative abundance ofMuribaculaceae OTUs compared to both control and first cutting chloroform extract (FIG. 27), while aqueous extracts generally did not affect this family. These results indicate that changes to highly-abundant Muribaculaceae OTUs were specific to fifth cutting alfalfa and could be attributed to the lipid-soluble compartment of the plant.

While differences in response by the microbiota of healthy animals were observed between cuttings and supplementation forms, similarities in BW and colon crypt depth after the feeding enrichment period indicate that observed microbial shifts did not affect these general health indicators.

Functional characteristics of changes to the microbiota at a health state can be assessed through the implementation of a health challenge. In this study, the rodent-specific pathogen C. rodentium was administered to study how alfalfa-induced changes to the microbiota translated to altered responses to a bacterial pathogen. Infection with C. rodentium is characterized by dysbiosis as an overgrowth of the bacteria displaces members of the commensal microbiota. Prior to infection, C. rodentium was not detected in the colon microbiota of healthy mice. After infection, Citrobacter rodentium was identified as OTU 14 and present in the microbiota at 4 dpi before reducing to low or undetectable relative abundance at 14 and 21 dpi (FIGS. 25-27). Mice fed the control had a 1.0% median relative abundance of C. rodentium at 4 dpi and the highest abundances were observed in mice fed fifth cutting hay (4.1%) and aqueous extract (7.8%; FIGS. 25 and 26). Of all the treatments, only fifth cutting chloroform extract reduced the relative abundance of C. rodentium compared to control at 4 dpi (FIG. 27). These reductions were not due to direct action of the extract on the pathogen, as evidenced by the lack of inhibition observed in the disc diffusion assay but may be due to indirect effects on the microbiota or host immune system. Regardless, the effects of reduced pathogen abundance were seen in BW responses, which showed a recovery to pre-inoculation BW in mice fed fifth cutting chloroform at 2 dpi. These results suggest that only the lipid-soluble components of fifth cutting alfalfa reduce the ability of C. rodentium to colonize the colon and protect BW during early infection, whereas water-soluble components may facilitate colonization-resulting in an intermediate response when the plant is fed in its entirety.

As C. rodentium was cleared in later timepoints of infection (14 and 21 dpi), differences in beneficial community members were observed in response to alfalfa form and cutting. Only mice fed fifth cutting chloroform extracts continued to show changes in high numbers of OTUs associated with Muribaculaceae at 14 dpi, suggesting that this treatment continued to exert protective effects on this family throughout the infection.

Fifth cutting hay increased relative abundance of Turicibacter (OTU 13) compared to first cutting, while fifth cutting chloroform extract increased Turicibacter compared to control and first cutting chloroform extract, indicating that lipid-soluble compounds enriched at later cuttings have greater impact on this genus. In chickens, increased relative abundance of members within this genus was associated with a high residual feed intake (RFI; 39).

Notably, mice fed fifth cutting hay had numerically higher median relative abundance of Turicibacter (1.92) compared to those fed fifth cutting chloroform extract (1.71). During this time, mice fed chloroform extracts had higher average BW despite lower feed intake, whereas mice fed ground hay had the highest FI and lowest BW. While performance measurements such as RFI are not typically recorded for mice, these results suggest that lipid-soluble compounds in late-cutting alfalfa increased the abundance of Turicibacter and contributed to a similar “low RFI” phenotype to reports in poultry; however, changes to this genus could not compensate for the effects of low-energy, high-fiber diets on animal BW.

At 21 dpi, both chloroform extracts increased the relative abundance of Akkermansia (OTU 8) compared to control, but fifth cutting chloroform extract increased the relative abundance of an additional OTU associated with this genus (OTU 125) compared to first cutting extract (FIG. 27; Table 43). Members of the Akkermansia genus are considered to be beneficial members of the microbiota with a number of documented benefits on gut barrier function and immunity (40). While first cutting aqueous extract also increased the relative abundance of Akkermansia (OTU 8) at 21 dpi, this treatment also reduced the relative abundance of Bifidobacterium, a genus whose members are linked to a number of health benefits and used commonly as a probiotic. As mice fed both chloroform extracts had increased BW over the control in the final days of the trial, the increased abundance of Akkermansia over the control by both supplementation forms coupled with preservation of Bifidobacterium abundance may have contributed to improvements in final BW.

Overall, the results of this study show noteworthy changes to the microbiota of mice fed alfalfa-supplemented diets with more consistent benefits observed in mice fed chloroform extracts of fifth cutting alfalfa. While changes to the microbiota were noted in several treatments before and after infection, only fifth cutting chloroform extracts reduced the relative abundance of C. rodentium at early stages post-inoculation. The underlying cause contributing to reduced pathogen abundance remains unclear; however, it is probable that reduced pathogen abundance translated to a protective effect on BW at early post-inoculation timepoints. Diets supplemented with chloroform extracts increased mouse BW compared to the control in later post-inoculation timepoints and underlying changes to beneficial genera by these extracts may be contributing to the observed phenotype. Despite similar responses between cuttings, fifth cutting chloroform extracts had the greatest relative abundance of these genera, suggesting that lipid-soluble compounds of late-cutting alfalfa beneficially modulate the microbiota to protect and improve mouse BW throughout infection with C. rodentium.

Additional details and examples are provided in K. A. Craft, Lipid-soluble compounds in late-cutting alfalfa maximize host immune responses and beneficially modulate the colon microbiota of mice during Citrobacter rodentium infection (2019), which is herein incorporated by reference in its entirety.

### Example 5. Poultry Feed Evaluation

A 42-day research study was conducted using chloroform alfalfa extracts. A total of 576 Ross 708 broilers were housed in 16 floor pens (18 birds/pen) and randomly assigned to 1 of 2 experimental diets comprising ±0.25% chloroform extract of fifth cutting alfalfa (144 birds/diet). Animals were given ad libitum access to feed and water for the duration of the study. At day 14, half of the birds in each treatment were orally gavaged with 10× Coccivac®-B52 vaccine containing oocysts of Eimeria mivati, E. tenella, E. acervulina, and E. maxima (Merck, Kenilworth, N.J.) as part of a coccidiosis challenge. This resulted in a factorial treatment arrangement of diet (control or extract) and Eimeria status (healthy or inoculated). Body and feeder weights were collected on a weekly basis to calculate body weight gain (BWG), feed intake (FI) and feed conversion ratio (FCR; FCR=FI/BWG) per bird. Blood was collected at d14 (baseline), 3, 7, 14, and 28 d post-inoculation (pi) to isolate peripheral blood mononuclear cells and flow cytometry was done to identify systemic immune cell populations throughout the challenge.

Dietary alfalfa extract inclusion during the starter period (days 0-14) increased BWG by 6.8% and FI by 5.8% (P=0.04 and 0.02, respectively). This resulted in 2 points numerically more efficient FCR in birds fed alfalfa extract during the starter period compared to birds on control diets as shown in Tables 45 and 46.

Weekly performance data indicated that changes between the two diets were observed primarily between weeks 1 and 2 (d7-14); however, numerically improved performance in week 1 suggests that alfalfa extract can improve bird performance in the first days of production when they are consuming overall less feed per bird per day. In week 2, birds fed diets containing the extract weighed 5.9% more, gained 8.4% more weight, and ate 7.0% more feed than the control (P=0.04, 0.03, and 0.01, respectively). As shown in Tables 47-48, extract-fed birds had a 1 and 2 point (1.0 and 1.6%) more efficient FCR compared to the control in weeks 1 and 2, respectively.

More particularly, with respect to Tables 44-48, the grower period represents the 14 d following Eimeria inoculation and represents a period of time where performance was greatly reduced by coccidiosis, as expected. While the main effect of Eimeria inoculation predictably reduced BWG (12.2%; P=0.002), FI (8.2%; P=0.003), and contributed to a 4 point efficiency loss (4.1%; P=0.05), extract inclusion did not have a significant effect on performance outcomes during coccidiosis. Importantly, as shown in Tables 44-46, extract inclusion numerically increased BWG and FI in inoculated birds by 1.4% (10 g) and 3.8% (44 g) compared to the inoculated control in the grower period. This outcome suggests that 5^{th} cutting alfalfa chloroform extract may protect BWG and FI during coccidiosis, an outcome that was similarly observed in the preliminary mouse trial. Numeric differences in weekly performance outcomes additionally show that inoculated birds on extract diets weighed 2.9% (18 g and 32 g) more than inoculated birds on the control in weeks 3 and 4. As shown in Tables 47-48, within groups of non-inoculated healthy birds, extract similarly increased BW in weeks 3 and 4 by 4.7% (35 g) and 1.1% (13 g), respectively-suggesting that alfalfa extract generally contributes to a greater BW compared to control in both healthy and Eimeria-inoculated broilers.

In the finisher period (d28-35), the main effect of Eimeria inoculation does not have a significant effect on performance, suggesting that birds have recovered from the challenge by this period. While alfalfa extract does not have a significant impact on many performance outcomes during this time, birds on extract diets ate 7.3% more than those on the control regardless of health status (P=0.02). Notably, healthy birds on extract diets had a 3 point (1.5%) numerically more efficient finisher FCR than healthy birds on the control diet. As evidenced by Table 46 (where P=0.02), for the entire 42 d study, birds on extract diets ate 5.7% more than birds on the control diet, regardless of health status. This can be interpreted as a positive outcome as a typical response to an immune challenge is to reduce feed intake which in turn reduces performance negatively. Diets which promote feed intake, especially during metabolically expensive immune challenges may help birds recover more quickly from a challenge compared to birds who remain off feed.

When looking at the weekly performance data, the increased FI in extract-containing diets is consistent in weeks 5 and 6 with birds eating 9.1% more than the control in week 6, regardless of health status (P=0.03). Notably, in weeks 5 and 6 inoculated birds on extract-containing diets weighed numerically more by 3.6% (61 g) and 3.5% (83 g) than inoculated birds on the control diet. Similarly, healthy birds on extract diets weighed numerically more by 2.5% (45 g) and 4.9% (119 g) than healthy control in weeks 5 and 6, respectively. When looking at week 6 BW data in addition to overall FCR, it is noted that healthy birds on extract diets have greater BW than healthy controls while having a similar FCR suggesting that birds grow to a larger size when fed chloroform extract of 5^{th} cutting alfalfa without sacrificing efficiency. In Eimeria-inoculated birds, extract contributed to numerically greater BW at d42 compared to inoculated birds on the control diet. While increased FI in the early stages post-inoculation may have had downstream impacts on overall FCR for the entire 42 d study it may have improved underlying physiological outcomes in the intestine during coccidiosis.

TABLE 44
Composition of starter, grower, and finisher
diets fed to Ross 708 broilers for 42 days

| | Experimental Diet | | | | | |
|---|---|---|---|---|---|---|
| | Control | Extract | Control | Extract | Control | Extract |
| Ingredient, % | Starter | Starter | Grower | Grower | Finisher | Finisher |
| Corn | 53.59 | 53.34 | 60.73 | 60.48 | 63.67 | 63.42 |
| Soybean Meal, | 37.75 | 37.75 | 31.80 | 31.80 | 28.00 | 28.00 |
| 48% CP | | | | | | |
| Soybean Oil | 2.51 | 2.52 | 2.67 | 2.67 | 3.86 | 3.86 |
| Salt | 0.35 | 0.35 | 0.36 | 0.36 | 0.36 | 0.36 |
| DL-Met | 0.35 | 0.35 | 0.30 | 0.30 | 0.26 | 0.26 |
| L-Lys*HCL | 0.25 | 0.25 | 0.22 | 0.22 | 0.18 | 0.18 |
| L-Thr | 0.12 | 0.12 | 0.14 | 0.14 | 0.03 | 0.03 |
| Limestone | 2.00 | 2.00 | 0.91 | 0.91 | 0.70 | 0.70 |
| Dicalcium | 2.05 | 2.06 | 1.82 | 1.82 | 1.82 | 1.82 |
| Phosphate | | | | | | |
| Choline | 0.40 | 0.40 | 0.42 | 0.42 | 0.50 | 0.50 |
| Chloride-60 | | | | | | |
| Vitamin- | 0.63 | 0.63 | 0.63 | 0.63 | 0.63 | 0.63 |
| Mineral | | | | | | |
| Premix | | | | | | |
| Alfalfa Extract | 0.00 | 0.25 | 0.00 | 0.25 | 0.00 | 0.25 |
| Calculated | | | | | | |
| Values, % | | | | | | |
| Crude Fat | 4.99 | 4.99 | 5.36 | 5.36 | 6.56 | 6.56 |
| CP | 23.19 | 23.19 | 20.88 | 20.88 | 19.16 | 19.16 |
| Digestible Lys | 1.32 | 1.32 | 1.15 | 1.15 | 1.02 | 1.02 |
| Digestible Met | 0.63 | 0.63 | 0.56 | 0.56 | 0.51 | 0.51 |
| ME, kcal/Kg | 3000.00 | 3000.00 | 3100.00 | 3100.00 | 3200.00 | 3200.00 |
| Analyzed | | | | | | |
| Values, | | | | | | |
| as-fed (%) | | | | | | |
| Moisture | 8.44 | 8.53 | 8.21 | 8.31 | 8.14 | 8.26 |
| DM | 91.56 | 91.47 | 91.79 | 91.69 | 91.86 | 91.74 |
| Crude Fat | 5.46 | 4.96 | 4.51 | 6.54 | 5.26 | 6.06 |
| CP | 18.50 | 18.19 | 18.24 | 18.41 | 16.19 | 16.21 |
| GE, cal/g | 3851.06 | 3855.24 | 3922.11 | 3930.06 | 3972.43 | 3967.96 |

TABLE 45
Healthy and Eimeria-inoculated Ross 708 broilers fed diets ± 0.25% 5^{th}
cutting alfalfa chloroform extract divided into 14-d starter, grower, and
finisher periods on a per bird basis; n = 4/treatment

| | Treatment | | |
|---|---|---|---|
| | Control | Alfalfa Extract | SEM |
| d0 BW (kg) | 0.044 | 0.044 | 0.0005 |

Starter (d0-d14)

| BWG (kg) | 0.289 | | 0.31 | | 0.006 |
|---|---|---|---|---|---|
| FI (kg) | 0.371 | | 0.394 | | 0.006 |
| FCR | 1.284 | | 1.269 | | 0.01 |
| | Treatment | | | | |
| | | Alfalfa | | Alfalfa | |
| | Control, | Extract, | Control, | Extract, | |
| | Eimeria− | Eimeria | Eimeria+ | Eimeria+ | SEM |

Grower (d14-d28)

| | | | | | |
|---|---|---|---|---|---|
| BWG (kg) | 0.831 | 0.825 | 0.722 | 0.732 | 0.037 |
| FI (kg) | 1.234 | 1.263 | 1.124 | 1.168 | 0.042 |
| FCR | 1.492 | 1.534 | 1.559 | 1.598 | 0.046 |

Finisher (d28-d42)

| | | | | | |
|---|---|---|---|---|---|
| BWG, kg | 1.052 | 1.131 | 1.146 | 1.118 | 0.191 |
| FI, kg | 1.998 | 2.143 | 2.086 | 2.261 | 0.093 |
| FCR | 1.945 | 1.915 | 1.826 | 2.022 | 0.45 |

Overall (d0-d42)

| | | | | | |
|---|---|---|---|---|---|
| BWG, kg | 2.171 | 2.263 | 2.159 | 2.162 | 0.209 |
| FI, kg | 3.601 | 3.797 | 3.584 | 3.825 | 0.129 |
| FCR | 1.674 | 1.681 | 1.661 | 1.814 | 0.176 |

TABLE 46
Healthy and Eimeria-inoculated Ross 708 broilers fed
diets ± 0.25% 5^{th} cutting alfalfa chloroform extract
P-values

| | Diet | Eimeria | Diet*Eimeria |
|---|---|---|---|
| d0 BW (kg) | 0.399 | n/a | n/a |

Starter (d0-d14)

| | | | |
|---|---|---|---|
| BWG (kg) | 0.037 | n/a | n/a |
| FI (kg) | 0.015 | n/a | n/a |
| FCR | 0.319 | n/a | n/a |

P-values

| | | |
|---|---|---|
| Diet | Cocci | Diet*Cocci |

Grower (d14-d28)

| | | | |
|---|---|---|---|
| BWG (kg) | 0.945 | 0.002 | 0.756 |
| FI (kg) | 0.209 | 0.003 | 0.812 |
| FCR | 0.2 | 0.051 | 0.97 |

Finisher (d28-d42)

| | | | |
|---|---|---|---|
| BWG, kg | 0.843 | 0.751 | 0.693 |
| FI, kg | 0.023 | 0.118 | 0.826 |
| FCR | 0.501 | 0.703 | 0.47 |

Overall (d0-d42)

| | | | |
|---|---|---|---|
| BWG, kg | 0.733 | 0.685 | 0.764 |
| FI, kg | 0.024 | 0.948 | 0.801 |
| FCR | 0.497 | 0.613 | 0.563 |

TABLE 47

| Treatment | | | |
|---|---|---|---|
| | Control | Alfalfa Extract | SEM |
| d0 BW, kg | 0.044 | 0.044 | 0.0005 |

Week 1

| | | | |
|---|---|---|---|
| BW, kg | 0.148 | 0.152 | 0.002 |
| BWG, kg | 0.105 | 0.108 | 0.002 |
| FI, kg | 0.119 | 0.122 | 0.002 |
| FCR | 1.138 | 1.127 | 0.014 |

Week 2

| BW, kg | | 0.333 | | 0.354 | 0.006 |
|---|---|---|---|---|---|
| BWG, kg | | 0.185 | | 0.202 | 0.005 |
| FI, kg | | 0.252 | | 0.271 | 0.005 |
| FCR | | 1.367 | | 1.345 | 0.012 |
| Treatment | | | | | |
| | | Alfalfa | | Alfalfa | |
| | Control, | Extract, | Control, | Extract, | |
| | Eimeria− | Eimeria− | Eimeria+ | Eimeria+ | SEM |

Week 3

| | | | | | |
|---|---|---|---|---|---|
| BW, kg | 0.705 | 0.74 | 0.593 | 0.611 | 0.033 |
| BWG, kg | 0.373 | 0.389 | 0.258 | 0.253 | 0.021 |
| FI, kg | 0.515 | 0.545 | 0.44 | 0.45 | 0.025 |
| FCR | 1.383 | 1.408 | 1.703 | 1.785 | 0.034 |

Week 4

| | | | | | |
|---|---|---|---|---|---|
| BW, kg | 1.163 | 1.176 | 1.057 | 1.089 | 0.046 |
| BWG, kg | 0.458 | 0.436 | 0.464 | 0.478 | 0.026 |
| FI, kg | 0.719 | 0.718 | 0.685 | 0.718 | 0.019 |
| FCR | 1.587 | 1.648 | 1.482 | 1.497 | 0.087 |

Week 5

| | | | | | |
|---|---|---|---|---|---|
| BW, kg | 1.785 | 1.83 | 1.657 | 1.718 | 0.074 |
| BWG, kg | 0.622 | 0.654 | 0.6 | 0.629 | 0.046 |
| FI, kg | 0.954 | 0.995 | 0.966 | 1.026 | 0.038 |
| FCR | 1.535 | 1.532 | 1.61 | 1.633 | 0.071 |

Week 6

| | | | | | |
|---|---|---|---|---|---|
| BW, kg | 2.301 | 2.419 | 2.29 | 2.373 | 0.113 |
| BWG, kg | 0.52 | 0.619 | 0.633 | 0.658 | 0.073 |
| FI, kg | 1.045 | 1.148 | 1.12 | 1.235 | 0.067 |
| FCR | 2.025 | 1.858 | 1.773 | 1.945 | 0.223 |

TABLE 48

| | Diet | Eimeria | Diet*Eimeria |
|---|---|---|---|
| d0 BW, kg | 0.399 | N/A | N/A |

Week 1

| | | | |
|---|---|---|---|
| BW, kg | 0.2 | N/A | N/A |
| BWG, kg | 0.249 | N/A | N/A |
| FI, kg | 0.166 | N/A | N/A |
| FCR | 0.593 | N/A | N/A |

Week 2

| | | | |
|---|---|---|---|
| BW, kg | 0.036 | N/A | N/A |
| BWG, kg | 0.026 | N/A | N/A |
| FI, kg | 0.012 | N/A | N/A |
| FCR | 0.25 | N/A | N/A |

Week 3

| | | | |
|---|---|---|---|
| BW, kg | 0.247 | 0.0002 | 0.712 |
| BWG, kg | 0.702 | <0.0001 | 0.493 |
| FI, kg | 0.225 | 0.0002 | 0.574 |
| FCR | 0.033 | <0.0001 | 0.255 |

Week 4

| | | | |
|---|---|---|---|
| BW, kg | 0.473 | 0.0085 | 0.775 |
| BWG, kg | 0.829 | 0.19 | 0.339 |
| FI, kg | 0.241 | 0.195 | 0.227 |
| FCR | 0.514 | 0.044 | 0.714 |

Week 5

| | | | |
|---|---|---|---|
| BW, kg | 0.295 | 0.03 | 0.88 |
| BWG, kg | 0.32 | 0.439 | 0.962 |
| FI, kg | 0.064 | 0.408 | 0.735 |
| FCR | 0.83 | 0.083 | 0.804 |

Week 6

| | | | |
|---|---|---|---|
| BW, kg | 0.197 | 0.7 | 0.829 |
| BWG, kg | 0.216 | 0.125 | 0.485 |
| FI, kg | 0.029 | 0.089 | 0.903 |
| FCR | 0.987 | 0.58 | 0.296 |

### Example 6. Immune Cell Analysis of Poultry Evaluation

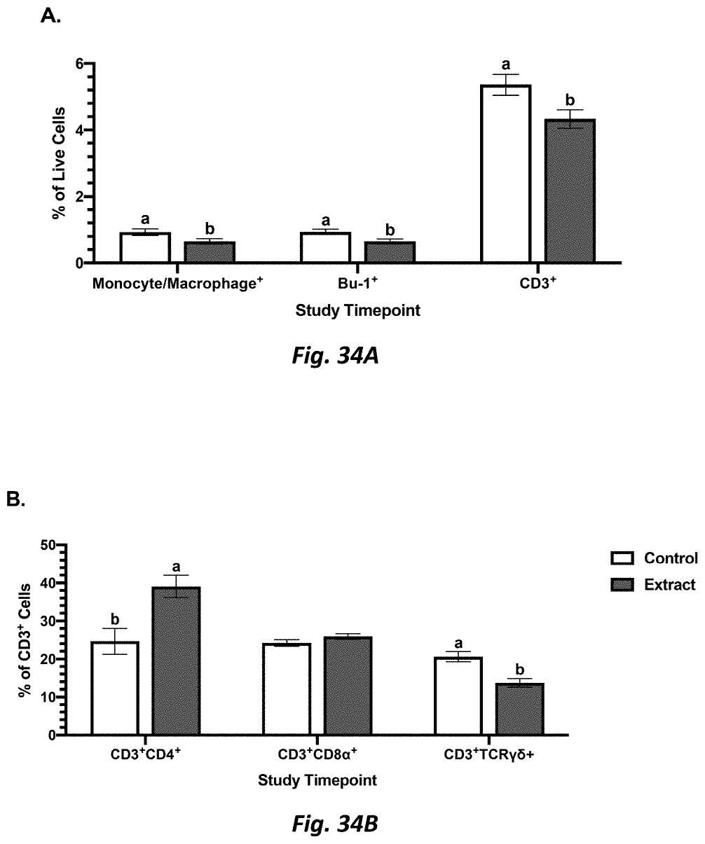

Following the poultry feed evaluation described in Example 5, further analysis was conducted on the immune cells of the poultry populations of Example 5. The results of this assessment are show in FIGS. 34A-34B, 35A-35C, and 36A-36C.

Prior to Eimeria inoculation, the general trend was for alfalfa extract to alter populations of circulating blood immune cells compared to the control. In 14 d-old healthy chicks prior to inoculation challenge, alfalfa extract supplementation reduced monocytes/macrophages, Bu-1⁺ B cells, and CD3⁺ T cells by 30.3, 31.2, and 19.3%, respectively, compared to the control (P=0.04, 0.01, and 0.02). Within T cell subpopulations, feeding alfalfa extract changed underlying T cell populations in favor of CD3⁺CD4⁺ helper T cells (Tx) at the expense of CD3⁺ TCRγδ⁺ (γδ) T cells. As shown in FIG. 34A and FIG. 34B, extract-fed birds had 31.8% more Tx compared to the control and 33.5% fewer γδ T cells (P=0.003 and 0.0003). These outcomes indicate that extract may have a systemic anti-inflammatory effect by reducing the tested immune cell populations in circulation. Additionally, these reduced immune cell populations indicate a reduced energy demand by the immune system in 14 d-old birds that may account for some of the performance improvements observed.

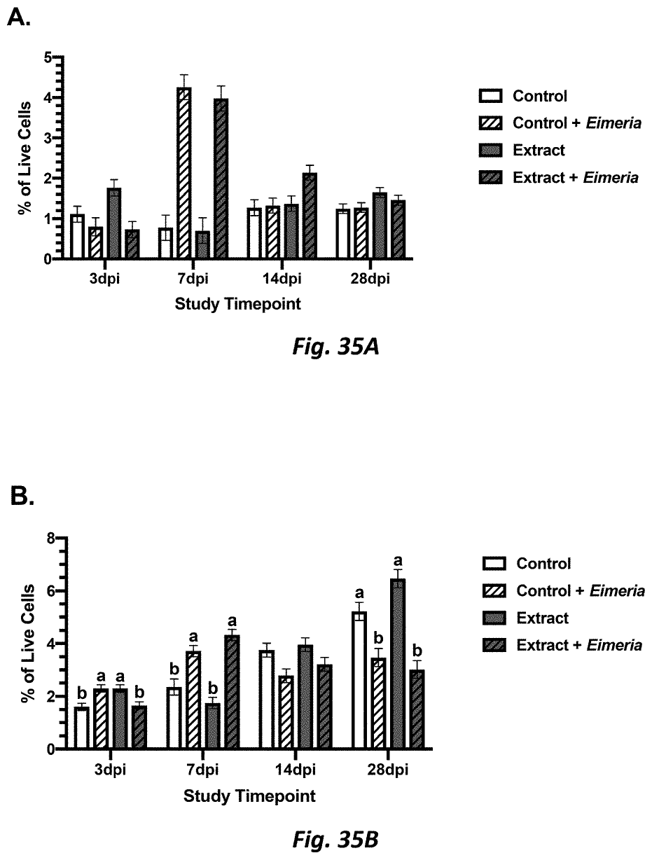

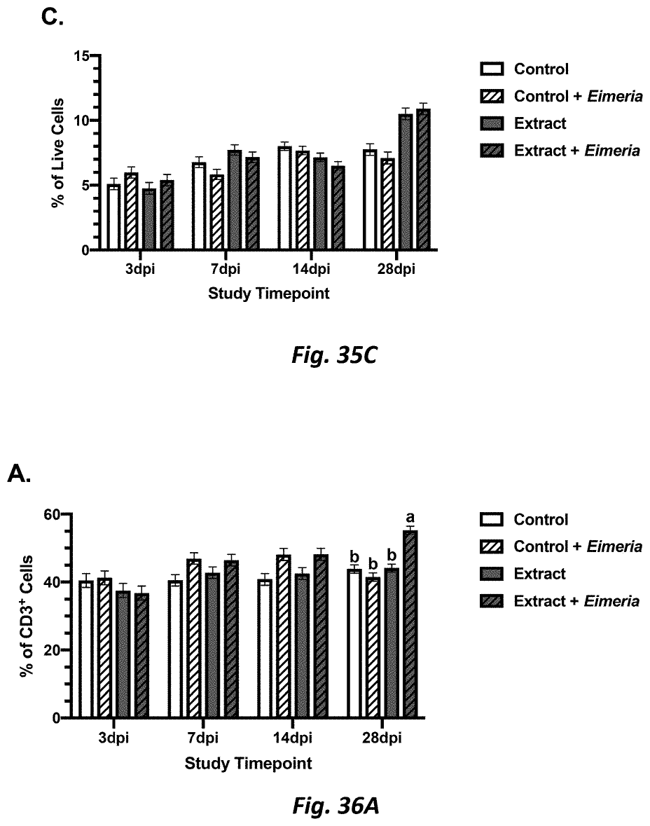

Monocytes/macrophages are innate immune cells that respond quickly to pathogen challenge and therefore the analysis showed expected changes in the early post-inoculation time period. Of the two cell lineages, macrophages are typically identified in tissues and monocyte precursors are typically found at low percentages in the blood. In addition to pathogen clearance as part of innate immunity, monocytes/macrophages function as antigen-presenting cells to initiate adaptive immune responses by B and T lymphocytes. In the first 3 dpi, the main effect of Eimeria inoculation reduced monocytes/macrophages by 46.8% compared to healthy animals (P=0.001). Most notably, these cell populations were increased in the peripheral blood of inoculated animals by 82.0% at 7 dpi-consistent with a systemic response to infection by these immune cells (P<0.0001). As shown in FIG. 35A, in the first 7 dpi, feeding alfalfa extract did not impact peripheral monocyte/macrophage responses to Eimeria as both the control and extract diets showed similar changes at 7 dpi. At 14 dpi, the main effect of Eimeria inoculation increased monocytes/macrophages by 23.6% in inoculated vs. healthy birds (P=0.04); however, this is due to inoculated birds on extract diets having 36.0% more monocyte/macrophages compared to their healthy counterparts. At 14 dpi, monocyte/macrophage populations are numerically similar between healthy and inoculated birds. These findings suggest a prolonged monocyte/macrophage response in extract-fed birds during coccidiosis and are consistent with observed prolonged macrophage responses from the preliminary mouse trial. By the conclusion of the study, feeding alfalfa extract resulted in 18.7% increased peripheral monocyte/macrophage populations compared to the control regardless of Eimeria status (P=0.02). As shown in FIG. 35A, similar populations of this cell type at the study conclusion (28 dpi) between the control and inoculated birds within each diet suggests that monocyte/macrophage populations in the peripheral blood resolved by 28 dpi.

The lymphocytes measured in this study encompass B and T cells, with B cells representing a population of cells with antigen-presentation and antibody-producing capabilities. Changes to B cells were observed first at 7 dpi when the main effect of Eimeria inoculation resulted in 49.0% increased populations of this cell type in inoculated vs. healthy birds, regardless of diet type (P<0.0001). Beyond this early B cell expansion, inoculated birds had 22.2 and 44.5% reductions in peripheral blood B cells at 14 and 28 dpi compared to healthy birds, regardless of diet type (P<0.0001). As shown in FIG. 35B, as B cell populations responded similarly to Eimeria inoculation between the control and extract diets from 7-28 dpi there is not much evidence to indicate that 5^{th} cutting extract alters systemic B cell responses during coccidiosis. When taking these data in consideration with Tables 44-48, it is important to note that while alfalfa extract did not alter B cell responses, Eimeria infections appeared to reduce age-related B cell expansion in the peripheral blood as early as 14 dpi (birds at 28 d of age) even when performance outcomes indicate that birds are recovering phenotypically.

Outcomes in CD3⁺ T cells suggest that these cells are likely not recruited to the intestine from the peripheral blood during Eimeria infection. While the T cells analyzed in this work were not altered by Eimeria infection in peripheral blood, the main effect of diet impacted expansion of these cells over time. At 7 dpi (21 d of age), birds on extract diets had 15.1% more T cells than birds on the control diet (P=0.006). As shown in FIG. 35C, by the end of the study (28 dpi; 42 d of age), birds fed extract diets had 30.5% more T cells than those on the control diet, regardless of Eimeria status. These findings are consistent with previous research and outcomes observed in healthy 8-week-old mice during the preliminary study.

While overall T cell populations analyzed in peripheral blood were not altered in response to Eimeria inoculation, changes to T cell subpopulations were observed throughout the post-inoculation period. Of the three different subpopulations assessed in this study, Tx cells function in the adaptive response by either activating B cells for antibody production or activating effector functions in other T cell subtypes whereas CD3⁺CD8α⁺ (Tc) cells play a direct role in killing pathogen-infected cells. The function of γδ T cells in poultry is not as well-established, but they are thought to play a role in regulating immune responses. At 3 dpi, the main effect of Eimeria inoculation increased the percentage of Tc cells by 39.0% and γδ T cells by 20.7% in inoculated vs. healthy birds (P=0.001 and 0.04). Peripheral blood Tc populations were increased 28.9% in inoculated birds on the extract diet compared to inoculated birds fed the control diet. Additionally, extract-fed birds had 45.6% more Tc cells than their healthy counterparts while inoculated control-fed birds showed a smaller 29.7% increase compared to their healthy counterparts (P=0.02). Changes to γδ T cells at 3 dpi may be due to the general decrease in this cell population in control-fed birds between baseline and 3 dpi (˜20% to ˜10% of T cells) and 35.4% increased γδ T cells in inoculated vs. healthy control-fed birds (P=0.001). Reasons for a decrease in these cells between baseline and 3 dpi in the control diet are not certain, but this population remains fairly stable in extract-fed birds. Changes in Tc populations at 3 dpi do not accompany changes in Tx cells, suggesting that expansion of this subpopulation at 3 dpi displaces T cell populations that were not measured due to reagent and marker availability limitations.

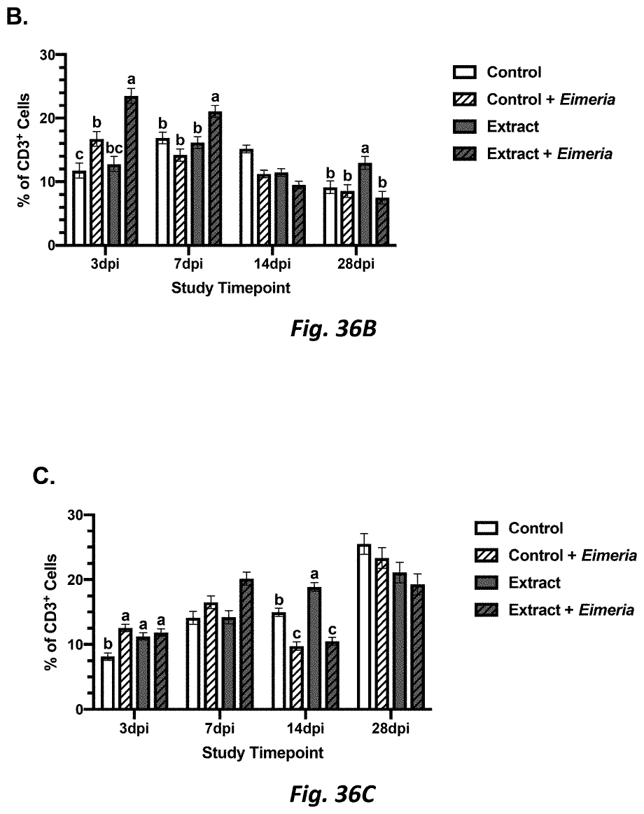

Beyond early changes to T cell subpopulations, other differences were observed throughout the study. At 7 dpi, Tc cells in inoculated birds fed the extract diet were increased 23.3% compared to their healthy counterparts while these populations were similar between healthy and inoculated control-fed birds (P=0.0001). At the same time, the main effect of Eimeria inoculation increased Tx and γδ T cells by 10.9 and 22.7%, respectively, in inoculated vs. healthy birds (P<0.0001). While the interaction of diet and Eimeria status was not significant, inoculated extract-fed birds had 8.0% more Tx cells than their healthy counterparts while these cells were increased 13.8% in inoculated vs. healthy control-fed birds. In contrast, inoculated extract-fed birds had 29.5% more γδ T cells, numerically, than their healthy counterparts while these populations were increased 14.3% in inoculated vs. healthy control-fed birds. FIGS. 36A-36C therefore indicate that alfalfa extract contributes to increased Tc cells and a greater magnitude of Eimeria-related γδ T cell expansion at 7 dpi but reduced the magnitude of Tx expansion at 7 dpi in the peripheral blood. At 14 dpi, the main effect of Eimeria inoculation increased Tx cells by 13.5% and reduced γδ T cells by 40.3% in inoculated vs. healthy birds (P=0.0003 and <0.0001). Notably, γδ T cells were increased 20.7% in the peripheral blood of healthy extract-fed birds compared to healthy control-fed animals; however, γδ T cells were significantly reduced 35.0-44.5% in inoculated birds fed either diet (P=0.02). As evidenced by FIG. 36A and FIG. 36B, by the conclusion of the study, inoculated birds on extract diets have 20.3% more Tx and 42.2% fewer Tc cells than their healthy counterparts suggesting late expansion of Tx in the peripheral blood at the expense of Tc cells. As overall T cell populations did not show evidence of recruitment to the site of Eimeria infection in the intestine, these changes in T cell subpopulations may serve as general indicators of inflammatory state as the infection progresses.

The inventions being thus described, it will be obvious that the same may be varied in many ways. Such variations are not to be regarded as a departure from the spirit and scope of the inventions and all such modifications are intended to be included within the scope of the following claims. The above specification provides a description of the manufacture and use of the disclosed compositions and methods. Since many embodiments can be made without departing from the spirit and scope of the invention, the invention resides in the claims.

What is claimed is:

1. An animal feed composition comprising:
an alfalfa bioactive composition comprising one or more saponins, one or more fatty acids, one or more phytoestrogens, one or more polysaccharides, or a combination thereof; and a carbohydrate source.

2. The composition of claim 1, wherein the carbohydrate source comprises maize, sorghum, rye alfalfa, green oilseed, legumes, grasses, cabbage, pumpkins, turnips, beets, carrots, swedes, vegetable roots, non-leguminous hay, clover, wheat bran, rice bran, barley bran, maize bran, rye bran, oat bran, millet bran, sorghum bran, fonio, triticale, pulses, or a combination thereof.

3. The composition of claim 1, further comprising a source of fiber.

4. The composition of claim 3, wherein the source of fiber comprises neutral detergent fiber, acid detergent fiber, lignin, cellulose, or a combination thereof.

5. The composition of claim 1, further comprising one or more vitamins and minerals, wherein the vitamins and minerals are calcium, phosphorous, magnesium potassium, chloride, sodium, copper, zinc, sulfur, iron, manganese, nitrate, or a combination thereof.

6. The composition of claim 1, further comprising a supplementary protein source, wherein the supplementary protein source is soy meal, sunflower meal, canola meal, distiller's dried grains with solubles (DDGS), pea protein, bean protein, lupins, lemna, algae, sweet potato, common vetch seeds, hempseed cake, castor oil meal, pigeon pea, rapeseed, cassava foliage, duckweed, fish meal, blood meal, poultry by-product (ground poultry offal), meat meal, keratin, insect meal, or a combination thereof.

7. The composition of claim 1, wherein the alfalfa bioactive composition is present in an amount of between about 0.0001 wt. % to about 15 wt. % of the composition, and the carbohydrate source is present in an amount of from about 1 wt. % to about 99 wt. % of the composition.

8. A method of improving the growth of livestock animals comprising:
(a) providing to a livestock animal an alfalfa bioactive composition in an amount effective to increase the body weight and/or feed efficiency of the livestock animal, wherein the alfalfa bioactive composition comprises:
(i) one or more saponins,
(ii) one or more fatty acids,
(iii) one or more phytoestrogens,
(iv) one or more polysaccharides,
(v) or a combination thereof; and
(b) exposing the livestock animal to the alfalfa bioactive composition, whereby the body weight and/or feed efficiency of the livestock animal is improved compared to livestock animals not provided with the alfalfa bioactive composition.

9. The method of claim 8, wherein the feed intake of the livestock animal is maintained or improved even in the event of a pathogen challenge.

10. The method of claim 8, wherein the livestock animal is exposed to the alfalfa bioactive composition for a period of between 1 day and >56 days

11. The method of claim 8, wherein the exposure occurs by providing the alfalfa bioactive composition as part of an animal feed composition.

12. The method of claim 8, wherein the alfalfa bioactive composition is suspended in a solvent comprising water, chloroform, or a combination thereof.

13. A method of improving immune resistance in livestock comprising:
(a) providing to a livestock animal an alfalfa bioactive composition in an amount effective to reduce serum cytokines and/or improve adaptive and/or innate immune response, wherein the alfalfa bioactive composition comprises:
(i) one or more saponins,
(ii) one or more fatty acids,
(iii) one or more phytoestrogens,
(iv) one or more polysaccharides,
(v) or a combination thereof; and
(b) exposing the livestock animal to the alfalfa bioactive composition, wherein the concentration of serum cytokines is reduced and/or innate and/or adaptive immune cell concentration is increased.

14. The method of claim 13, wherein the decrease in serum cytokines includes a reduction in the number of IFN-γ⁺ and/or TNF-α⁺ cells.

15. The method of claim 13, wherein the reduction in the number of IFN-γ⁺ and/or TNF-α⁺ cells improves infection recovery rate.

16. The method of claim 13, wherein the increase in adaptive immune cells includes an increase in one or more B-cell and/or T-cell populations.

17. The method of claim 13, wherein the increase in innate immune cells includes an increase in one or more neutrophil and/or macrophage populations.

18. A method of improving the intestinal microbiota of livestock comprising:
(a) providing to a livestock animal an alfalfa bioactive composition in an amount effective to reduce a pathogen population and improve one or more beneficial microbial populations, wherein the alfalfa bioactive composition comprises:
(i) one or more saponins,
(ii) one or more fatty acids,
(iii) one or more phytoestrogens,
(iv) one or more polysaccharides,
(v) or a combination thereof; and
(b) exposing the livestock animal to the alfalfa bioactive composition, wherein the quantity of the pathogen population is reduced and/or the quantity of the one or more beneficial microbial populations are increased.

19. The method of claim 18, wherein the pathogen population includes Citrobacter rodentium and/or an operational taxonomic unit thereof.

20. The method of claim 18, wherein the one or more beneficial microbial populations includes Akkermansia, Turicibacter, Muribaculaceae, Dubosiella, Lactobacillus, Bacteroides, Lachnospiraceae, Alistipes, Parasutterella, Bifidobacterium, Anaeroplasma, or a combination or an operational taxonomic unit thereof.

21. An alfalfa bioactive composition comprising:
(i) one or more saponins;
(ii) one or more fatty acids;
(iii) one or more phytoestrogens; and/or
(iv) one or more polysaccharides.
